(19) United States
(12) Patent Application Publication
(10) Pub. No.: US 2024/0174526 A1
(43) Pub. Date: May 30, 2024

(54) COMPOSITIONS, METHODS, AND SYSTEMS FOR MICROWAVE CATALYTIC AMMONIA SYNTHESIS

(71) Applicant: WEST VIRGINIA UNIVERSITY BOARD OF GOVERNORS ON BEHALF OF WEST VIRGINIA UNIVERSITY, Morgantown, WV (US)

(72) Inventors: Jianli HU, Morgantown, WV (US); Yuxin WANG, Morgantown, WV (US); Dushyant SHEKHAWAT, Morgantown, WV (US); Christina WILDFIRE, Fairmont, WV (US); Alexander David WELSH, San Francisco, CA (US); Robert Edward WEISS, San Francisco, CA (US)

(21) Appl. No.: 18/284,525

(22) PCT Filed: Mar. 27, 2022
(86) PCT No.: PCT/US2022/022080

§ 371 Date: Sep. 27, 2023

Related U.S. Application Data
(60) Provisional application No. 63/166,997, filed on Mar. 27, 2021.

(51) Int. Cl. C01C 1/04; B01J 3/04; B01J 23/10; B01J 23/46; B01J 23/58; B01J 37/34

(52) U.S. Cl. CPC C01C 1/0411; B01J 3/04; B01J 23/10; B01J 23/462; B01J 23/58; B01J 37/346

(57) ABSTRACT

The disclosure relates to relates to heterogeneous catalysts useful for the synthesis of ammonia under electromagnetic irradiation, processes for preparing the disclosed heterogeneous catalysts, processes for synthesizing ammonia at ambient pressures using hydrogen and nitrogen. The disclosed heterogeneous catalysts can be utilized in disclosed processes for efficient synthesis of ammonia utilizing a variable frequency reactor with an electromagnetic frequency generator and a reactor chamber. This abstract is intended as a scanning tool for purposes of searching in the particular art and is not intended to be limiting of the present disclosure.

### CROSS-REFERENCE TO RELATED APPLICATIONS

This Application claims the benefit of U.S. Provisional Application No. 63/166,997, filed on Mar. 27, 2021, which is incorporated herein by reference in its entirety.

### STATEMENT REGARDING FEDERALLY SPONSORED RESEARCH

This disclosure was made with U.S. Government support under Contract number DE-AR0000807, awarded by the U.S. Department of Energy Advanced Research Projects Agency-Energy (ARPA-E). The U.S. government has certain rights in the disclosure.

### BACKGROUND

Ammonia has become one of the most industrially important and most consumed synthetic chemicals in the world, with the United States as one of the world's leading producers and consumers. For example, ammonia, which contains 82 percent nitrogen, is the main source for nitrogen in various types of fertilizers used in crop production used globally. In the chemical industry, ammonia is conventionally produced in large-scale plants via the Haber-Bosch (H-B) process. The industrial H-B process is a technology that consumes considerable energy—requiring high temperature (400-570 C), high pressure (150-250 bar, or about 148-246 atm) and an effective catalyst (Fe promoted with K₂O and Al₂O₃ as well as other metal oxides). Moreover, current ammonia plants are very large, e.g., producing 1000 ton/day ammonia. In 2019, the production of ammonia in the U.S. was estimated to total approximately 14 million metric tons.

It is estimated that current ammonia production, together with upstream H₂ production from steam reforming or coal gasification process consumes approximately 2% of world power generation. Importantly, 1.87 tons of CO₂ is released per ton of ammonia produced. In 2010, 245 million tons of CO₂ was released as a result of ammonia production, which is equivalent to 0.77% of the world total CO₂ emissions. The chemical industry has been trying to optimize the H-B process to decrease the amount of capital and energy required. Although optimization of process conditions and catalysts have resulted in about 30% efficiency improvements, the H-B the process still accounts for 1-2% of global energy consumption and consumes 3-5% of all natural gas produced globally.

Industry has also attempted to scale down the H-B process, for example, in order to take advantage of renewable energy resources. The current H-B synthesis of ammonia is too large for the deployable scale of renewables (ranging from 1-2 MW to 100-150 MW). If the conventional H-B process could be scaled down to about 100 ton/day, this would reduce the energy consumption to about 150 MW of renewable energy. At an energy consumption of about 150 MW, the energy requirement matches well with a single mid-size solar/wind farm or combination of several renewable sources. However, scaling the H-B process down to about 100 ton/day increases the production cost by a factor of 2 to 3.

Other industrial efforts to synthesize ammonia without the H-B approach, including electrochemical, biomimetic routes, and novel chemical looping processes, are all at the fundamental research level at this time. As reported, electrochemical approaches often yield only trace amounts of ammonia at modest current efficiencies, while biomimetic routes suffer from the requirement for liquid phase operation with slow mass transfer, often slow kinetics, and sometimes requirements for co-factors that are prohibitively expensive and/or complex to provide.

Accordingly, despite advances in the improving the efficiency of the H-B process and ammonia synthesis without the H-B process, there is still a need for an industrial ammonia synthesis process with improved energy efficiency, allows efficient pairing with renewable energy resources, reduced capital and operating costs. These needs and other needs are satisfied by the present disclosure.

### SUMMARY

In accordance with the purpose(s) of the disclosure, as embodied and broadly described herein, the disclosure, in one aspect, relates to a process that utilizes a microwave reactor to improve catalysis by providing a more optimal system and method for ammonia synthesis. Using heterogeneous catalysts useful for the synthesis of ammonia, microwave irradiation, and chemical reaction engineering, processes for synthesizing ammonia at ambient pressures using hydrogen and nitrogen at an accelerated rate are described.

Disclosed herein are processes for ammonia synthesis, the process comprising: providing a reaction chamber within a reactor with a heterogeneous catalyst; activating the heterogeneous catalyst using electromagnetic energy having a frequency of 13.5 MHz to 50 GHz; wherein the activating the heterogeneous catalyst initiates a chemical reaction; conveying a flow of a reactant gas mixtures into the reaction chamber via an entry port; wherein the reaction chamber pressurizes the reaction chamber to a pressure from about 0.5 atm to about 1000 atm; contacting the reactant gas mixture with the heterogeneous catalyst; and reacting the reactant gas mixture in contact with the heterogenous catalyst, thereby providing a product gas mixture; wherein the heterogeneous catalyst comprises a catalyst support comprising a cerium oxide, a lanthanum oxide, or a combination thereof; wherein the cerium oxide comprises Ce(III), Ce(IV), or combinations thereof; and wherein the lanthanum oxide comprises La(III); wherein the heterogeneous catalyst comprises a catalyst metal comprising at least one metal selected from Groups 6-12; and wherein the catalyst metal is selected from Rh, Ir, Os, Ru, Pt, Pd, Cr, Mn, Fe, Co, Ni, Zn, and combinations thereof; wherein the catalyst metal is present in an amount from about 0.1 wt % to about 15 wt %; wherein the heterogeneous catalyst has a heterogeneous catalyst temperature of from about 40° C. to about 800° C.; wherein the reactant gas mixture comprises nitrogen and hydrogen; and wherein the product gas mixture comprises ammonia.

Also disclosed herein are heterogeneous catalysts comprising: a catalyst support comprising a cerium oxide, a lanthanum oxide, or a combination thereof; and wherein the cerium oxide comprises Ce(III), Ce(IV), or combinations thereof; and wherein the lanthanum oxide comprises La(III); a catalyst metal comprising at least one metal selected from Groups 6-12; wherein the catalyst metal is selected from Rh, Ir, Os, Ru, Pt, Pd, Cr, Mn, Fe, Co, Ni, Zn, and combinations thereof; wherein the catalyst metal is present in an amount from about 0.1 wt % to about 15 wt %; wherein the catalyst is capable of interacting with electromagnetic energy having a frequency of 13.5 MHz to 50 GHz; wherein the wt % is based on the total weight of the catalyst support and the catalyst metal.

Also disclosed herein are heterogeneous catalysts comprising: a catalyst support comprising CeO₂, La₂O₃, or combinations thereof; a catalyst metal comprising at least one metal selected from Groups 6-12; and optionally a catalyst promoter comprising at least one metal selected from Group 1, and Group 2; wherein the catalyst is capable of interacting with electromagnetic energy in the frequency range of 300 MHz to 50 GHz; wherein the catalyst metal is present in an amount from about 0.1 wt % to about 15 wt %; wherein the catalyst promoter is present in an amount from about 0.1 wt % to about 15 wt %; and wherein the wt % is based on the total weight of the catalyst support, the catalyst metal, and the catalyst promoter, when present.

Also disclosed are processes for ammonia synthesis, the process comprising: providing a reaction chamber within a reactor with a disclosed heterogeneous catalyst; heating the heterogeneous catalyst using microwave energy with electromagnetic energy in the frequency range of 300 MHz to 50 GHz; conveying a flow of a reactant gas mixtures into the reaction chamber via an entry port; wherein the reaction chamber pressurizes the reaction chamber to a pressure from about 0.9 atm to about 100 atm; contacting the reactant gas mixture with the heterogeneous catalyst; and reacting the reactant gas mixture in contact with the heterogenous catalyst, thereby providing a product gas mixture; wherein the heterogeneous catalyst has a heterogeneous catalyst temperature of from about 40° C. to about 800° C.; wherein the reactant gas mixture comprises nitrogen and hydrogen; and wherein the product gas mixture comprises ammonia.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B show representative apparatus for carrying out a disclosed process for ammonia synthesis. FIG. 1A shows a representative apparatus for carrying out a disclosed process for ammonia synthesis comprising a quartz microwave tube reactor that is joined to a stainless-steel connector through pyrex transition. The upper limit of the reactor pressure was 200 psig. The high-pressure microwave reaction system prototype was created using this high-pressure microwave reactor tube. FIG. 1B shows a representative apparatus for carrying out a disclosed process for ammonia synthesis. For safety, the system was shielded with clear plastic tubing outside of the reactor and plastic boards around the framework of experimental station. A Sairem solid-state microwave reactor (PCCMWR340L130PVMR1PE-B) was used to supply microwave irradiation at 2.450 GHz frequency, the catalyst temperature was measured by IR sensor.

FIG. 2 provides representative temperature profiles of a representative CsRu/CeO₂ catalyst of a 2 kw magnetron (input power 200 W) and 950 W solid-state generator.

FIG. 3 schematically illustrates a representative low-pressure ammonia process with water absorption separation technology.

FIG. 4 schematically illustrates a representative low-pressure ammonia process with cryogenic separation technology.

FIG. 5 provides a block flow diagram of a representative Modified Haber-Bosch process.

FIG. 6 shows representative data of the effect of promoter on ammonia production rate over MgO supported catalysts (260 C, 0.1 Mpa, H₂/N₂=3:1, flow rate 100 ml/min gcat).

FIG. 7 shows representative data of the effect of Ru and promoter loading on ammonia production rate (260 C, 0.1 Mpa, H₂/N₂=3:1, flow rate 100 ml/min gcat).

FIG. 8 shows representative data of the ammonia production rate over different supported catalysts (260 C, 0.1 Mpa, H₂/N₂=3:1, flow rate 100 ml/min gcat).

FIG. 9 shows representative data for NH₃ formation rate over Ru catalysts with different support and promoter (533K, 0.1 MPa).

FIG. 10 provides representative data of the effect of Cs/Ru mass ratio for ammonia formation rate over CeO₂ and MgO support (Ru loading at 4%), 533 K, 0.1 MPa.

FIG. 11 provides representative data of the effect of pressure for ammonia formation rate over CsRu/CeO₂ (2-4%), 593 K.

FIGS. 12A-12B show representative XRD data of Ru catalysts on different supports. The catalyst composition and catalyst amount (wt %) with support are as detailed in the figure. FIG. 12A shows XRD data for the indicated Ru catalysts on a CeO₂ support compared to support without a catalyst. FIG. 12B shows XRD data for the indicated Ru catalysts on a MgO support compared to support without a catalyst.

FIG. 13 shows representative TEM images of disclosed catalyst. The individual TEM images (referenced by the inset key) are as follows: a-1 and a-2: Ru/CeO₂(4%), b-1 and b-2: Ru/CeO₂(8%), c-1 and c-2: CsRu/CeO₂(2-4%), d-1 and d-2: KRu/CeO₂(2-4%), e-1 and e-2:f Ru/MgO(4%), f-1 and f-2: Ru/MgO(8%), g-1 and g-2: CsRu/MgO(2-4%), h-1 and h-2: KRu/MgO(2-4%).

FIGS. 14A-14B show representative XPS data of Ru catalysts on different supports. The catalyst composition and catalyst amount (wt %) with support are as detailed in the figure. FIG. 12A shows XPS data for the indicated Ru catalysts on a CeO₂. FIG. 12B shows XPS data for the indicated Ru catalysts on a MgO support.

FIGS. 15A-15B show representative H₂-TPR data of Ru catalysts on different supports. The catalyst composition and catalyst amount (wt %) with support are as detailed in the figure. FIG. 12A shows XPS data for the indicated Ru catalysts on a CeO₂ compared to support without a catalyst. FIG. 12B shows XPS data for the indicated Ru catalysts on a MgO support compared to support without a catalyst.

FIG. 16 shows a representative formation energy diagram of disclosed Ru catalysts on different supports during the agglomeration of Ru over MgO(100) and CeO₂(110) surface.

FIG. 17 shows a representative Free Energy (G-TS+ZPE) diagram of NH₃ formation from the reaction of N₂ and H₂ over the Ru(211), K-promoted Ru(211) and Cs-promoted Ru(211) surfaces at 533 K. The reaction details for each specified letter on the diagram are shown above the diagram.

FIG. 18 shows representative data for NH₃ production rate over the Ru(211), K—Ru(211) and Cs—Ru(211) surfaces at temperature range 500 K-700 K. Total pressure 1 bar, N₂:H₂ in 1:3 ratio.

FIGS. 19A-19C show a representative model of DFT optimized geometry of (FIG. 19A) CeO₂(110), (FIG. 19B) Ru—CeO₂(110), and (FIG. 19C) Cs—Ru—CeO₂(110) catalyst surfaces. Color code: Ce (white), O (red), Ru (green), Cs (pink).

FIG. 20 shows representative data for ammonia formation rate for different supports and catalyst loading amounts (wt %) as specified by the graph inset key using a disclosed method for microwave-assisted ammonia synthesis at 533K, 0.1 MPa.

FIG. 21 shows representative data for ammonia formation rate for representative disclosed catalysts on different supports as specified by the graph inset key using a disclosed method for microwave-assisted ammonia synthesis at 533K, 0.1 MPa. The catalyst loading amounts were as follows: 4 wt % K or 4 wt % Cs loading (Ru loading is 4 wt % for all catalysts).

FIG. 22 shows representative data for ammonia formation rate for of representative Cs/Ru catalysts on different supports as specified by the graph inset key using a disclosed method for microwave-assisted ammonia synthesis at 533K, 0.1 MPa. The catalyst loading amounts were Ru loading was 4 wt %. The data demonstrate the effect of Cs/Ru mass ratio on ammonia formation rate.

FIGS. 23A-23B show representative XRD data of representative Cs/Ru catalysts on different supports. The catalyst composition and catalyst amount (wt %) with support are as detailed in the figure. FIG. 23A shows XRD data for the indicated Cs/Ru catalysts on a CeO₂ as indicated. FIG. 23B shows XRD data for the indicated Cs/Ru catalysts on a MgO support as indicated.

FIGS. 24A-24F show representative element EDS mapping for representative disclosed catalyst/support compositions. The data are as follows: (FIG. 24A) Ru/CeO₂(4%), (FIG. 24B) Ru/MgO(4%), (FIG. 24C) CsRu/CeO₂(2-4%), (FIG. 24D) CsRu/MgO(2-4%), (FIG. 24E) KRu/CeO₂(2-4%), and (FIG. 24F) KRu/MgO(2-4%).

FIGS. 25A-25B show representative Ru 3d XPS spectra of representative Cs/Ru catalysts on different supports. The catalyst composition and catalyst amount (wt %) with support are as detailed in the figure. FIG. 25A shows Ru 3d XPS spectra for the indicated Cs/Ru catalysts on a CeO₂ as indicated. FIG. 25B shows Ru 3d XPS spectra for the indicated Cs/Ru catalysts on a MgO support as indicated.

FIG. 26 shows representative Ce 3d XPS spectra of representative Ru catalysts on CeO₂ support. 6 peaks that are attributed to Ce⁴⁺ (shown in red color) and 4 peaks are attributed to Ce³⁺ (shown in blue color).

FIG. 27 shows representative Ce 3d XPS spectra of representative Cs/Ru catalysts on CeO₂ support. 6 peaks that are attributed to Ce⁴⁺ (shown in red color) and 4 peaks are attributed to Ce³⁺ (shown in blue color).

FIG. 28 show representative data for H₂ temperature programmed reduction data using representative Cs/Ru catalysts on different supports. The catalyst composition and catalyst amount (wt %) with support are as detailed in the figure. FIG. 28A shows H₂ temperature programmed reduction data for the indicated Cs/Ru catalysts on a CeO₂ as indicated. FIG. 28B shows H₂ temperature programmed reduction data for the indicated Cs/Ru catalysts on a MgO support as indicated.

FIG. 29 shows representative binding configuration of of Ru, Ru₄ and Ru₁₃ metal clusters over MgO support, (a-a′) MgO(100); (b-b′) Ru/MgO(100); (c-c′) Ru₄/MgO(100) and (d-d′) Ru₁₃/MgO(100). Color code: Mg (light-green), O (red), Ru (dark-green).

FIG. 30 shows representative binding configuration of of Ru, Ru₄ and Ru₁₃ metal clusters over CeO₂ support, (a-a′) CeO₂(110); (b-b′) Ru/CeO₂(110); (c-c′) Ru₄/CeO₂(110) and (d-d′) Ru₁₃/CeO₂(110). Color code: Ce (white), O (red), Ru (dark-green).

FIG. 31 shows representative dielectric constant data representative disclosed Ru catalysts on different supports. The catalyst loading (wt %) is as indicated on the graph.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. DEFINITIONS

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a metal oxide,” “an inert gas,” or “a catalyst,” includes, but is not limited to, two or more such metal oxides, inert gases, or catalysts, and the like.

Moreover, reference to “a” chemical compound refers one or more molecules of the chemical compound, rather than being limited to a single molecule of the chemical compound. Furthermore, the one or more molecules may or may not be identical, so long as they fall under the category of the chemical compound. Thus, for example, “a” heterogeneous catalyst is interpreted to include one or more heterogeneous catalyst molecules that may or may not be identical (e.g., different compositions of a heterogeneous catalyst within the scope of the present disclosure).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a catalyst refers to an amount that is sufficient to achieve the desired improvement in the property modulated by the formulation component, e.g. achieving the desired level of modulus. Thus, for example, the specific level in terms of wt % of specific components in a heterogeneous catalyst composition required as an effective amount will depend upon a variety of factors including the amount and type of catalyst; composition of reactant gas mixture; amount, frequency and wattage of microwave energy that will be used during product; and production requirements in the use of the heterogeneous catalyst in preparing ammonia by the disclosed methods.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt %,” and “wt %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

As used herein the terms “volume percent,” “vol %,” and “vol. %,” which can be used interchangeably, indicate the percent by volume of a given gas based on the total volume at a given temperature and pressure, unless otherwise specified. That is, unless otherwise specified, all vol % values are based on the total volume of the composition. It should be understood that the sum of vol % values for all components in a disclosed composition or formulation are equal to 100.

Compounds are described using standard nomenclature. Unless defined otherwise, technical and scientific terms used herein have the same meaning as is commonly understood by one of skill in the art to which this disclosure belongs. For example, reference to Group 1, Group 2, and other atoms are in reference to IUPAC nomenclature as it applies to the periodic table. In particular, the group nomenclature used herein is that this is in accordance with that put forth in the IUPAC proposal was first circulated in 1985 for public comments (Pure Appl. Chem. IUPAC. 60 (3): 431-436. doi:10.1351/pac198860030431), and was later included as part of the 1990 edition of the Nomenclature of Inorganic Chemistry (Nomenclature of Inorganic Chemistry: Recommendations 1990. Blackwell Science, 1990. ISBN 0-632-02494-1).

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### B. SUMMARY

Ammonia (NH₃) is one of the most consumed chemicals in the world [Ref. 1]. It is an essential raw material and intermediate for many important chemicals, including fertilizers, polymers, and explosives [Ref. 2]. In addition, it is also being considered as a future fuel alternative and hydrogen storage molecule [Ref. 3]. Currently, NH₃ is mainly produced by the Haber-Bosch process, which operates at high temperatures (673-873K) and high pressures (20-40 MPa) requiring high capital investment and energy consumption [Ref. 4]. An alternative approach that can efficiently convert N₂ and H₂ to NH₃ with low-energy consumption is much desired. Microwaves offer instantaneous and volumetric heating through direct heating via interaction with electromagnetic radiation [Ref. 5]. The direct interaction of the microwave with a catalyst permits greater sorption selectivity, resulting in selective heating effects [Ref. 6]. Chemical reaction conditions like temperature, pressure, time, and activation energy can be significantly reduced. Microwave technology is a promising alternative for energy-intensive Haber-Bosch process to produce NH₃ under mild conditions.

The cleavage of the extremely stable N═N bond (945 kJ/mol) of N₂ is the rate-determining step in NH₃ synthesis [Ref. 7]. Electron donation from d-orbitals of active transition metal into the π* orbitals of N₂ will largely weaken the N═N bond [Ref. 8]. Group 8 metals, e.g. Fe, Ru, and Os, with seven electrons in the d-orbital shows high activity in NH₃ synthesis [Ref. 9]. Specifically, Ru catalyst has displayed five times higher activity under the same temperature and at half of the pressure of other metals [Ref. 10]. The NH₃ synthesis activity of Ru is largely affected by its electronic and geometric structures. One of the main variables on Ru that can affect NH₃ synthesis is the geometrical structure called the B5-type sites [Ref. 11]. B5-type sites may exist on the surfaces of Ru, and it is responsible for strong physical adsorption of nitrogen. These sites of Ru are believed to be extremely active and thus to dominate the reaction rate of NH₃ synthesis [Ref. 12]. The fraction of B5-type sites mainly depends on the Ru crystal size and morphology. They can be increased with decreasing particle size and tend to form some morphology like truncated hexagonal pyramid shape [Ref. 13]. The morphology and size of Ru can be modified by the support and promoter, these effects are considered as a structural modification. The NH₃ synthesis activity with Ru can also be dramatically enhanced through modification of electronic structure by basics supports and alkali metal promoters [Ref. 14]. The electrons are transferred from supports and promoters to the Ru surface, thus promoting the donation of electron density into the π* orbitals of N₂ and facilitating the N═N cleavage. These effects are considered as an electronic modification [Ref. 15].

The support properties affect the geometric and electronic properties of Ru. The interaction between Ru and support affects the Ru particle size and dispersion, while the electron donating ability is crucial for the creation of highly active electron-rich Ru. MgO is a promising support for Ru catalysts due to the considerable electron-donating ability and geometric modification [Ref. 16]. The Ru/MgO shows considerable activity toward NH₃ synthesis at the relatively low temperatures (573-673K) under pressures close to ambient [Ref. 17]. CeO₂ is one of the most effective supports for Ru catalysts due to the reversible transformation of Ce³⁺/Ce⁴⁺ and abundant oxygen vacancies, which causes an increase of Ru metal surface electron density [Ref. 18]. The oxygen vacancies can also enhance the adsorption and activation of N₂, and thus promote N₂ reduction to NH₃ [Ref. 19]. Moreover, previously studies indicate that the surface of CeO₂ easily forms the metal-O—Ce bonds (e.g. Pt, Ag, and Ru), resulting in strongly bonded, finely dispersed metal nanoparticles [Ref. 20]. The electronic and geometric structures of Ru can also be modified by the promoters, e.g. alkali metals and alkaline-earth metals. Specifically, alkali metals can significantly boost Ru catalytic activity in NH₃ synthesis through electron transfer to the Ru surface, facilitating its electron-donating ability [Ref. 21]. It has been found that the promoting effect of alkali-metal is inversely proportional to the electronegativity, and the promotion effect follows the order of Cs>K>Na [Ref. 22]. Meanwhile, the alkali-metal promoter can effectively prevent the sintering of Ru and forms small size particles [Ref. 23].

In the present disclosure, in the Examples, the effect of supports and promoters for the Ru electronic and geometric structures and corresponding actives in microwave-assisted NH₃ synthesis are systematic investigated. Two supports MgO and CeO₂ were selected, and Cs and K were selected as promoters. Their NH₃ synthesis actives were compared experimentally, and density functional theory (DFT) calculations were carried out to understand the functional differences at the atomic scale. Moreover, DFT-based microkinetic models were set up to elucidate the effect of promoter on the NH₃ synthesis activity.

Herein described and disclosed is a high-pressure quartz reactor for microwave reaction resulting in a significant increase in ammonia synthesis yields. It is believed that this is the first time microwave reactors using catalytic reactions have been conducted under pressure.

Also disclosed are processes for the synthesis of ammonia, comprising: conveying a flow of a reactant gas mixture into the reaction chamber via an entry port; wherein the reaction chamber is at a pressure of about 2 torr to about 20 atm; and wherein the reaction chamber comprises a disclosed heterogeneous catalyst; contacting the reactant gas mixture and the heterogeneous catalyst; heating the heterogeneous catalyst using microwave energy; reacting the reactant gas mixture in contact with the heterogeous catalyst, thereby providing a product gas mixture; and wherein the heterogeneous catalyst reaction has a heterogeneous catalyst reaction temperature temperature of from about 50 C to about 1000 C; wherein the reactant gas mixture comprises nitrogen and hydrogen; wherein the product gas mixture comprises ammonia; conveying the product gas mixture from the reaction chamber via an exit port.

Also disclosed are processes for the synthesis of ammonia, comprising: providing a reaction chamber with a disclosed heterogeneous catalyst, or a heterogeneous catalyst made by a disclosed process; conveying a flow of a reactant gas mixture into the reaction chamber via an entry port; contacting the reactant gas mixture and the heterogeneous catalyst; heating the heterogeneous catalyst using microwave energy, thereby providing a product gas mixture; and conveying the product gas mixture from the reaction chamber via an exit port; wherein the reaction chamber has a pressure of about 2 torr to about 20 atm; wherein the reactant gas mixture comprises nitrogen and hydrogen; and wherein the product gas mixture comprises ammonia.

### C. CATALYST COMPOSITIONS

In one aspect, the disclosure relates to heterogeneous catalysts for ammonia production comprising ruthenium (Ru) metal and a metal oxide. More specifically, in one aspect, the present disclosure relates to heterogeneous catalysts comprising: a metal selected from Group 7, Group 8, Group 9, Group 10, Group 11, or combinations thereof; wherein the metal is a promoter material and present in an amount from about 1 wt % to about 50 wt % based on the total weight of the heterogeneous catalyst; and a metal oxide support.

Further promoters used herein are provided as but not limited to Potassium (K), Cesium (Cs), Barium (Ba) and Cerium (Ce).

Support materials in the form of metal oxides are provided as but not limited to MgO, CeCO₂, and BaCeO₃.

### D. PROCESSES FOR PREPARING THE CATALYST COMPOSITIONS

Materials for used in catalyst preparation were obtained as follows: Magnesium oxide (MgO, Timilon Technology), Cerium (IV) oxide (99.95%, CeO₂, Sigma-Aldrich), Ruthenium (III) nitrosylnitrate (>31.3% Ru, Ru(NO)(NO₃)³, Alfa Aesar), Cesium nitrate (99.8%, CsNO₃, Alfa Aesar), and Potassium nitrate (>99.0%, KNO₃, Fisher Chemical).

All catalysts were prepared by incipient wetness method. For example, the CeO₂ support was wet impregnated with a solution of Ru(NO)(NO₃)³ and CsNO₃. After drying in air (373K, 12 h), the sample was calcined at 823K for 4 h. The catalyst thus obtained had a nominal 4% wt. content of Ru and 2 wt % Cs and was designated as CsRu/CeO₂(2-4%). Moreover, Ru/CeO₂(4%), Ru/CeO₂(8%), CsRu/CeO₂(1-4%), CsRu/CeO₂(4-4%), CsRu/CeO₂(6-4%), KRu/CeO₂(2-4%), Ru/MgO(4%), Ru/MgO(8%), CsRu/MgO(1-4%), CsRu/MgO(2-4%), CsRu/MgO(4-4%), CsRu/MgO(6-4%), and KRu/MgO(2-4%), etc. were also prepared following the same procedure.

In accordance with the purpose of the disclosure, as embodied and broadly described herein, another aspect of the present disclosure relates to processes for making the disclosed catalyst compositions. In an aspect the process comprises preparing a mixture of ruthenium salt and the metal oxide.

In various aspects, disclosed are processes for synthesizing a disclosed heterogeneous catalyst, the process comprising: forming a metal compound solution comprising a solvent and a metal compound; forming a mixture of the metal compound solution and a metal oxide; wherein the metal compound is present in amount corresponding to about 0.05 wt % to about 50 wt % based on the total weight of the metal oxide powder and the metal compound; wherein the metal compound is an organometallic compound or a metal salt comprising a metal selected from Group 7, Group 8, Group 9, Group 10, Group 11, or combinations thereof; wherein the metal oxide is present in an amount of about 60 wt % to about 99 wt % based on the total weight of the metal oxide and the metal compound; and, reacting the mixture at a temperature of about 5 C to about 95 C for a period of time from about 1 minute to about 72 hours; thereby forming the heterogeneous catalyst.

In a further aspect, disclosed are processes for synthesizing a disclosed heterogeneous catalyst, the process comprising: forming a metal compound solution comprising a solvent and a metal compound; forming a mixture of the metal compound solution and a metal oxide; wherein the metal compound is present in amount corresponding to about 0.05 wt % to about 20 wt % based on the total weight of the metal oxide powder and the metal compound; wherein the metal compound is an organometallic compound or a metal salt comprising a metal selected from Group 7, Group 8, Group 9, Group 10, Group 11, or combinations thereof; wherein the metal oxide is present in an amount of about 60 wt % to about 99 wt % based on the total weight of the metal oxide and the metal compound; and, reacting the mixture at a temperature of about 5 C to about 95 C for a period of time from about 1 minute to about 72 hours; thereby forming the heterogeneous catalyst.

In a further aspect, disclosed are processes for synthesizing a disclosed heterogeneous catalyst, the process comprising: forming a metal compound solution comprising a solvent and a metal compound; forming a mixture of the metal compound solution and a metal oxide; wherein the metal compound is present in amount corresponding to about 0.05 wt % to about 10 wt % based on the total weight of the metal oxide powder and the metal compound; wherein the metal compound is an organometallic compound or a metal salt comprising a metal selected from Group 7, Group 8, Group 9, Group 10, Group 11, or combinations thereof; wherein the metal oxide is present in an amount of about 60 wt % to about 99 wt % based on the total weight of the metal oxide and the metal compound; and, reacting the mixture at a temperature of about 5 C to about 95 C for a period of time from about 1 minute to about 72 hours; thereby forming the heterogeneous catalyst.

In various aspects, disclosed processes for synthesizing a disclosed heterogeneous catalyst, the process comprising: forming a ruthenium compound solution comprising a ruthenium compound and a solvent; forming a mixture of the ruthenium compound solution and a metal oxide; wherein the ruthenium compound is present in amount corresponding to about 0.05 wt % to about 50 wt % based on the total weight of the metal oxide powder and the ruthenium; wherein the ruthenium compound is an organometallic compound or a metal cation derived from a metal salt; wherein the metal oxide is present in an amount of about 60 wt % to about 99 wt % based on the total weight of the metal oxide and the ruthenium compound; and, reacting the mixture at a temperature of about 5 C to about 95 C for a period of time from about 1 minute to about 72 hours; thereby forming the heterogeneous catalyst.

In various aspects, disclosed processes for synthesizing a disclosed heterogeneous catalyst, the process comprising: forming a ruthenium compound solution comprising a ruthenium compound and a solvent; forming a mixture of the ruthenium compound solution and a metal oxide; wherein the ruthenium compound is present in amount corresponding to about 0.05 wt % to about 20 wt % based on the total weight of the metal oxide powder and the ruthenium; wherein the ruthenium compound is an organometallic compound or a metal cation derived from a metal salt; wherein the metal oxide is present in an amount of about 60 wt % to about 99 wt % based on the total weight of the metal oxide and the ruthenium compound; and, reacting the mixture at a temperature of about 5 C to about 95 C for a period of time from about 1 minute to about 72 hours; thereby forming the heterogeneous catalyst.

In various aspects, disclosed are processes for synthesizing a disclosed heterogeneous catalyst, the process comprising: forming a ruthenium compound solution comprising a ruthenium compound and a solvent; forming a mixture of the ruthenium compound solution and a metal oxide; wherein the ruthenium compound is present in amount corresponding to about 0.05 wt % to about 10 wt % based on the total weight of the metal oxide powder and the ruthenium; wherein the ruthenium compound is an organometallic compound or a metal cation derived from a metal salt; wherein the metal oxide is present in an amount of about 60 wt % to about 99 wt % based on the total weight of the metal oxide and the ruthenium compound; and, reacting the mixture at a temperature of about 5 C to about 95 C for a period of time from about 1 minute to about 72 hours; thereby forming the heterogeneous catalyst.

In various aspects, the disclosed catalysts can be prepared by an incipient wetness impregnation method.

In various aspects, the disclosed catalysts can be prepared by using spray application methods comprising spraying a solution of the ruthenium salt onto a metal oxide support.

In various aspects, the disclosed catalysts can be prepared using chemical vapor deposition methods.

In various aspects, the disclosed catalysts can be prepared using a metal nano particle material, wherein a ruthenium metal nanoparticle material is prepared using sol-gel techniques, followed by adhering the ruthenium metal containing sol-gel onto the metal oxide support, then calcining the material to fix the ruthenium metal onto the metal oxide support.

In various aspects, drying is understood to include a state wherein the catalyst is essentially dry, but nevertheless comprises some amount of solvent, such as water. That is the material can be dry, but have solvent molecules present in the pore structure of the catalyst such that there are hydroxyl (OH) groups and protons present on a surface of the catalyst.

In various aspects, the catalyst can be used in the disclosed methods for conversion of nitrogen and hydrogen into ammonia after the calcining step of the disclosed methods for the preparation of the catalyst. Optionally, after the calcining step, the catalyst can be further processed by a pre-reduction step wherein the catalyst is exposed to a flow of gas comprising hydrogen. The pre-reduction step can further comprise heating the catalyst in the presence of the gas flow.

### E. PROCESSES FOR SYNTHESIS OF AMMONIA

The present disclosure pertains to processes to synthesize ammonia using a high-pressure microwave-assisted reactor. The present disclosure provides methods that integrate microwave reaction chemistry, heterogeneous catalysis, and chemical reaction engineering. Application of microwaves in the chemical field has generated much excitement in recent years due to the ability to provide high selectivity, shorter reaction times under relatively mild reaction conditions, which is enhanced via heterogenous catalysis. These benefits are mainly achieved through the unique ability of microwaves to directly, selectively heat specific material targets. In the microwave electromagnetic field, materials are directly heated using the dielectric effect and achieve selective heating by using dipoles-dipole interactions. In microwave-assisted catalysis, in addition to the catalytic function, the catalysts also provide the ability to function as a microwave energy absorber. More specifically the present disclosure is an apparatus for providing synthesis of gaseous reactants with microwave assisted catalysis comprising: a variable frequency microwave reactor with a microwave generator and a reactor chamber that includes an entrance port and an exit port, where the reactor chamber allows for heat and pressurization of gas reactant mixtures to at least 260 degrees Centigrade and 200 psi where the microwave reactor also includes at least two IR sensors; wherein at least one IR sensor measures reactor temperatures and at least one IR sensor measures bulk catalyst temperatures; and wherein the microwave reactor can supply microwave irradiation to the reactor chamber of at least 5.850 GHz frequency.

In various aspects, the present disclosure pertains to an apparatus and process to synthesize ammonia using a high-pressure microwave-assisted reactor is provided. This overall system design integrates microwave reaction chemistry, heterogeneous catalysis, and chemical reaction engineering. Application of the use of microwave radiation in the chemical field has generated much excitement in recent years due the ability to provide microwave energy that is highly selective, allows for shorter reaction times, and relatively mild reaction conditions, especially when utilizing heterogenous catalysis. These benefits are mainly achieved through the unique ability of microwaves to directly, selectively heat specific material targets. In the microwave electromagnetic field region, materials are directly heated through the dielectric effect and achieve selective heating by implementing dipole interactions. In microwave-assisted catalysis, in addition to the catalytic function, the catalysts also work as a type of microwave energy absorber. Catalysts with high-catalytic activity and significant dielectric sensitivity are sought after for use in microwave-assisted reactions, such as ammonia synthesis.

According to Le Chatelier's principle, for the ammonia synthesis reaction,

N₂+3H₂→2NH₃,

high pressure will largely shift the equilibrium towards the ammonia production. However, to achieve catalysis heating and high microwave energy utilization, the reactors are typically constructed with radio-frequency transparent materials, such as glass, quartz, and ceramics.

The use of high-pressures in microwave-assisted reaction is largely prohibited by these fragile reactors. The present disclosure includes development of catalysts capable of high ammonia synthesis activity and microwave energy utilization. Moreover, the use of a high-pressure microwave reaction system prototype created for ammonia synthesis is provided.

In a further aspect the gaseous reactants are hydrogen and nitrogen and the synthesis is ammonia synthesis.

In a further aspect, the microwave reactor is a multimode microwave reactor.

In a further aspect, the microwave reactor is a monomode progressive microwave reactor.

In a further aspect, the microwave reactor is a progressive wave design microwave reactor.

In a further aspect, the reactor chamber is a quartz tube reactor chamber where the quartz tube reactor chamber has a quartz tube portion and a metal tube portion that is connected to the quartz tube portion via a pyrex glass/metal transition connector.

In a further aspect, the microwave reactor and reactor chamber is shielded with a transparent thermoplastic or thermoset tube that provides safety from any possible explosion that takes place within the microwave reactor.

In a further aspect, the reactor chamber supports at least a 6000 mL/g_{cat}·h weight hourly space velocity (WHSV) of heterogenous or homogeneous catalysts.

In a further aspect, the microwave reactor and reactor chamber reactant gas mixtures and ammonia effluent is analyzed with a gas chromatograph.

In a further aspect the gas chromatograph is a micro gas chromatograph.

In a further aspect the ammonia synthesis activity in the reactor chamber is increased in the presence of K and Cs promoters together with both MgO and CeO₂ supported Ru catalysts.

In a further aspect the ammonia synthesis activity is increased most significantly with the Cs promoter than with the K promotor.

In a further aspect the ammonia synthesis activity reaches a maximum when the Cs loading is increased from 1 wt % to 2 wt % and reaches the maximum activity for both CeO₂ and MgO supported catalysts.

In a further aspect ammonia formation rates reach 26.4 ml/h·g_{cat} for CsRu/CeO₂ at a 2-4 wt % loading and and 21.5 ml/h·g_{cat} for CsRu/MgO at a 2-4 wt % loading of catalysts respectively

In a further aspect, further increases in Cs/Ru mass ratios result in ammonia synthesis activity decreases for both CeO₂ and MgO supported catalysts.

In a further aspect under the same Cs/Ru mass ratio, the CeO₂ supported catalysts always show higher activity than the one supported on MgO.

In a further aspect the ammonia formation rate is nearly tripled with pressure increases from ambient to 80 psig over CsRu/CeO₂ catalysts at 2-4 wt. %, and wherein the ammonia formation rate reaches 94.2 ml/h·g_{cat}.

In addition, the present disclosure provides for a microwave-assisted catalysis process for producing enhanced ammonia synthesis comprising providing a reaction chamber within a reactor with a heterogeneous catalyst comprising: conveying a flow of a reactant gas mixtures into the reaction chamber via an entry port; wherein the reaction chamber pressurizes the reaction chamber to a pressure of 700 torr to 15000 torr; contacting the reactant gas mixture with the heterogeneous catalyst; heating reaction chamber and the heterogeneous catalyst using microwave energy; reacting the reactant gas mixture in contact with the heterogeous catalyst, thereby providing a product gas mixture; and wherein the heterogeneous catalyst has a heterogeneous catalyst temperature of from about 50 C to about 1000 C; wherein the reactant gas mixture comprises nitrogen and hydrogen; wherein the product gas mixture comprises ammonia; and conveying the product gas mixture from the reaction chamber via an exit port.

This process further comprises reactant gas mixture comprises about 15 vol % to about 25 vol % of nitrogen; and about 45 vol % to about 75 vol % of hydrogen; provided that the vol % ratio of nitrogen to hydrogen is about 1 to about 5 and the total vol % of all gases in the reactant gas mixture is equal to about 100 vol %.

Catalysts screening can be measured in a quartz tube reactor (8 mm-ID, 12 mm-OD) in atmospheric pressure. For example, a variable frequency microwave reactor (Lambda MC1330-200) can be used to apply microwave irradiation to the catalyst at 5.850 GHz. The microwave reactor system was equipped with two infrared (IR) sensors, one used to measure reactor temperature, the other used to measure bulk catalyst temperature. The CeO₂ supported catalysts (1.2 g) can be sieved to 60-100 mesh and tested in a flowing gas mixture of 75 vol. % H₂ and 25% vol. N₂ at 533 K under 6000 mL/g_{cat}·h weight hourly space velocity (WHSV). For the MgO supported catalysts, 0.4 g catalyst (60-100 meshes) can be mixed with 0.1 g of 200 mesh sized silicon carbide (SiC) to improve the microwave adsorption ability. The reaction activity can be tested under the same temperature, gas composition, and WHSV. The ammonia concentration in the effluent can be analyzed by a 4-channel Inficon Fusion micro gas chromatography (Micro-GC).

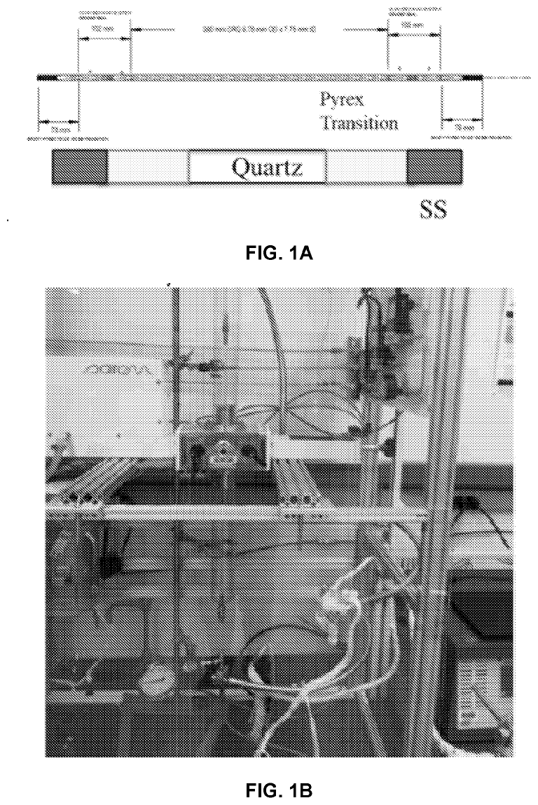

The present disclosure is the first reported high-pressure, microwave catalytic reaction for ammonia synthesis. As shown in FIG. 1A, the quartz microwave tube reactor was joined to the stainless-steel connector via a pyrex (glass) transition, a fabrication technique developed by Scientific Glass Instrumentation in Texas. The upper limit of the reactor pressure was 200 psig. The high-pressure microwave reaction system prototype was created using this high pressure microwave reactor tube. As shown in FIG. 1(b), for safety, the system was shielded with clear plastic tubing outside of the reactor and plastic boards around the framework of an experimental station. A Sairem solid-state microwave reactor (PCCMWR340L130PVMR1PE-B) was used to supply microwave irradiation at 2.450 GHz frequency, the catalyst temperature was measured by IR sensor.

### Reactor Design

Off-the shelf microwave reaction vessels are based on a mono-mode progressive wave system.

To date, studies have been based on highly focused mono-mode standing wave reactor designs that focus the output of the microwave generator into a small volume (about a 2 cm cube) wherea catalyst bed was provided. This design is advantageous in that it produces the highest possible E-field to drive the catalytic reaction and can yield very well characterized data. There are also some disadvantage including the fact that the volumetric area of the microwave application cannot be increased for simple scale-up. In this case, throughput can be increased only by increasing the flow of the reactants through the process zone. Phase I testing of this microwave and accompanying reactor design resulted in low energy efficiencies with this mono-mode standing wave reactor.

The most practical choice for scale-up of ammonia (and other) syntheses, therefore is the use of a multi-mode reactor treatment zone that can be of an almost arbitrarily large volume. Potentially, a large volume of catalyst could be placed in the reactor with reactant gases flowing through the catalyst. A kitchen-sized microwave is an example of the use of a multi-mode reactor treatment. This design is highly scalable, but does not allow for the reaction zone to be subjected to the highest possible E-fields. The use of these highest E-field is believed to be the one of the major advantages of the microwave reaction vs that of a traditional thermal approach with these reactions. Before moving towards this design, the question of the need of a high electric field within the catalyst bed had to be addressed.

The mono-mode progressive wave reactor, referred to as the “Baby Rocket,” allowed an expanded volume reaction zone compared to the standing wave reactor while sacrificing some intensity of field strength; achievable strengths between the mono-mode standing wave and the multi-mode designs are therefore achieved

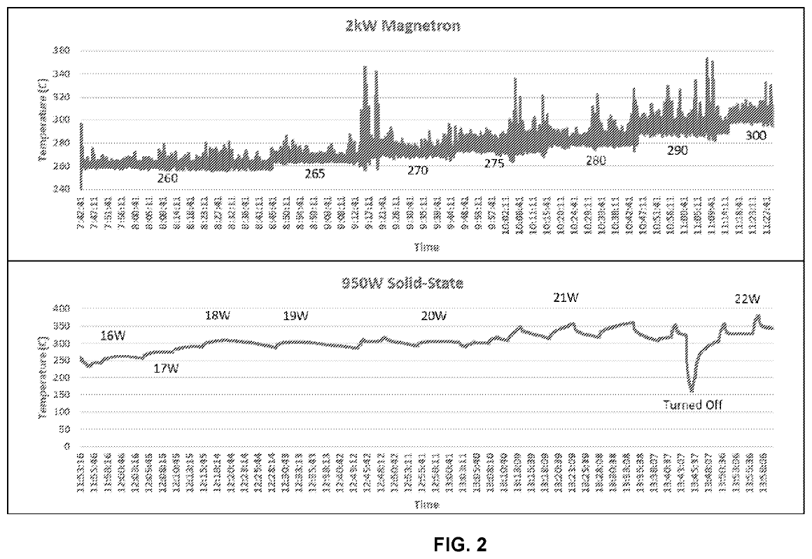

Recent work using a cerium-based catalyst support suggested led to a decision to use a solid-state microwave generator capable of highly accurate microwave dosing at very low power levels. With the use of the low power generator, the input power could be adjusted in 1 W increments and allowed a more precise control of the temperature and reduced the reflective power to zero (0). All reaction temperatures (250-400° C.) were obtained using less than 25 W as seen in Table 1. The 2 kW magnetron can only be turned down to 10% of its total power to maintain a consistent signal. With the high absorbing CeO₂ based catalyst, this is too much power which results in reflective power and large temperature swings seen in FIG. 2. Using the lower power solid-state generator results in no reflective power and a much more stable temperature profile. The oscillations in temperature on the solid-state test is most likely a change on the surface of the material and not a function of the microwave reactor. If fitted with a signal generator, the temperature can be better maintained by pulsing the power, i.e. only provide the reaction with MW power as needed rather than constantly powering the reactor. These results with the generator support, and even reinforce, the conviction that high field optimization will be of secondary importance to scaling applicator volume.

TABLE 1
Power comparison between magnetron
and solid-state MW generator.

| | | Input | Reflective |
|---|---|---|---|
| | Temperature | Power | Power |
| 2 kW Magnetron | 260 | 195 W | 62 W |
| | 300 | 195 W | 56 W |
| 950 W Solid-State | 300 | 18 W | 0 W |
| | 400 | 23 W | 0 W |

### F. PROCESS MODELING

### MW-Assisted Low-Pressure Synthesis

The plant-wide models were developed and simulated in Aspen Plus. For the low-pressure MW-assisted process, reactor experimental data from microwave reactors was used, as shown in Table 2. The plant scale is 60,000 tons/year of NH₃.

TABLE 2
Reactor experimental data for ammonia
synthesis using MW plasma technology.

| | | H₂:N₂ | | |
|---|---|---|---|---|
| Exp. | Single-Pass | Molar | Temperature | |
| Data | Conv. (%) | Ratio | (° C.) | Pressure(atm) |
| 1 | 3.5 | 3:1 | 300 | 1 |
| 2 | 15 | 3:1 | 260 | 5.1 |

One of the important aspects of then present disclosure is the separation of unconverted reactants from NH₃ for the low-pressure ammonia synthesis process. Based on the literature review and initial evaluation, candidate separation technologies are (i) temperature swing adsorption, (ii) ionic liquid absorption, (iii) water absorption, and (iv) cryogenic separation. Preliminary models of the last two separation technologies have been developed.

### Water Absorption for Low-Pressure NH₃ Separation

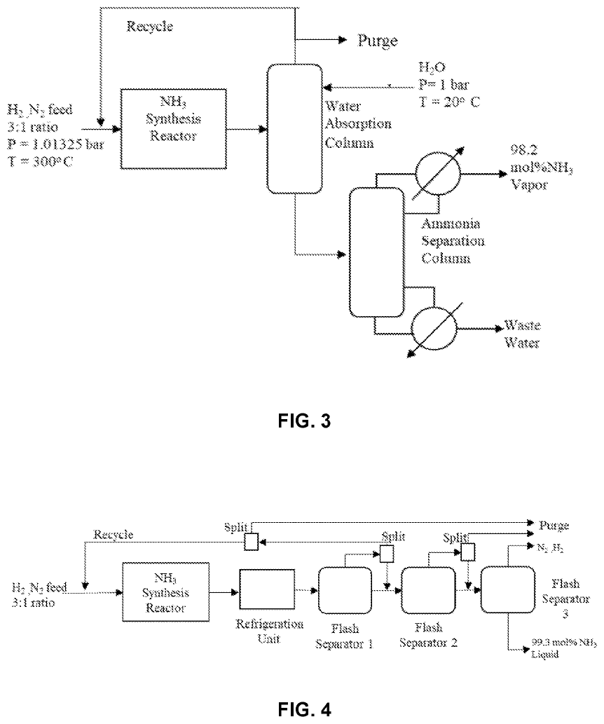

The block flow diagram of the low-pressure ammonia synthesis process with water absorption is shown in FIG. 3. Hydrogen and nitrogen are fed to the microwave reactor which is currently modeled as an isothermal reactor. A furnace is used to heat the feed to 300° C. before it enters the MW-assisted reactor. Using the data provided in Table 2, the MW-assisted reactor was modeled in Aspen Plus. The MW reactor product stream consists of ammonia, unreacted nitrogen and hydrogen. The product stream is sent to the water absorption column. Water is used as a solvent because ammonia has good solubility in water (Hales J M, Drewes D R, Richland. Solubility of ammonia in water at low concentrations. Atmospheric Environment 1979; Vol. 13: 1133-1147). Currently about 95% of the ammonia is being absorbed in the absorber column. The vapor stream of the absorber mainly consists of hydrogen and nitrogen, with very small quantity of water and ammonia. A small portion of the vapor stream is purged. The remaining vapor stream is recycled after compressing it with inter-stage cooling (not shown in the figure above) to remove most of the water. Fresh H₂/N₂ is added to maintain the molar ratio of H₂:N₂ to 3:1 in the total feed stream to the reactor. The liquid stream from the absorber is fed to a distillation column, where ammonia is separated from the water at a purity of 98.2 mol %.

### Cryogenic Separation Technology

To simulate the cryogenic separation technology, experimental VLE data (Sawant M R, Patwardhan A W, Gaikar V G, Bhaskaran M. Phase Equilibria Analysis of the binary N₂—NH₃ and H₂—NH₃ systems and prediction of the ternary phase equilibria. Fluid Phase Equilibria 2006; 52-62.) for H₂—NH₃ and N₂— NH₃ system at pressure between 1-10 atm and temperature between −73° C. to 126.85° C. was used to regress the binary interaction parameters. It should be noted that there is very limited data available in the low-pressure range for these systems thus the accuracy of the VLE model could not be properly evaluated. The block flow diagram of low-pressure ammonia synthesis with cryogenic separation technology is shown in FIG. 4. The ammonia synthesis section is similar to the synthesis section shown in FIG. 3. The MW reactor product stream is cooled to 350 C. It is then refrigerated to −70 C by a two-stage refrigeration cycle (for brevity, the refrigeration cycle is not shown in FIG. 4). The cold reactor outlet stream is fed to Flash Separator 1, the vapor stream from the Flash Separator 1 consisting of 99 mole % hydrogen and nitrogen that is split into two streams. The major portion of the split is recycled to the microwave reactor. The liquid stream from the Flash Separator 1 is mixed with the remaining vapor stream from Flash Separator 1 to improve recovery of unreacted N₂ and H₂. This stream is fed to Flash separator 2 that operates at a lower pressure than Flash Separator 1. Another stage of separation is used to improve separation. Finally, ammonia at 99.3 mole % purity is produced as the liquid stream from the final stage. In the current version, the vapor streams which are purged from Flash Separator 2 and 3 have relatively low (small) flows and therefore are not recycled. However, these can be considered for recycling after processing appropriately to remove the small quantity of NH₃ in these streams.

For reducing the energy consumption of this process, the pressure and temperature of each of the flash separators play a critical role. A grid search approach was used to obtain the optimal pressure/temperatures.

### Temperature Swing Adsorption (TSA)

TSA technology is also a feasible technology for low-pressure NH₃ separation. Zeolites 13X, 4A, and 5A are candidate materials for adsorbing NH₃ at room temperature (298.15 K) and atmospheric pressure (Helminen J, Helenius, Paatero E. Adsorption Equilibria of Ammonia Gas on Inorganic and Organic Sorbents at 298.15 K. Journal of Chemical & Engineering Data 2001; Vol. 46: 391-399). A temperature swing adsorption model is currently being developed in the current quarter. In the upcoming quarters, this model will be completed and integrated with the process model.

### Ionic Liquid Absorption

It has recently been discovered that ammonia can be captured by ionic liquids at atmospheric pressure (Shang D, Bai L, Zeng S, Dong H, Gao H, Zhang X, Zhang S. Enhanced Ammonia Capture by imidazolium-based protic ionic liquids with different anions and cations substituents. Journal of Chemical Technology and Biotechnology 2018, Vol. 93:1228-1236.). The simulation model involves feeding ammonia synthesis reactor product stream into an absorption column. The liquid from the bottom can be flashed in a series of depressurized flash vessels to recover the ammonia and the ionic liquid in two separate streams (Liu X, Chen Y, Zeng S, Zhang X, Zhang S, Liang X, Gani R, Kontogeorgis G M. Structure Optimization of tailored ionic liquids and process simulation for shale gas separation. AIChE 2020; Vol 66.). This separation technology will also be modeled in upcoming reporting periods, and techno-economic studies will be carried out.

### Haber-Bosch Process

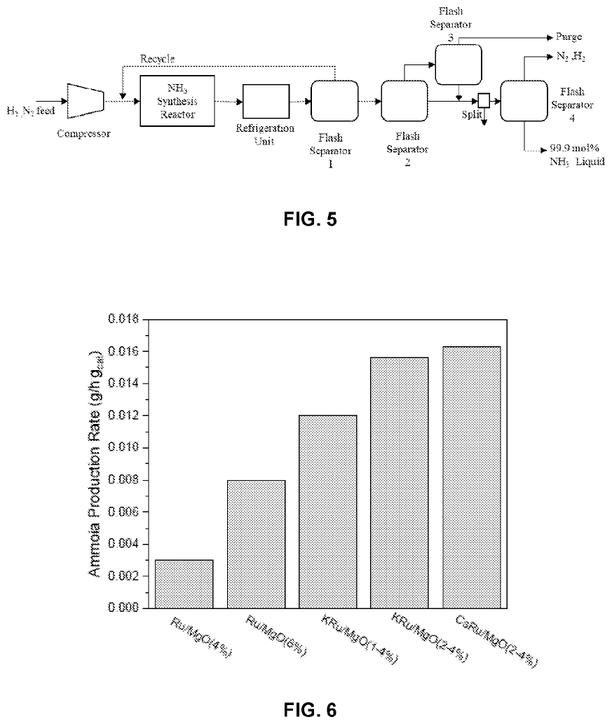

The Haber-Bosch process model was obtained from thAe spen library where experimental reactor data was used to develop the model (Aspen Technology. Aspen Plus Ammonia Model. 2015). Some modifications were made in the Aspen library model to ensure that the process boundary conditions for the Haber-Bosch process and the low-pressure ammonia synthesis process are identical. In the Aspen model, four reactors were modeled using RPlug blocks. The rate law expression used to simulate the reactors was obtained from Nielsen et al. (Nielsen A, Forlag J G. An Investigation on Promoted Iron Catalysts for the Synthesis of Ammonia. AIChE 1968; Vol 14: 850-850). The reactors single-pass conversion was compared with Elnaishaie et al. (Elnashaie S S, Abashar M E, AI-Ubaid A S. Simulation and Optimization of an Industrial Ammonia Reactor. Industrial & Engineering Chemistry Research 1988; Vol. 27; 2015-2022) and found to be in good agreement. The block flow diagram of the modified Haber-Bosch process is shown in FIG. 5. Hydrogen and nitrogen at 1 atm is compressed to 275 bar using a multistage compressor. The compressor outlet stream was heated using furnace temperatures reaching 442° C. and then fed to a series of four of reactors with inter-stage cooling. The reactor product was then cooled to 4 C. The refrigerated stream is fed to Flash Separator 1. The vapor stream from Flash Separator 1 is recycled to the reactor. The liquid stream from Flash Separator 1 is sent through a series of flash separators as shown in FIG. 5 finally producing a purity of 99.9 mole % liquid NH₃.

Initial investigations of promoters and supporters on the ammonia production rate demonstrated a production rate of ≥0.08 gNH₃/g_{cat}/h in 2.45 GHz fixed frequency microwave (MW) reactor.

### G. EFFECT OF PROMOTERS ON AMMONIA SYNTHESIS OVER 4% RU/MGO CATALYST

### Effect of Promoter on Ammonia Production Rate Over MgO Based Catalysts

Ru/MgO is considered as the second-generation catalysts for ammonia synthesis, because the enhanced activity and stability. Ru/MgO was selected as baseline reference in the microwave-enhanced catalytic ammonia synthesis. FIG. 6 shows the ammonia production rate, in terms of g NH₃/h. gram of catalyst, over MgO supported catalysts with different promoters. The presence of promoters improves the performance of the catalyst.

Adding 1% K as a promoter, the ammonia production rate is increased from 0.003 to 0.012 g/h·g_{cat}, which is four times higher than that of Ru/MgO(4%). When the second promoter Ba is introduced, ammonia production rate decreases to 0.010 g/h·g_{cat}, indicating its negative effect for ammonia synthesis. Different from Ba, when Ce is added as the second promoter, ammonia production rate is increased slightly, reaching 0.013 g/h·g_{cat}. The lower ammonia production rate over KBaCeRu/MgO(1-1-1-4%) further confirms the negative effect of Ba.

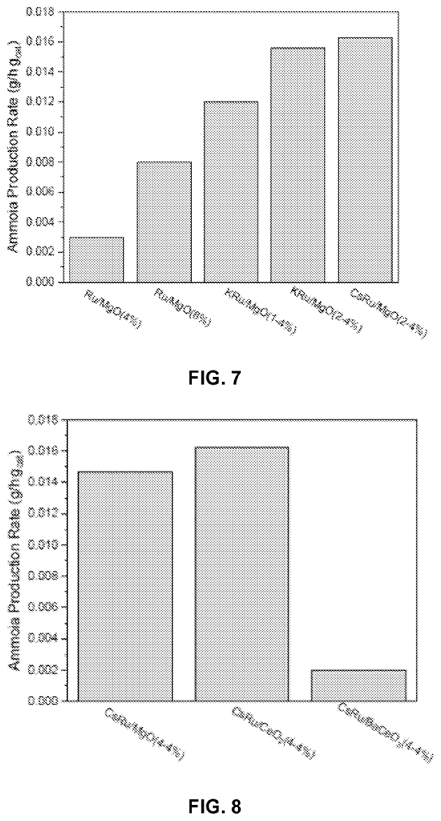

Based on the above analysis, the addition of second promoter has some effect over Ru/MgO based catalysts. In addition to K, Cs is used as a promotor. As shown in FIG. 7, compared with K, Cs shows larger improvement on ammonia production rate under the same loading (2%).

### Effect of Ru and Promoter Loading on Ammonia Production Rate

As shown in FIG. 7, when Ru loading is increased from 4% to 8%, ammonia production rate is increased to 0.008 g/h·g_{cat}, which is more than doubled than that of Ru/MgO(4% Ru). Adding K causes an increase in ammonia production rate. Over the KRu/MgO catalyst, when K loading is increased from 1% to 2%, the ammonia production rate is increased.

### H. EFFECT OF SUPPORT ON AMMONIA PRODUCTION RATE

FIG. 8 shows the effect of support on ammonia synthesis. Three support materials, MgO, CeO₂, and BaCeO3 are invested. Among three supports, CeO₂ shows the best catalytic performance under the same Ru and Cs loadings. The BaCeO3 supported catalyst shows much lower ammonia production rate than other two catalysts.

### I. EFFECT OF SUPPORT AND PROMOTER ON AMMONIA PRODUCTION RATE

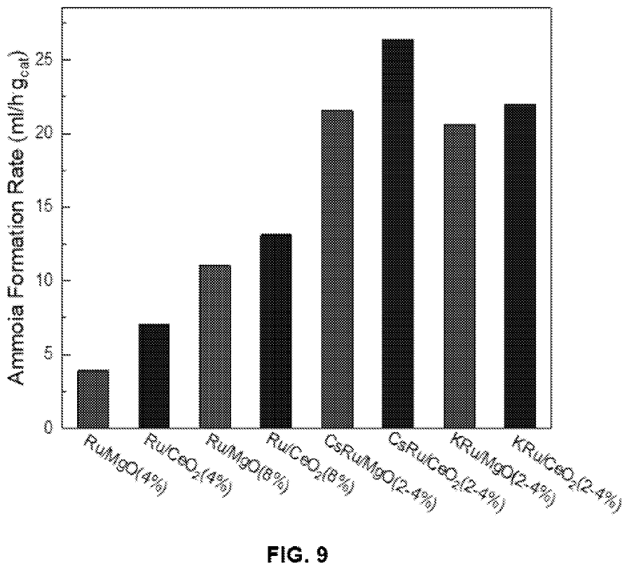

Based on the above experimental results, the promoter and support strongly affect the catalytic performance in ammonia synthesis. A series of catalysts with different support and promoter were designed and synthesized for microwave catalytic synthesis of ammonia. As shown in FIG. 9, under the same Ru and promoter loadings, the CeO₂ supported catalysts show higher ammonia production rate than MgO supported catalysts. Meanwhile, either on CeO₂ supported catalysts or MgO supported catalysts, Cs promoter shows higher ammonia production rate than K promoter. Among all of these catalysts, CsRu/CeO₂(2-4%) exhibits the highest catalytic activity in microwave catalytic synthesis of ammonia

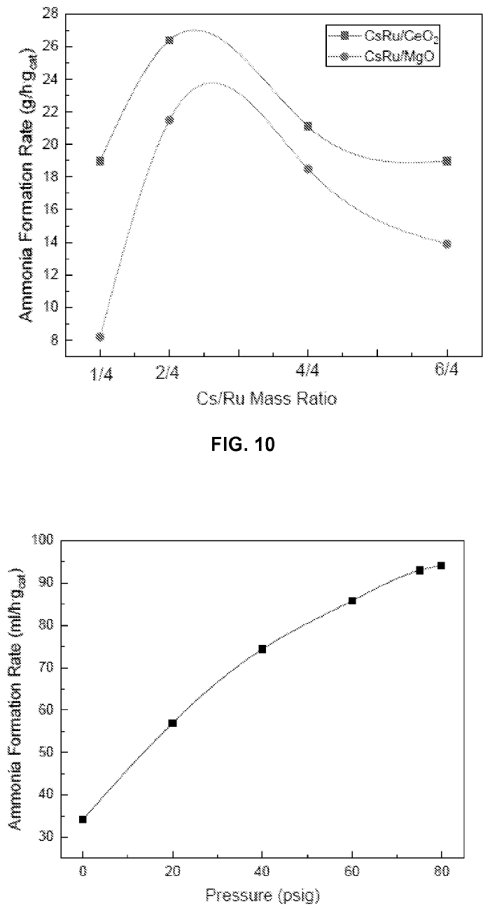

FIG. 9 shows the support and promoter effects for Ru catalysts for microwave assisted₂ammonia synthesis under ambient pressure. CeO-supported Ru catalysts show much higher ammonia synthesis activity over MgO supported Ru catalysts under the same active metal loading. The ammonia formation rate was increased when the Ru loading was increased over both the CeO₂- and MgO-supported catalysts. The ammonia synthesis activity was significantly increased in the presence of a K and Cs promoter over both MgO- and CeO₂-supported Ru catalysts, especially with the Cs promoter. Meanwhile, the ammonia synthesis activity was affected by the promoter loading amount. As shown in FIG. 10, when the Cs loading was increased from 1 to 2% wt., the ammonia synthesis activity reaches a maximum for both CeO₂- and MgO-supported catalysts. The ammonia formation rate reached 26.4 ml/h·g_{cat} and 21.5 ml/h·g_{cat} for CsRu/CeO The apparatus of claim 1, wherein the microwave reactor is a multimode microwave reactor (2-4%) and CsRu/MgO(2-4%), respectively. With further increase in Cs/Ru mass ratio, ammonia synthesis activity decreased for both CeO₂- and MgO-supported catalysts. Under the same Cs/Ru mass ratio, the CeO₂ supported catalysts always showed the higher activity than the one supported by MgO, further confirming CeO₂ has better promoting effect than MgO. Moreover, the CeO₂-supported catalysts show high microwave energy utilizing ability, while the MgO-supported catalysts exhibited much lower microwave energy utilizing ability. To achieve a 533 K reaction temperature, the CeO₂-supported catalysts only needed 10 to 15 W of microwave power, while MgO-supported catalysts usually required 70 to 85 W of microwave power.

The high-pressure ammonia synthesis was carried out in the high-pressure microwave-assisted reaction system that was developed, see FIGS. 1A and 1B. With 1.2 g CsRu/CeO₂(2-4%) as catalyst, the reaction tested in a flowing gas mixture of 50% vol. H₂ and 50% vol. N₂ at 533 K under 6000 mL/g_{cat}·h WHSV at 593 K. The frequency of microwave was fixed at 2.450 GHz with 340 W power input. As shown in FIG. 11, the ammonia formation rate was significantly increased with high-pressure utilization. The ammonia formation rate was nearly tripled with a pressure increase from ambient to 80 psig over CsRu/CeO₂(2-4%), reaching to 94.2 ml/h·g_{cat}.

In the present disclosure, a considerable ammonia formation rate was achieved under moderate reaction conditions. The ammonia formation rate reached 94.2 ml/h·g_{cat} with developed CsRu/CeO₂(2-4%) as catalyst under 80 psig pressure at 593 K. In the present technology, catalysts with high ammonia synthesis activity and microwave utilizing ability were developed.

In accordance with the purpose of the disclosure, as embodied and broadly described herein, another aspect of the present disclosure relates to processes for the synthesis of ammonia, comprising: conveying a flow of a reactant gas mixture into the reaction chamber via an entry port; wherein the reaction chamber is at a pressure of about 2 torr to about 20 atm; and wherein the reaction chamber comprises a disclosed heterogeneous catalyst; contacting the reactant gas mixture and the heterogeneous catalyst; heating the heterogeneous catalyst using microwave energy; reacting the reactant gas mixture in contact with the heterogenous catalyst, thereby providing a product gas mixture; and wherein the heterogeneous catalyst reaction has a heterogeneous catalyst reaction temperature temperature of from about 50 C to about 1000 C; wherein the reactant gas mixture comprises nitrogen and hydrogen; wherein the product gas mixture comprises ammonia; conveying the product gas mixture from the reaction chamber via an exit port.

In various aspects, a disclosed process for ammonia synthesis comprises: providing a reaction chamber with a disclosed heterogeneous catalyst, or a heterogeneous catalyst made by a disclosed process; conveying a flow of a reactant gas mixture into the reaction chamber via an entry port; contacting the reactant gas mixture and the heterogeneous catalyst; heating the heterogeneous catalyst using microwave energy, thereby providing a product gas mixture; and conveying the product gas mixture from the reaction chamber via an exit port; wherein the reaction chamber has a pressure of about 2 torr to about 20 atm; wherein the reactant gas mixture comprises nitrogen and hydrogen; and wherein the product gas mixture comprises ammonia.

### J. REFERENCES

References are cited herein throughout using the format of reference number(s) enclosed by parentheses corresponding to one or more of the following numbered references. For example, citation of references numbers 1 and 2 immediately herein below would be indicated in the disclosure as [Ref. 1, 2] or [Ref. 1-2].
[1] F. Jiao, B. Xu, Adv. Mater. 2019, 31, 1805173.
[2] S. A. Lawrence, Amines: Synthesis, Properties and Applications, Cambridge University Press, Cambridge, UK, 2004.
[3] T. Asefa, K. Koh, C. W. Yoon, Adv. Energy Mater. 2019, 9, 1901158.
[4] D. Bao, Q. Zhang, F. L. Meng, H. X. Zhong, M. M. Shi, Y. Zhang, J. M. Yan, Q. Jiang, X. B. Zhang, Adv. Mater. 2017, 29, 1604799.
[5] J. Hunt, A. Ferrari, A. Lita, M. Crosswhite, B. Ashley, A. E. Stiegman, J. Phys. Chem. C, 2013, 117, 26871.
[6] J. Hu, C. Wildfire, A. E. Stiegman, R. A. Dagle, D. Shekhawat, V. Abdelsayed, X. Bai, H. Tian, M. B. Bogle, C. Hsu, Y. Luo, Chem. Eng. J. 2020, 397, 125388; V. Palma, D. Barba, M. Cortese, M. Martino, S. Renda, E. Meloni, Catalysts, 2020, 10, 246.
[7] C. D. Zeinalipour-Yazdi, J. S. Hargreaves, C. R. A. Catlow, J. Phys. Chem. C 2018, 122, 6078.
[8] M. Kitano, Y. Inoue, Y. Yamazaki, F. Hayashi, S. Kanbara, S. Matsuishi, T. Yokoyama, S. W. Kim, M. Hara, H. Hosono, Nat. Chem. 2012, 4, 934.
[9] J. K. Norskov, Prog. Surf. Sci. 1991, 38, 103.
[10] M. Muhler, F. Rosowski, O. Hinrichsen, A. Hornung, G. Ertl, Stud. Surf. Sci. Catal. 1996, 101, 317.
[11] J. Zheng, F. Liao, S. Wu, G. Jones, T. Y. Chen, J. Fellowes, T. Sudmeier, I. J. McPherson, I. Wilkinson, S. C. E. Tsang, Angew. Chem. Int. Ed. 2019, 58, 17335.
[12] W. Raróg-Pilecka, E. Miśkiewicz, D. Szmigiel, Z. Kowalczyk, J. Catal. 2005, 231, 11.
[13] Z. You, K. Inazu, K. I. Aika, T. Baba, J. Catal. 2007, 251, 321.
[14] Y. Kadowaki, K. I. Aika, J. Catal. 1996, 161, 178.
[15] C. Liang, Z. Wei, Q. Xin, C. Li, Appl. Catal., A-Gen. 2001, 208, 193.
[16] J. Kubota, K. I. Aika, J. Phys. Chem. 1994, 98, 11293.
[17] P. Moggi, G. Predieri, A. Maione, Catal. Lett. 2002, 79, 7.
[18] J. Lin, L. Zhang, Z. Wang, J. Ni, R. Wang, K. Wei, J. Mol. Catal. A. Chem. 2013, 366, 375.
[19] B. Xu, L. Xia, F. Zhou, R. Zhao, H. Chen, T. Wang, Q. Zhou, Q. Liu, G. Cui, X. Xiong, F. Gong, ACS Sustain. Chem. Eng. 2019, 7, 2889.
[20] J. Lee, Y. Ryou, X. Chan, T. J. Kim, D. H. Kim, J. Phys. Chem. C 2016, 120, 25870.
[21] K. I. Aika, T. Kawahara, S. Murata, T. Onishi, B. Chem. Soc. Jpn. 1990, 63, 1221.
[22] P. Seetharamulu, V. S. Kumar, A. H. Padmasri, B. D. Raju, K. R. Rao, J. Mol. Catal. A. Chem. 2007, 263, 253.
[23] Y. V. Larichev, J. Phys. Chem. C. 2011, 115, 631.
[24] B. Lin, Y. Liu, L. Heng, X. Wang, J. Ni, J. Lin, L. Jiang, Ind. Eng. Chem. Res. 2018, 57, 9127.
[25] F. R. Garcia-Garcia, A. Guerrero-Ruiz, I. Rodriguez-Ramos, Top. Catal. 2009, 52, 758.
[26] Y. V. Larichev, B. L. Moroz, V. I. Bukhtiyarov, Appl. Surf. Sci. 2011, 258, 1541.
[27] H. Xie, H. Wang, Q. Geng, Z. Xing, W. Wang, J. Chen, L. Ji, L. Chang, Z. Wang, J. Mao, Inorg. Chem. 2019, 58, 5423.
[28] H. Huang, Q. Dai, X. Wang, appl. Catal. B. 2014, 158, 96.
[29] Y. Guo, S. Mei, K. Yuan, D. J. Wang, H. C. Liu, C. H. Yan, Y. W. Zhang, ACS Catal. 2018, 8, 6203.
[30] C. J. Jacobsen, S. Dahl, P. L. Hansen, E. Törnqvist, L. Jensen, H. Topsoe, D. V. Prip, P. B. Moenshaug, I. Chorkendorff, J. Mol. Catal. A. Chem. 2000, 163, 19.
[31] S. Dahl, E. Törnqvist, I. Chorkendorff, J. Catal. 2000, 192, 381.
[32] L. Zhao, L. Z. Fan, M. Q. Zhou, H. Guan, S. Qiao, M. Antonietti, M. M. Titirici, Adv. Mater. 2010, 22, 5202.
[33] A. Logadottir, J. K. Norskov, J. Catal. 2003, 220, 273.
[34] J. S. Hummelshoj, F. Abild-Pedersen, F. Studt, T. Bligaard, J. K. Norskov, Angew. Chem. Int. Ed. 2012, 51, 272.
[35] B. Hammer, L. B. Hansen, J. K. Norskov, Phys. Rev. B 1999, 59, 7413.
[36] A. J. Medford, C. Shi, M. J. Hoffmann, A. C. Lausche, S. R. Fitzgibbon, T. Bligaard, J. K. Nørskov, Catal. Lett. 2015, 145, 794.
[37] L. C. Grabow, F. Studt, F. Abild-Pedersen, V. Petzold, J. Kleis, T. Bligaard, J. K. Nørskov, Angew. Chem. Int. Ed. 2011, 50, 4601.
[38] T. S. Khan, F. Jalid, M. A. Top. Catal. 2018, 61, 1820.
[39] G. Kresse, J. Furthmuller, Comput. Mater. Sci. 1996, 6, 15.
[40] P. E. Blöchl, Phys. Rev. B 1994, 50, 17953.
[41] H. J. Monkhorst, J. D. Pack, Phys. Rev. B 1976, 13, 5188.
[42] A. Vojvodic, A. J. Medford, F. Studt, F. Abild-Pedersen, T. S. Khan, T. Bligaard, J. K. Norskov, Chem. Phys. Lett. 2014, 598, 108.
[43] S. Dahl, A. Logadottir, C. J. Jacobsen, J. K. Norskov, Appl. Catal. A-Gen. 2001, 222, 19.
[44] J. J. Mortensen, B. Hammer, J. K. Norskov, Phys. Rev. Lett. 1998, 80, 4333.

### K. ASPECTS

The following listing of exemplary aspects supports and is supported by the disclosure provided herein.

Aspect 1. A heterogeneous catalyst comprising: a catalyst support comprising CeO₂, La₂O₃, or combinations thereof; a catalyst metal comprising at least one metal selected from Groups 6-12; and optionally a catalyst promoter comprising at least one metal selected from Group 1, and Group 2; wherein the catalyst is capable of interacting with electromagnetic energy in the frequency range of 300 MHz to 50 GHz; wherein the catalyst metal is present in an amount from about 0.1 wt % to about 15 wt %; wherein the catalyst promoter is present in an amount from about 0.1 wt % to about 15 wt %; and wherein the wt % is based on the total weight of the catalyst support, the catalyst metal, and the catalyst promoter, when present.

Aspect 2. The heterogeneous catalyst of Aspect 1, wherein the catalyst metal is selected from Ru, Pt, Pd, Cr, Mn, Fe, Co, Ni, Zn, and combinations thereof.

Aspect 3. The heterogeneous catalyst of Aspect 2, wherein the catalyst metal is selected from Ru, Pd, Cr, Fe, Co, Ni, Zn, and combinations thereof.

Aspect 4. The heterogeneous catalyst of Aspect 3, wherein the catalyst metal is selected from Ru, Pd, Fe, and combinations thereof.

Aspect 5. The heterogeneous catalyst of Aspect 1, wherein the catalyst metal comprises a single metal selected from Groups 6-12.

Aspect 6. The heterogeneous catalyst of Aspect 5, wherein the catalyst metal is selected from Ru, Pt, Pd, Cr, Mn, Fe, Co, Ni, Zn, and combinations thereof.

Aspect 7. The heterogeneous catalyst of Aspect 6, wherein the catalyst metal is selected from Ru, Pd, Cr, Fe, Co, Ni, Zn, and combinations thereof.

Aspect 8. The heterogeneous catalyst of Aspect 7, wherein the catalyst metal is selected from Ru, Pd, Fe, and combinations thereof.

Aspect 9. The heterogeneous catalyst of Aspect 8, wherein the catalyst metal is Ru.

Aspect 10. The heterogeneous catalyst of Aspect 1, wherein the catalyst metal comprises two metals selected from Groups 6-12.

Aspect 11. The heterogeneous catalyst of Aspect 5, wherein the catalyst metal comprises two metals selected from Ru, Pt, Pd, Cr, Mn, Fe, Co, Ni, Zn, and combinations thereof.

Aspect 12. The heterogeneous catalyst of Aspect 6, wherein the catalyst metal comprises two metals selected from Ru, Pd, Cr, Fe, Co, Ni, Zn, and combinations thereof.

Aspect 13. The heterogeneous catalyst of Aspect 7, wherein the catalyst metal comprises two metals selected from Ru, Pd, Fe, and combinations thereof.

Aspect 14. The heterogeneous catalyst of Aspect 13, wherein the catalyst metal comprises Ru and Fe.

Aspect 15. The heterogeneous catalyst of Aspect 13, wherein the catalyst metal comprises Ru and Pd.

Aspect 16. The heterogeneous catalyst of any one of Aspect 1-Aspect 15, wherein the catalyst metal is present in an amount from about 0.5 wt % to about 12 wt %.

Aspect 17. The heterogeneous catalyst of Aspect 16, wherein the catalyst metal is present in an amount from about 0.5 wt % to about 10 wt %.

Aspect 18. The heterogeneous catalyst of Aspect 16, wherein the catalyst metal is present in an amount from about 0.5 wt % to about 8 wt %.

Aspect 19. The heterogeneous catalyst of Aspect 16, wherein the catalyst metal is present in an amount from about 0.5 wt % to about 6 wt %.

Aspect 20. The heterogeneous catalyst of Aspect 16, wherein the catalyst metal is present in an amount from about 1 wt % to about 12 wt %.

Aspect 21. The heterogeneous catalyst of Aspect 16, wherein the catalyst metal is present in an amount from about 1 wt % to about 10 wt %.

Aspect 22. The heterogeneous catalyst of Aspect 16, wherein the catalyst metal is present in an amount from about 1 wt % to about 8 wt %.

Aspect 23. The heterogeneous catalyst of Aspect 16, wherein the catalyst metal is present in an amount from about 1 wt % to about 6 wt %.

Aspect 24. The heterogeneous catalyst of Aspect 16, wherein the catalyst metal is present in an amount from about 2 wt % to about 12 wt %.

Aspect 25. The heterogeneous catalyst of Aspect 16, wherein the catalyst metal is present in an amount from about 2 wt % to about 10 wt %.

Aspect 26. The heterogeneous catalyst of Aspect 16, wherein the catalyst metal is present in an amount from about 2 wt % to about 8 wt %.

Aspect 27. The heterogeneous catalyst of Aspect 16, wherein the catalyst metal is present in an amount from about 2 wt % to about 6 wt %.

Aspect 28. The heterogeneous catalyst of Aspect 16, wherein the catalyst metal is present in an amount from about 4 wt % to about 12 wt %.

Aspect 29. The heterogeneous catalyst of Aspect 16, wherein the catalyst metal is present in an amount from about 4 wt % to about 10 wt %.

Aspect 30. The heterogeneous catalyst of Aspect 16, wherein the catalyst metal is present in an amount from about 4 wt % to about 8 wt %.

Aspect 31. The heterogeneous catalyst of Aspect 16, wherein the catalyst metal is present in an amount from about 4 wt % to about 6 wt %.

Aspect 32. The heterogeneous catalyst of any one of Aspect 1-Aspect 31, wherein the catalyst promoter is present in an amount from about 0.5 wt % to about 12 wt %.

Aspect 33. The heterogeneous catalyst of Aspect 16, wherein the catalyst promoter is present in an amount from about 0.5 wt % to about 10 wt %.

Aspect 34. The heterogeneous catalyst of Aspect 16, wherein the catalyst promoter is present in an amount from about 0.5 wt % to about 8 wt %.

Aspect 35. The heterogeneous catalyst of Aspect 16, wherein the catalyst promoter is present in an amount from about 0.5 wt % to about 6 wt %.

Aspect 36. The heterogeneous catalyst of Aspect 16, wherein the catalyst promoter is present in an amount from about 0.5 wt % to about 4 wt %.

Aspect 37. The heterogeneous catalyst of Aspect 16, wherein the catalyst promoter is present in an amount from about 0.5 wt % to about 2 wt %.

Aspect 38. The heterogeneous catalyst of Aspect 16, wherein the catalyst promoter is present in an amount from about 1 wt % to about 12 wt %.

Aspect 39. The heterogeneous catalyst of Aspect 16, wherein the catalyst promoter is present in an amount from about 1 wt % to about 10 wt %.

Aspect 40. The heterogeneous catalyst of Aspect 16, wherein the catalyst promoter is present in an amount from about 1 wt % to about 8 wt %.

Aspect 41. The heterogeneous catalyst of Aspect 16, wherein the catalyst promoter is present in an amount from about 1 wt % to about 6 wt %.

Aspect 42. The heterogeneous catalyst of Aspect 16, wherein the catalyst promoter is present in an amount from about 1 wt % to about 4 wt %.

Aspect 43. The heterogeneous catalyst of Aspect 16, wherein the catalyst promoter is present in an amount from about 1 wt % to about 2 wt %.

Aspect 44. The heterogeneous catalyst of any one of Aspect 1-Aspect 43, wherein the catalyst promoter is K, Cs, or combination thereof.

Aspect 45. The heterogeneous catalyst of Aspect 44, wherein the catalyst promoter is K

Aspect 46. The heterogeneous catalyst of Aspect 44, wherein the catalyst promoter is Cs.

Aspect 47. The heterogeneous catalyst of any one of Aspect 1-Aspect 46, wherein the catalyst promoter is present in an amount from about 0.1 wt % to about 7 wt %.

Aspect 48. The heterogeneous catalyst of Aspect 47, wherein the catalyst promoter is present in an amount from about 1.5 wt % to about 6.5 wt %.

Aspect 49. The heterogeneous catalyst of Aspect 47, wherein the catalyst promoter is present in an amount from about 2 wt % to about 6 wt %.

Aspect 50. The heterogeneous catalyst of any one of Aspect 1-Aspect 49, wherein the catalyst metal is present in an amount from about 1 wt % to about 8 wt %.

Aspect 51. The heterogeneous catalyst of Aspect 50, wherein the catalyst promoter is present in an amount from about 2 wt % to about 6 wt %.

Aspect 52. The heterogeneous catalyst of Aspect 50, wherein the catalyst promoter is present in an amount from about 3 wt % to about 5 wt %.

Aspect 53. The heterogeneous catalyst of Aspect 50, wherein the catalyst promoter is present in an amount from about 3.9 wt % to about 4.9 wt %.

Aspect 54. The heterogeneous catalyst of any one of Aspect 1-Aspect 53, wherein the total wt % of both the catalyst metal and the catalyst promoter is from about 1 wt % to about 15 wt %.

Aspect 55. The heterogeneous catalyst of Aspect 54, wherein the total wt % of both the catalyst metal and the catalyst promoter is from about 1 wt % to about 10 wt %.

Aspect 56. The heterogeneous catalyst of Aspect 54, wherein the total wt % of both the catalyst metal and the catalyst promoter is from about 2 wt % to about 10 wt %.

Aspect 57. The heterogeneous catalyst of Aspect 54, wherein the total wt % of both the catalyst metal and the catalyst promoter is from about 3 wt % to about 10 wt %.

Aspect 58. The heterogeneous catalyst of Aspect 54, wherein the total wt % of both the catalyst metal and the catalyst promoter is from about 4 wt % to about 10 wt %.

Aspect 59. The heterogeneous catalyst of Aspect 54, wherein the total wt % of both the catalyst metal and the catalyst promoter is from about 5 wt % to about 10 wt %.

Aspect 60. The heterogeneous catalyst of any one of Aspect 1-Aspect 59, wherein the heterogeneous catalyst has a particle size from about 10 nm to about 50 μm.

Aspect 61. The heterogeneous catalyst of any one of Aspect 1-Aspect 60, wherein catalyst support comprises CeO₂.

Aspect 62. The heterogeneous catalyst of any one of Aspect 1-Aspect 60, wherein catalyst support comprises La₂O₃.

Aspect 63. The heterogeneous catalyst of any one of Aspect 1-Aspect 60, wherein catalyst support comprises CeO₂ and La₂O₃; and wherein the CeO₂ and La₂O₃ are present in a 1:1 ratio based on weight.

Aspect 64. The heterogeneous catalyst of any one of Aspect 1-Aspect 63, wherein catalyst support has a particle size from about 10 nm to about 50 μm.

Aspect 65. The heterogeneous catalyst of any one of Aspect 1-Aspect 64, wherein the catalyst support is CeO₂.

Aspect 66. The heterogeneous catalyst of any one of Aspect 1-Aspect 64, wherein the catalyst support is La₂O₃.

Aspect 67. The heterogeneous catalyst of any one of Aspect 1-Aspect 66, wherein the catalyst the catalyst metal has a particle size of from about 0.1 nm to about 1 μm.

Aspect 68. The heterogeneous catalyst of Aspect 67, wherein the catalyst the catalyst metal has a particle size of from about 1 nm to about 100 nm.

Aspect 69. The heterogeneous catalyst of Aspect 67, wherein the catalyst the catalyst metal has a particle size of from about 1 nm to about 50 nm.

Aspect 70. The heterogeneous catalyst of Aspect 67, wherein the catalyst the catalyst metal has a particle size of from about 1 nm to about 20 nm.

Aspect 71. The heterogeneous catalyst of Aspect 67, wherein the catalyst the catalyst metal has a particle size of from about 1 nm to about 15 nm.

Aspect 72. The heterogeneous catalyst of Aspect 67, wherein the catalyst the catalyst metal has a particle size of from about 1 nm to about 10 nm.

Aspect 73. A process for ammonia synthesis, the process comprising: providing a reaction chamber within a reactor with a heterogeneous catalyst of any one of Aspect 1-Aspect 72; heating the heterogeneous catalyst using electromagnetic energy with electromagnetic energy in the frequency range of 300 MHz to 50 GHz; conveying a flow of a reactant gas mixtures into the reaction chamber via an entry port; wherein the reaction chamber pressurizes the reaction chamber to a pressure from about 0.9 atm to about 100 atm; contacting the reactant gas mixture with the heterogeneous catalyst; and reacting the reactant gas mixture in contact with the heterogenous catalyst, thereby providing a product gas mixture; wherein the heterogeneous catalyst has a heterogeneous catalyst temperature of from about 40° C. to about 800° C.; wherein the reactant gas mixture comprises nitrogen and hydrogen; and wherein the product gas mixture comprises ammonia.

Aspect 74. The process of Aspect 73, wherein the reactant gas mixture comprises about 15 vol % to about 75 vol % of nitrogen; and about 15 vol % to about 90 vol % of hydrogen; provided that the vol % ratio of hydrogen to nitrogen is about 1 to about 5 and the total vol % of all gases in the reactant gas mixture is equal to about 100 vol %.

Aspect 75. The process of Aspect 74, wherein the vol % ratio of hydrogen to nitrogen is about 1 to about 5.

Aspect 76. The process of Aspect 74, wherein the vol % ratio of hydrogen to nitrogen is about 1.5 to about 3.5.

Aspect 77. The process of Aspect 74, wherein the vol % ratio of nitrogen to hydrogen is about 2.8 to about 3.2.

Aspect 78. The process of Aspect 74, wherein the vol % ratio of nitrogen to hydrogen is about 3.0±20%.

Aspect 79. The process of Aspect 74, wherein the vol % ratio of nitrogen to hydrogen is about 3.0±15%.

Aspect 80. The process of Aspect 74, wherein the vol % ratio of nitrogen to hydrogen is about 3.0±10%.

Aspect 81. The process of Aspect 74, wherein the vol % ratio of nitrogen to hydrogen is about 3.0±5%.

Aspect 82. The process of any one of Aspect 73-Aspect 81, wherein the reactant gas mixture comprises about 18 vol % to about 24 vol % of nitrogen; and about 60 vol % to about 70 vol % of hydrogen.

Aspect 83. The process of Aspect 82, wherein the reactant gas mixture comprises about 19 vol % to about 23 vol % of nitrogen; and about 65 vol % to about 70 vol % of hydrogen.

Aspect 84. The process of Aspect 82, wherein the reactant gas mixture comprises about 20 vol % to about 23 vol % of nitrogen; and about 66 vol % to about 70 vol % of hydrogen.

Aspect 85. The process of Aspect 82, wherein the reactant gas mixture comprises about 22 vol %±20% of nitrogen; and about 68 vol %±20% of hydrogen.

Aspect 86. The process of any one of Aspect 73-Aspect 85, wherein the reactant gas mixture is essentially free of oxygen.

Aspect 87. The process of any one of Aspect 73-Aspect 86, wherein the reactant gas mixture is pre-heated to a reactant gas mixture pre-heat temperature prior to conveying the flow of a reactant gas mixture into the reaction chamber via an entry port; and wherein the reactant gas mixture pre-heat temperature is from about 20° C. to about 500° C.

Aspect 88. The process of Aspect 87, wherein the reactant gas mixture pre-heat temperature is from about 50° C. to about 400° C.

Aspect 89. The process of Aspect 87, wherein the reactant gas mixture pre-heat temperature is from about 50° C. to about 300° C.

Aspect 90. The process of Aspect 87, wherein the reactant gas mixture pre-heat temperature is from about 50° C. to about 200° C.

Aspect 91. The process of Aspect 87, wherein the reactant gas mixture pre-heat temperature is from about 100° C. to about 500° C.

Aspect 92. The process of Aspect 87, wherein the reactant gas mixture pre-heat temperature is from about 100° C. to about 400° C.

Aspect 93. The process of Aspect 87, wherein the reactant gas mixture pre-heat temperature is from about 100° C. to about 300° C.

Aspect 94. The process of Aspect 87, wherein the reactant gas mixture pre-heat temperature is from about 100° C. to about 200° C.

Aspect 95. The process of Aspect 87, wherein the reactant gas mixture pre-heat temperature is from about 150° C. to about 500° C.

Aspect 96. The process of Aspect 87, wherein the reactant gas mixture pre-heat temperature is from about 150° C. to about 400° C.

Aspect 97. The process of Aspect 87, wherein the reactant gas mixture pre-heat temperature is from about 150° C. to about 300° C.

Aspect 98. The process of Aspect 87, wherein the reactant gas mixture pre-heat temperature is from about 150° C. to about 200° C.

Aspect 99. The process of Aspect 87, wherein the reactant gas mixture pre-heat temperature is from about 200° C. to about 500° C.

Aspect 100. The process of Aspect 87, wherein the reactant gas mixture pre-heat temperature is from about 200° C. to about 400° C.

Aspect 101. The process of Aspect 87, wherein the reactant gas mixture pre-heat temperature is from about 200° C. to about 300° C.

Aspect 102. The process of Aspect 87, wherein the reactant gas mixture pre-heat temperature is from about 250° C. to about 500° C.

Aspect 103. The process of Aspect 87, wherein the reactant gas mixture pre-heat temperature is from about 250° C. to about 450° C.

Aspect 104. The process of any one of Aspect 73-Aspect 103, wherein the heating the heterogeneous catalyst is heating with electromagnetic energy having at a frequency of about 300 MHz to about 50 GHz.

Aspect 105. The process of Aspect 104, wherein the electromagnetic energy has a frequency of about 2 MHz to about 50 GHz.

Aspect 106. The process of Aspect 104, wherein the electromagnetic energy has a frequency of about 2 MHz to about 40 GHz.

Aspect 107. The process of Aspect 104, wherein the electromagnetic energy has a frequency of about 2 MHz to about 30 GHz.

Aspect 108. The process of Aspect 104, wherein the electromagnetic energy has a frequency of about 2 MHz to about 25 GHz.

Aspect 109. The process of Aspect 104, wherein the electromagnetic energy has a frequency of about 2 MHz to about 20 GHz.

Aspect 110. The process of Aspect 104, wherein the electromagnetic energy has a frequency of about 2 MHz to about 15 GHz.

Aspect 111. The process of Aspect 104, wherein the electromagnetic energy has a frequency of about 915 MHz to about 10 GHz.

Aspect 112. The process of Aspect 104, wherein the electromagnetic energy has a frequency of about 4 GHz to about 7 GHz.

Aspect 113. The process of Aspect 104, wherein the electromagnetic energy has a frequency of about 5 GHz to about 7 GHz.

Aspect 114. The process of Aspect 104, wherein the electromagnetic energy has a frequency of about 5 GHz to about 6 GHz.

Aspect 115. The process of Aspect 104, wherein the electromagnetic energy has a frequency of about 0.7 GHz to about 3 GHz.

Aspect 116. The process of Aspect 104, wherein the electromagnetic energy has a frequency of about 0.9 GHz to about 2.5 GHz.

Aspect 117. The process of any one of Aspect 73-Aspect 116, wherein the heterogeneous catalyst temperature is from about 40° C. to about 600° C.

Aspect 118. The process of Aspect 117, wherein the heterogeneous catalyst temperature is from about 90° C. to about 400° C.

Aspect 119. The process of Aspect 117, wherein the heterogeneous catalyst temperature is from about 90° C. to about 300° C.

Aspect 120. The process of Aspect 117, wherein the heterogeneous catalyst temperature is from about 90° C. to about 200° C.

Aspect 121. The process of Aspect 117, wherein the heterogeneous catalyst temperature is from about 100° C. to about 500° C.

Aspect 122. The process of Aspect 117, wherein the heterogeneous catalyst temperature is from about 100° C. to about 400° C.

Aspect 123. The process of Aspect 117, wherein the heterogeneous catalyst temperature is from about 100° C. to about 300° C.

Aspect 124. The process of Aspect 117, wherein the heterogeneous catalyst temperature is from about 100° C. to about 200° C.

Aspect 125. The process of Aspect 117, wherein the heterogeneous catalyst temperature is from about 150° C. to about 500° C.

Aspect 126. The process of Aspect 117, wherein the heterogeneous catalyst temperature is from about 150° C. to about 400° C.

Aspect 127. The process of Aspect 117, wherein the heterogeneous catalyst temperature is from about 150° C. to about 300° C.

Aspect 128. The process of Aspect 117, wherein the heterogeneous catalyst temperature is from about 150° C. to about 200° C.

Aspect 129. The process of Aspect 117, wherein the heterogeneous catalyst temperature is from about 200° C. to about 500° C.

Aspect 130. The process of Aspect 117, wherein the heterogeneous catalyst temperature is from about 200° C. to about 400° C.

Aspect 131. The process of Aspect 117, wherein the heterogeneous catalyst temperature is from about 200° C. to about 300° C.

Aspect 132. The process of any one of Aspect 73-Aspect 131, wherein the product gas mixture has an ammonia concentration of about 10 ppm to about 90 vol %.

Aspect 133. The process of Aspect 132, wherein the product gas mixture has an ammonia concentration of about 1,000 ppm to about 30 vol %.

Aspect 134. The process of Aspect 132, wherein the product gas mixture has an ammonia concentration of about 1,000 ppm to about 25 vol %.

Aspect 135. The process of Aspect 132, wherein the product gas mixture has an ammonia concentration of about 1,000 ppm to about 20 vol %.

Aspect 136. The process of Aspect 132, wherein the product gas mixture has an ammonia concentration of about 1,000 ppm to about 10 vol %.

Aspect 137. The process of Aspect 132, wherein the product gas mixture has an ammonia concentration of about 1,000 ppm to about 4,000 ppm.

Aspect 138. The process of Aspect 132, wherein the product gas mixture has an ammonia concentration of about 1,000 ppm to about 3,000 ppm.

Aspect 139. The process of Aspect 132, wherein the product gas mixture has an ammonia concentration of about 1,000 ppm to about 2,500 ppm.

Aspect 140. The process of Aspect 132, wherein the product gas mixture has an ammonia concentration of about 1,000 ppm to about 5,000 ppm.

Aspect 141. The process of any one of Aspect 73-Aspect 140, wherein the process yields ammonia at about 0.01 gNH₃/(g_{catalyst}·hour) to about 3 gNH₃/(g_{catalyst}·hour).

Aspect 142. The process of Aspect 141, wherein the process yields ammonia at about 0.01 gNH₃/(g_{catalyst}·hour) to about 1.5 gNH₃/(g_{catalyst}·hour).

Aspect 143. The process of Aspect 141, wherein the process yields ammonia at about 0.01 gNH₃/(g_{catalyst}·hour) to about 1 gNH₃/(g_{catalyst}·hour).

Aspect 144. The process of Aspect 141, wherein the process yields ammonia at about 0.01 gNH₃/(g_{catalyst}·hour) to about 0.75 gNH₃/(g_{catalyst}·hour).

Aspect 145. The process of Aspect 141, wherein the process yields ammonia at about 0.01 gNH₃/(g_{catalyst}·hour) to about 0.5 gNH₃/(g_{catalyst}·hour).

Aspect 146. The process of Aspect 141, wherein the process yields ammonia at about 0.01 gNH₃/(g_{catalyst}·hour) to about 0.3 gNH₃/(g_{catalyst}·hour).

Aspect 147. The process of Aspect 141, wherein the process yields ammonia at about 0.01 gNH₃/(g_{catalyst}·hour) to about 0.25 gNH₃/(g_{catalyst}·hour).

Aspect 148. The process of Aspect 141, wherein the process yields ammonia at about 0.01 gNH₃/(g_{catalyst}·hour) to about 0.2 gNH₃/(g_{catalyst}·hour).

Aspect 149. The process of Aspect 141, wherein the process yields ammonia at about 0.01 gNH₃/(g_{catalyst}·hour) to about 0.15 gNH₃/(g_{catalyst}·hour).

Aspect 150. The process of Aspect 141, wherein the process yields ammonia at about 0.01 gNH₃/(g_{catalyst}·hour) to about 0.1 gNH₃/(g_{catalyst}·hour).

Aspect 151. The process of Aspect 141, wherein the process yields ammonia at about 0.3 gNH₃/(g_{catalyst}·hour) to about 10 gNH₃/(g_{catalyst}·hour).

Aspect 152. The process of Aspect 141, wherein the process yields ammonia at about 0.3 gNH₃/(g_{catalyst}·hour) to about 7.5 gNH₃/(g_{catalyst}·hour).

Aspect 153. The process of Aspect 141, wherein the process yields ammonia at about 0.3 gNH₃/(g_{catalyst}·hour) to about 5 gNH₃/(g_{catalyst}·hour).

Aspect 154. The process of Aspect 141, wherein the process yields ammonia at about 0.3 gNH₃/(g_{catalyst}·hour) to about 2.5 gNH₃/(g_{catalyst}·hour).

Aspect 155. The process of Aspect 141, wherein the process yields ammonia at about 0.3 gNH₃/(g_{catalyst}·hour) to about 2.0 gNH₃/(g_{catalyst}·hour).

Aspect 156. The process of Aspect 141, wherein the process yields ammonia at about 0.3 gNH₃/(g_{catalyst}·hour) to about 1.5 gNH₃/(g_{catalyst}·hour).

Aspect 157. The process of Aspect 141, wherein the process yields ammonia at about 0.3 gNH₃/(g_{catalyst}·hour) to about 1.0 gNH₃/(g_{catalyst}·hour).

Aspect 158. The process of Aspect 141, wherein the process yields ammonia at about 0.5 gNH₃/(g_{catalyst}·hour) to about 10 gNH₃/(g_{catalyst}·hour).

Aspect 159. The process of Aspect 141, wherein the process yields ammonia at about 0.5 gNH₃/(g_{catalyst}·hour) to about 7.5 gNH₃/(g_{catalyst}·hour).

Aspect 160. The process of Aspect 141, wherein the process yields ammonia at about 0.5 gNH₃/(g_{catalyst}·hour) to about 5 gNH₃/(g_{catalyst}·hour).

Aspect 161. The process of Aspect 141, wherein the process yields ammonia at about 0.5 gNH₃/(g_{catalyst}·hour) to about 2.5 gNH₃/(g_{catalyst}·hour).

Aspect 162. The process of Aspect 141, wherein the process yields ammonia at about 0.5 gNH₃/(g_{catalyst}·hour) to about 2.0 gNH₃/(g_{catalyst}·hour).

Aspect 163. The process of Aspect 141, wherein the process yields ammonia at about 0.5 gNH₃/(g_{catalyst}·hour) to about 1.5 gNH₃/(g_{catalyst}·hour).

Aspect 164. The process of Aspect 141, wherein the process yields ammonia at about 0.5 gNH₃/(g_{catalyst}·hour) to about 1.0 gNH₃/(g_{catalyst}·hour).

Aspect 165. The process of any one Aspect 73-Aspect 164, wherein the reaction chamber has a pressure of from about 0.9 atm to about 120 atm.

Aspect 166. The process of Aspect 165, wherein the reaction chamber has a pressure of from about 1 atm to about 30 atm.

Aspect 167. The process of Aspect 165, wherein the reaction chamber has a pressure of from about 1 atm to about 10 atm.

Aspect 168. The process of Aspect 165, wherein the reaction chamber has a pressure of from about 1 atm to about 7.5 atm.

Aspect 169. The process of Aspect 165, wherein the reaction chamber has a pressure of from about 1 atm to about 5 atm.

Aspect 170. The process of Aspect 165, wherein the reaction chamber has a pressure of from about 1 atm to about 2.5 atm.

Aspect 171. The process of Aspect 165, wherein the reaction chamber has a pressure of from about 600 torr to about 800 torr.

Aspect 172. The process of Aspect 165, wherein the reaction chamber has a pressure about the same as ambient pressure.

Aspect 173. The process of Aspect 73, wherein the ammonia formation rate reaches 0.3 g NH3/h·g_{cat} using a CsRu/CeO₂ catalyst ratio of 2/4 wt % at 150 psig pressure and at 593 K.

Aspect 174. A process for ammonia synthesis, the process comprising: providing a reaction chamber within a reactor with a heterogeneous catalyst; activating the heterogeneous catalyst using electromagnetic energy having a frequency of 13.5 MHz to 50 GHz; wherein the activating the heterogeneous catalyst initiates a chemical reaction; conveying a flow of a reactant gas mixtures into the reaction chamber via an entry port; wherein the reaction chamber pressurizes the reaction chamber to a pressure from about 0.5 atm to about 1000 atm; contacting the reactant gas mixture with the heterogeneous catalyst; and reacting the reactant gas mixture in contact with the heterogenous catalyst, thereby providing a product gas mixture; wherein the heterogeneous catalyst comprises a catalyst support comprising a cerium oxide, a lanthanum oxide, or a combination thereof; wherein the cerium oxide comprises Ce(III), Ce(IV), or combinations thereof; and wherein the lanthanum oxide comprises La(III); wherein the heterogeneous catalyst comprises a catalyst metal comprising at least one metal selected from Groups 6-12; and wherein the catalyst metal is selected from Rh, Ir, Os, Ru, Pt, Pd, Cr, Mn, Fe, Co, Ni, Zn, and combinations thereof; wherein the catalyst metal is present in an amount from about 0.1 wt % to about 15 wt %; wherein the heterogeneous catalyst has a heterogeneous catalyst temperature of from about 40° C. to about 800° C.; wherein the reactant gas mixture comprises nitrogen and hydrogen; and wherein the product gas mixture comprises ammonia.

Aspect 175. The process of Aspect 174, wherein the reaction chamber has a pressure of from about 1 atm to about 2.5 atm.

Aspect 176. The process of Aspect 174, wherein the reaction chamber has a pressure of from about 5 atm to about 100 atm.

Aspect 177. The process of Aspect 174, wherein the reaction chamber has a pressure of from about 0.9 atm to about 120 atm.

Aspect 178. The process of Aspect 177, wherein the reaction chamber has a pressure of from about 1 atm to about 30 atm.

Aspect 179. The process of Aspect 177, wherein the reaction chamber has a pressure of from about 1 atm to about 10 atm.

Aspect 180. The process of Aspect 177, wherein the reaction chamber has a pressure of from about 1 atm to about 7.5 atm.

Aspect 181. The process of Aspect 177, wherein the reaction chamber has a pressure of from about 1 atm to about 5 atm.

Aspect 182. The process of Aspect 177, wherein the reaction chamber has a pressure of from about 1 atm to about 2.5 atm.

Aspect 183. The process of Aspect 177, wherein the reaction chamber has a pressure of from about 600 torr to about 800 torr.

Aspect 184. The process of Aspect 177, wherein the reaction chamber has a pressure about the same as ambient pressure.

Aspect 185. The process of any one of Aspect 174-Aspect 184, wherein the reactant gas mixture comprises about 15 vol % to about 75 vol % of nitrogen; and about 90 vol % to about 15 vol % of hydrogen; provided that the vol % ratio of hydrogen to nitrogen is about 1 to about 5.

Aspect 186. The process of Aspect 185, wherein the reactant gas mixture comprises about 25 vol % to about 50 vol % of nitrogen; and about 75 vol % to about 35 vol % of hydrogen; provided that the vol % ratio of hydrogen to nitrogen is about 1.5 to about 4.

Aspect 187. The process of Aspect 185, wherein the vol % ratio of hydrogen to nitrogen is about 1 to about 5.

Aspect 188. The process of Aspect 185, wherein the vol % ratio of hydrogen to nitrogen is about 1.5 to about 3.5.

Aspect 189. The process of Aspect 185, wherein the vol % ratio of nitrogen to hydrogen is about 2.8 to about 3.2.

Aspect 190. The process of Aspect 185, wherein the vol % ratio of nitrogen to hydrogen is about 3.0±20%.

Aspect 191. The process of Aspect 185, wherein the vol % ratio of nitrogen to hydrogen is about 3.0±15%.

Aspect 192. The process of Aspect 185, wherein the vol % ratio of nitrogen to hydrogen is about 3.0±10%.

Aspect 193. The process of Aspect 185, wherein the vol % ratio of nitrogen to hydrogen is about 3.0±5%.

Aspect 194. The process of any one of Aspect 174-Aspect 193, wherein the reactant gas mixture comprises about 18 vol % to about 24 vol % of nitrogen; and about 60 vol % to about 70 vol % of hydrogen.

Aspect 195. The process of Aspect 194, wherein the reactant gas mixture comprises about 19 vol % to about 23 vol % of nitrogen; and about 65 vol % to about 70 vol % of hydrogen.

Aspect 196. The process of Aspect 194, wherein the reactant gas mixture comprises about 20 vol % to about 23 vol % of nitrogen; and about 66 vol % to about 70 vol % of hydrogen.

Aspect 197. The process of Aspect 194, wherein the reactant gas mixture comprises about 22 vol %±20% of nitrogen; and about 68 vol %±20% of hydrogen.

Aspect 198. The process of any one of Aspect 174-Aspect 197, wherein the reactant gas mixture is essentially free of oxygen.

Aspect 199. The process of any one of Aspect 174-Aspect 198, wherein the reactant gas mixture is pre-heated to a reactant gas mixture pre-heat temperature prior to conveying the flow of a reactant gas mixture into the reaction chamber via an entry port; and wherein the reactant gas mixture pre-heat temperature is from about 20° C. to about 500° C.

Aspect 200. The process of Aspect 199, wherein the reactant gas mixture pre-heat temperature is from about 100° C. to about 450° C.

Aspect 201. The process of Aspect 199, wherein the reactant gas mixture pre-heat temperature is from about 50° C. to about 400° C.

Aspect 202. The process of Aspect 199, wherein the reactant gas mixture pre-heat temperature is from about 50° C. to about 300° C.

Aspect 203. The process of Aspect 199, wherein the reactant gas mixture pre-heat temperature is from about 50° C. to about 200° C.

Aspect 204. The process of Aspect 199, wherein the reactant gas mixture pre-heat temperature is from about 100° C. to about 500° C.

Aspect 205. The process of Aspect 199, wherein the reactant gas mixture pre-heat temperature is from about 100° C. to about 400° C.

Aspect 206. The process of Aspect 199, wherein the reactant gas mixture pre-heat temperature is from about 100° C. to about 300° C.

Aspect 207. The process of Aspect 199, wherein the reactant gas mixture pre-heat temperature is from about 100° C. to about 200° C.

Aspect 208. The process of Aspect 199, wherein the reactant gas mixture pre-heat temperature is from about 150° C. to about 500° C.

Aspect 209. The process of Aspect 199, wherein the reactant gas mixture pre-heat temperature is from about 150° C. to about 400° C.

Aspect 210. The process of Aspect 199, wherein the reactant gas mixture pre-heat temperature is from about 150° C. to about 300° C.

Aspect 211. The process of Aspect 199, wherein the reactant gas mixture pre-heat temperature is from about 150° C. to about 200° C.

Aspect 212. The process of Aspect 199, wherein the reactant gas mixture pre-heat temperature is from about 200° C. to about 500° C.

Aspect 213. The process of Aspect 199, wherein the reactant gas mixture pre-heat temperature is from about 200° C. to about 400° C.

Aspect 214. The process of Aspect 199, wherein the reactant gas mixture pre-heat temperature is from about 200° C. to about 300° C.

Aspect 215. The process of Aspect 199, wherein the reactant gas mixture pre-heat temperature is from about 250° C. to about 500° C.

Aspect 216. The process of Aspect 199, wherein the reactant gas mixture pre-heat temperature is from about 250° C. to about 450° C.

Aspect 217. The process of any one of Aspect 174-Aspect 216, wherein the heterogeneous catalyst has a heterogeneous catalyst temperature of from about 40° C. to about 600° C.

Aspect 218. The process of Aspect 217, wherein the heterogeneous catalyst has a heterogeneous catalyst temperature of from about 150° C. to about 600° C.

Aspect 219. The process of Aspect 217, wherein the heterogeneous catalyst temperature is from about 90° C. to about 400° C.

Aspect 220. The process of Aspect 217, wherein the heterogeneous catalyst temperature is from about 90° C. to about 300° C.

Aspect 221. The process of Aspect 217, wherein the heterogeneous catalyst temperature is from about 90° C. to about 200° C.

Aspect 222. The process of Aspect 217, wherein the heterogeneous catalyst temperature is from about 100° C. to about 500° C.

Aspect 223. The process of Aspect 217, wherein the heterogeneous catalyst temperature is from about 100° C. to about 400° C.

Aspect 224. The process of Aspect 217, wherein the heterogeneous catalyst temperature is from about 100° C. to about 300° C.

Aspect 225. The process of Aspect 117, wherein the heterogeneous catalyst temperature is from about 100° C. to about 200° C.

Aspect 226. The process of Aspect 217, wherein the heterogeneous catalyst temperature is from about 150° C. to about 500° C.

Aspect 227. The process of Aspect 217, wherein the heterogeneous catalyst temperature is from about 150° C. to about 400° C.

Aspect 228. The process of Aspect 217, wherein the heterogeneous catalyst temperature is from about 150° C. to about 300° C.

Aspect 229. The process of Aspect 217, wherein the heterogeneous catalyst temperature is from about 150° C. to about 200° C.

Aspect 230. The process of Aspect 217, wherein the heterogeneous catalyst temperature is from about 200° C. to about 500° C.

Aspect 231. The process of Aspect 217, wherein the heterogeneous catalyst temperature is from about 200° C. to about 400° C.

Aspect 232. The process of Aspect 217, wherein the heterogeneous catalyst temperature is from about 200° C. to about 300° C.

Aspect 233. The process of any one of Aspect 174-Aspect 232, wherein the product gas mixture has an ammonia concentration of about 10 ppm to about 90 vol %.

Aspect 234. The process of Aspect 233, wherein the product gas mixture has an ammonia concentration of about 0.5 vol % to about 25 vol %.

Aspect 235. The process of Aspect 233, wherein the product gas mixture has an ammonia concentration of about 1,000 ppm to about 30 vol %.

Aspect 236. The process of Aspect 233, wherein the product gas mixture has an ammonia concentration of about 1,000 ppm to about 25 vol %.

Aspect 237. The process of Aspect 233, wherein the product gas mixture has an ammonia concentration of about 1,000 ppm to about 20 vol %.

Aspect 238. The process of Aspect 233, wherein the product gas mixture has an ammonia concentration of about 1,000 ppm to about 10 vol %.

Aspect 239. The process of Aspect 233, wherein the product gas mixture has an ammonia concentration of about 1,000 ppm to about 4,000 ppm.

Aspect 240. The process of Aspect 233, wherein the product gas mixture has an ammonia concentration of about 1,000 ppm to about 3,000 ppm.

Aspect 241. The process of Aspect 233, wherein the product gas mixture has an ammonia concentration of about 1,000 ppm to about 2,500 ppm.

Aspect 242. The process of Aspect 233, wherein the product gas mixture has an ammonia concentration of about 1,000 ppm to about 5,000 ppm.

Aspect 243. The process of Aspect 233, wherein the product gas mixture has an ammonia concentration of about 5 vol % to about 20 vol %.

Aspect 244. The process of any one of Aspect 174-Aspect 243, wherein the electromagnetic energy has a frequency of from 300 MHz to 50 GHz.

Aspect 245. The process of Aspect 244, wherein the electromagnetic energy has a frequency of from 900 MHz to 2.5 GHz.

Aspect 246. The process of Aspect 244, wherein the electromagnetic energy has a frequency of about 2 MHz to about 50 GHz.

Aspect 247. The process of Aspect 244, wherein the electromagnetic energy has a frequency of about 2 MHz to about 40 GHz.

Aspect 248. The process of Aspect 244, wherein the electromagnetic energy has a frequency of about 2 MHz to about 30 GHz.

Aspect 249. The process of Aspect 244, wherein the electromagnetic energy has a frequency of about 2 MHz to about 25 GHz.

Aspect 250. The process of Aspect 244, wherein the electromagnetic energy has a frequency of about 2 MHz to about 20 GHz.

Aspect 251. The process of Aspect 244, wherein the electromagnetic energy has a frequency of about 2 MHz to about 15 GHz.

Aspect 252. The process of Aspect 244, wherein the electromagnetic energy has a frequency of about 915 MHz to about 10 GHz.

Aspect 253. The process of Aspect 244, wherein the electromagnetic energy has a frequency of about 4 GHz to about 7 GHz.

Aspect 254. The process of Aspect 244, wherein the electromagnetic energy has a frequency of about 5 GHz to about 7 GHz.

Aspect 255. The process of Aspect 244, wherein the electromagnetic energy has a frequency of about 5 GHz to about 6 GHz.

Aspect 256. The process of Aspect 244, wherein the electromagnetic energy has a frequency of about 0.7 GHz to about 3 GHz.

Aspect 257. The process of Aspect 244, wherein the electromagnetic energy has a frequency of about 0.9 GHz to about 2.5 GHz.

Aspect 258. The process of any one of Aspect 174-Aspect 257, further comprising microwave-thermal hybrid heating.

Aspect 259. The process of any one of Aspect 174-Aspect 258, further comprising providing an electromagnetic energy susceptor with the heterogeneous catalyst in the reaction chamber within the reactor; wherein the electromagnetic energy susceptor is capable of interacting with electromagnetic energy in the frequency range of 13.5 MHz to 50 GHz.

Aspect 260. The process of Aspect 259, wherein the electromagnetic energy susceptor comprises a material selected from a SiC, graphene, carbon nanotube, carbon nanofiber, graphite, carbon nanofoam, and combinations thereof.

Aspect 261. The process of any one of Aspect 174-Aspect 260, wherein the catalyst metal is selected from Ru, Pt, Pd, Cr, Mn, Fe, Co, Ni, Zn, and combinations thereof.

Aspect 262. The process of Aspect 261, wherein the catalyst metal is selected from Ru, Pd, Cr, Fe, Co, Ni, Zn, and combinations thereof.

Aspect 263. The process of Aspect 262, wherein the catalyst metal is selected from Ru, Pd, Fe, and combinations thereof.

Aspect 264. The process of Aspect 263, wherein the catalyst metal comprises Ru.

Aspect 265. The process of any one of Aspect 174-Aspect 260, wherein the catalyst metal comprises a single metal selected from Ru, Pt, Pd, Cr, Mn, Fe, Co, Ni, and Zn.

Aspect 266. The process of Aspect 265, wherein the catalyst metal comprises a single metal selected from Ru, Pd, Cr, Fe, Co, Ni, and Zn.

Aspect 267. The process of Aspect 266, wherein the catalyst metal comprises a single metal selected from Ru, Pd, and Fe.

Aspect 268. The process of Aspect 267, wherein the catalyst metal comprises Ru.

Aspect 269. The process of any one of Aspect 174-Aspect 260, wherein the catalyst metal comprises two metals selected from Ru, Pt, Pd, Cr, Mn, Fe, Co, Ni, and Zn.

Aspect 270. The process of Aspect 269, wherein the catalyst metal comprises two metals selected from Ru, Pd, Cr, Fe, Co, Ni, and Zn.

Aspect 271. The process of Aspect 270, wherein the catalyst metal comprises two metals selected from Ru, Pd, and Fe.

Aspect 272. The process of Aspect 269, wherein the catalyst metal comprises Ru and Fe.

Aspect 273. The process of Aspect 269, wherein the catalyst metal comprises Ru and Pd.

Aspect 274. The process of any one of Aspect 174-Aspect 273, wherein the catalyst metal is present in an amount from about 0.5 wt % to about 12 wt %.

Aspect 275. The process of Aspect 274, wherein the catalyst metal is present in an amount from about 0.5 wt % to about 10 wt %.

Aspect 276. The process of Aspect 274, wherein the catalyst metal is present in an amount from about 0.5 wt % to about 8 wt %.

Aspect 277. The process of Aspect 274, wherein the catalyst metal is present in an amount from about 0.5 wt % to about 6 wt %.

Aspect 278. The process of Aspect 274, wherein the catalyst metal is present in an amount from about 1 wt % to about 12 wt %.

Aspect 279. The process of Aspect 274, wherein the catalyst metal is present in an amount from about 1 wt % to about 10 wt %.

Aspect 280. The process of Aspect 274, wherein the catalyst metal is present in an amount from about 1 wt % to about 8 wt %.

Aspect 281. The process of Aspect 274, wherein the catalyst metal is present in an amount from about 1 wt % to about 6 wt %.

Aspect 282. The process of Aspect 274, wherein the catalyst metal is present in an amount from about 2 wt % to about 12 wt %.

Aspect 283. The process of Aspect 274, wherein the catalyst metal is present in an amount from about 2 wt % to about 10 wt %.

Aspect 284. The process of Aspect 274, wherein the catalyst metal is present in an amount from about 2 wt % to about 8 wt %.

Aspect 285. The process of Aspect 274, wherein the catalyst metal is present in an amount from about 2 wt % to about 6 wt %.

Aspect 286. The process of Aspect 274, wherein the catalyst metal is present in an amount from about 4 wt % to about 12 wt %.

Aspect 287. The process of Aspect 274, wherein the catalyst metal is present in an amount from about 4 wt % to about 10 wt %.

Aspect 288. The process of Aspect 274, wherein the catalyst metal is present in an amount from about 4 wt % to about 8 wt %.

Aspect 289. The process of Aspect 274, wherein the catalyst metal is present in an amount from about 4 wt % to about 6 wt %.

Aspect 290. The process of any one of Aspect 174-Aspect 289, further comprising a catalyst promoter comprising at least one metal selected from Group 1 and Group 2; wherein the catalyst promoter is present in an amount from about 0.1 wt % to about 15 wt %; and wherein the wt % is based on the total weight of the catalyst support, the catalyst metal, and the catalyst promoter.

Aspect 291. The process of Aspect 290, wherein the catalyst promoter is present in an amount from about 0.5 wt % to about 12 wt %.

Aspect 292. The process of Aspect 290, wherein the catalyst promoter is present in an amount from about 0.5 wt % to about 10 wt %.

Aspect 293. The process of Aspect 290, wherein the catalyst promoter is present in an amount from about 0.5 wt % to about 8 wt %.

Aspect 294. The process of Aspect 290, wherein the catalyst promoter is present in an amount from about 0.5 wt % to about 6 wt %.

Aspect 295. The process of Aspect 290, wherein the catalyst promoter is present in an amount from about 0.5 wt % to about 4 wt %.

Aspect 296. The process of Aspect 290, wherein the catalyst promoter is present in an amount from about 0.5 wt % to about 2 wt %.

Aspect 297. The process of Aspect 290, wherein the catalyst promoter is present in an amount from about 1 wt % to about 12 wt %.

Aspect 298. The process of Aspect 290, wherein the catalyst promoter is present in an amount from about 1 wt % to about 10 wt %.

Aspect 299. The process of Aspect 290, wherein the catalyst promoter is present in an amount from about 1 wt % to about 8 wt %.

Aspect 300. The process of Aspect 290, wherein the catalyst promoter is present in an amount from about 1 wt % to about 6 wt %.

Aspect 301. The process of Aspect 290, wherein the catalyst promoter is present in an amount from about 1 wt % to about 4 wt %.

Aspect 302. The process of Aspect 290, wherein the catalyst promoter is present in an amount from about 1 wt % to about 2 wt %.

Aspect 303. The process of Aspect 290, wherein the catalyst promoter is present in an amount from about 0.1 wt % to about 7 wt %.

Aspect 304. The process of Aspect 290, wherein the catalyst promoter is present in an amount from about 1.5 wt % to about 6.5 wt %.

Aspect 305. The process of Aspect 290, wherein the total wt % of both the catalyst metal and the catalyst promoter is from about 1 wt % to about 15 wt %.

Aspect 306. The process of Aspect 305, wherein the total wt % of both the catalyst metal and the catalyst promoter is from about 1 wt % to about 10 wt %.

Aspect 307. The process of Aspect 305, wherein the total wt % of both the catalyst metal and the catalyst promoter is from about 2 wt % to about 10 wt %.

Aspect 308. The process of Aspect 305, wherein the total wt % of both the catalyst metal and the catalyst promoter is from about 3 wt % to about 10 wt %.

Aspect 309. The process of Aspect 305, wherein the total wt % of both the catalyst metal and the catalyst promoter is from about 4 wt % to about 10 wt %.

Aspect 310. The process of Aspect 305, wherein the total wt % of both the catalyst metal and the catalyst promoter is from about 5 wt % to about 10 wt %.

Aspect 311. The process of any one of Aspect 290-Aspect 310, wherein the catalyst promoter comprises at least one metal selected from K, Cs, or a combination thereof.

Aspect 312. The process of Aspect 311, wherein the catalyst promoter comprises K.

Aspect 313. The process of Aspect 311, wherein the catalyst promoter comprises Cs.

Aspect 314. The process of any one of Aspect 174-Aspect 313, wherein the catalyst metal has an active catalyst metal cluster size of from about 0.5 nm to about 50 nm.

Aspect 315. The process of Aspect 314, wherein the catalyst metal has an active catalyst metal cluster size of from about 0.5 nm to about 30 nm.

Aspect 316. The process of Aspect 314, wherein the catalyst metal has an active catalyst metal cluster size of from about 0.5 nm to about 25 nm.

Aspect 317. The process of Aspect 314, wherein the catalyst metal has an active catalyst metal cluster size of from about 0.5 nm to about 20 nm.

Aspect 318. The process of Aspect 314, wherein the catalyst metal has an active catalyst metal cluster size of from about 0.5 nm to about 15 nm.

Aspect 319. The process of Aspect 314, wherein the catalyst metal has an active catalyst metal cluster size of from about 0.5 nm to about 10 nm.

Aspect 320. The process of Aspect 314, wherein the catalyst metal has an active catalyst metal cluster size of from about 0.5 nm to about 5 nm.

Aspect 321. The process of Aspect 314, wherein the catalyst metal has an active catalyst metal cluster size of from about 1 nm to about 50 nm.

Aspect 322. The process of Aspect 314, wherein the catalyst metal has an active catalyst metal cluster size of from about 1 nm to about 40 nm.

Aspect 323. The process of Aspect 314, wherein the catalyst metal has an active catalyst metal cluster size of from about 1 nm to about 30 nm.

Aspect 324. The process of Aspect 314, wherein the catalyst metal has an active catalyst metal cluster size of from about 1 nm to about 25 nm.

Aspect 325. The process of Aspect 314, wherein the catalyst metal has an active catalyst metal cluster size of from about 1 nm to about 20 nm.

Aspect 326. The process of Aspect 314, wherein the catalyst metal has an active catalyst metal cluster size of from about 1 nm to about 15 nm.

Aspect 327. The process of Aspect 314, wherein the catalyst metal has an active catalyst metal cluster size of from about 1 nm to about 10 nm.

Aspect 328. The process of Aspect 314, wherein the catalyst metal has an active catalyst metal cluster size of from about 1 nm to about 5 nm.

Aspect 329. The process of Aspect 314, wherein the catalyst metal has an active catalyst metal cluster size of from about 5 nm to about 50 nm.

Aspect 330. The process of Aspect 314, wherein the catalyst metal has an active catalyst metal cluster size of from about 5 nm to about 40 nm.

Aspect 331. The process of Aspect 314, wherein the catalyst metal has an active catalyst metal cluster size of from about 5 nm to about 30 nm.

Aspect 332. The process of Aspect 314, wherein the catalyst metal has an active catalyst metal cluster size of from about 5 nm to about 25 nm.

Aspect 333. The process of Aspect 314, wherein the catalyst metal has an active catalyst metal cluster size of from about 5 nm to about 20 nm.

Aspect 334. The process of Aspect 314, wherein the catalyst metal has an active catalyst metal cluster size of from about 5 nm to about 15 nm.

Aspect 335. The process of Aspect 314, wherein the catalyst metal has an active catalyst metal cluster size of from about 5 nm to about 10 nm.

Aspect 336. The process of any one of Aspect 174-Aspect 335, wherein the heterogeneous catalyst has a particle size from about 10 nm to about 50 μm.

Aspect 337. The process of any one of Aspect 174-Aspect 336, wherein catalyst support comprises CeO₂, La₂O₃, or a combination thereof.

Aspect 338. The process of Aspect 337, wherein the catalyst support comprises CeO₂.

Aspect 339. The process of Aspect 337, wherein the catalyst support comprises La₂O₃.

Aspect 340. The process of Aspect 337, wherein the catalyst support comprises CeO₂ and La₂O₃, and wherein the CeO₂ and La₂O₃ are present in a 1:1 ratio based on weight.

Aspect 341. The process of any one of Aspect 174-Aspect 340, wherein the process yields ammonia at about 0.01 gNH₃/(g_{catalyst}·hour) to about 3 gNH₃/(g_{catalyst}·hour).

Aspect 342. The process of Aspect 341, wherein the process yields ammonia at about 0.01 gNH₃/(g_{catalyst}·hour) to about 1.5 gNH₃/(g_{catalyst}·hour).

Aspect 343. The process of Aspect 341, wherein the process yields ammonia at about 0.01 gNH₃/(g_{catalyst}·hour) to about 1 gNH₃/(g_{catalyst}·hour).

Aspect 344. The process of Aspect 341, wherein the process yields ammonia at about 0.01 gNH₃/(g_{catalyst}·hour) to about 0.75 gNH₃/(g_{catalyst}·hour).

Aspect 345. The process of Aspect 341, wherein the process yields ammonia at about 0.01 gNH₃/(g_{catalyst}·hour) to about 0.5 gNH₃/(g_{catalyst}·hour).

Aspect 346. The process of Aspect 341, wherein the process yields ammonia at about 0.01 gNH₃/(g_{catalyst}·hour) to about 0.3 gNH₃/(g_{catalyst}·hour).

Aspect 347. The process of Aspect 341, wherein the process yields ammonia at about 0.01 gNH₃/(g_{catalyst}·hour) to about 0.25 gNH₃/(g_{catalyst}·hour).

Aspect 348. The process of Aspect 341, wherein the process yields ammonia at about 0.01 gNH₃/(g_{catalyst}·hour) to about 0.2 gNH₃/(g_{catalyst}·hour).

Aspect 349. The process of Aspect 341, wherein the process yields ammonia at about 0.01 gNH₃/(g_{catalyst}·hour) to about 0.15 gNH₃/(g_{catalyst}·hour).

Aspect 350. The process of Aspect 341, wherein the process yields ammonia at about 0.01 gNH₃/(g_{catalyst}·hour) to about 0.1 gNH₃/(g_{catalyst}·hour).

Aspect 351. The process of Aspect 341, wherein the process yields ammonia at about 0.3 gNH₃/(g_{catalyst}·hour) to about 10 gNH₃/(g_{catalyst}·hour).

Aspect 352. The process of Aspect 341, wherein the process yields ammonia at about 0.3 gNH₃/(g_{catalyst}·hour) to about 7.5 gNH₃/(g_{catalyst}·hour).

Aspect 353. The process of Aspect 341, wherein the process yields ammonia at about 0.3 gNH₃/(g_{catalyst}·hour) to about 5 gNH₃/(g_{catalyst}·hour).

Aspect 354. The process of Aspect 341, wherein the process yields ammonia at about 0.3 gNH₃/(g_{catalyst}·hour) to about 2.5 gNH₃/(g_{catalyst}·hour).

Aspect 355. The process of Aspect 341, wherein the process yields ammonia at about 0.3 gNH₃/(g_{catalyst}·hour) to about 2.0 gNH₃/(g_{catalyst}·hour).

Aspect 356. The process of Aspect 341, wherein the process yields ammonia at about 0.3 gNH₃/(g_{catalyst}·hour) to about 1.5 gNH₃/(g_{catalyst}·hour).

Aspect 357. The process of Aspect 341, wherein the process yields ammonia at about 0.3 gNH₃/(g_{catalyst}·hour) to about 1.0 gNH₃/(g_{catalyst}·hour).

Aspect 358. The process of Aspect 341, wherein the process yields ammonia at about 0.5 gNH₃/(g_{catalyst}·hour) to about 10 gNH₃/(g_{catalyst}·hour).

Aspect 359. The process of Aspect 341, wherein the process yields ammonia at about 0.5 gNH₃/(g_{catalyst}·hour) to about 7.5 gNH₃/(g_{catalyst}·hour).

Aspect 360. The process of Aspect 341, wherein the process yields ammonia at about 0.5 gNH₃/(g_{catalyst}·hour) to about 5 gNH₃/(g_{catalyst}·hour).

Aspect 361. The process of Aspect 341, wherein the process yields ammonia at about 0.5 gNH₃/(g_{catalyst}·hour) to about 2.5 gNH₃/(g_{catalyst}·hour).

Aspect 362. The process of Aspect 341, wherein the process yields ammonia at about 0.5 gNH₃/(g_{catalyst}·hour) to about 2.0 gNH₃/(g_{catalyst}·hour).

Aspect 363. The process of Aspect 341, wherein the process yields ammonia at about 0.5 gNH₃/(g_{catalyst}·hour) to about 1.5 gNH₃/(g_{catalyst}·hour).

Aspect 364. The process of Aspect 341, wherein the process yields ammonia at about 0.5 gNH₃/(g_{catalyst}·hour) to about 1.0 gNH₃/(g_{catalyst}·hour).

Aspect 365. The process of Aspect 174, wherein the ammonia formation rate reaches 0.3 g NH3/h·g_{cat} using a CsRu/CeO₂ catalyst ratio of 2/4 wt % at 150 psig pressure and at 593 K.

Aspect 366. A heterogeneous catalyst comprising:
a catalyst support comprising a cerium oxide, a lanthanum oxide, or a combination thereof; and
wherein the cerium oxide comprises Ce(II), Ce(IV), or combinations thereof; and
wherein the lanthanum oxide comprises La(III);
a catalyst metal comprising at least one metal selected from Groups 6-12;
wherein the catalyst metal is selected from Rh, Ir, Os, Ru, Pt, Pd, Cr, Mn, Fe, Co, Ni, Zn, and combinations thereof;
wherein the catalyst metal is present in an amount from about 0.1 wt % to about 15 wt %;
wherein the catalyst is capable of interacting with electromagnetic energy having a frequency of 13.5 MHz to 50 GHz;
wherein the wt % is based on the total weight of the catalyst support and the catalyst metal.

Aspect 367. The heterogeneous catalyst of Aspect 366, wherein the catalyst metal is selected from Ru, Pd, Fe, and combinations thereof.

Aspect 368. The heterogeneous catalyst of Aspect 367, wherein the catalyst metal is Ru.

Aspect 369. The heterogeneous catalyst of Aspect 366, wherein the catalyst metal comprises a single metal selected from Ru, Pt, Pd, Cr, Mn, Fe, Co, Ni, and Zn.

Aspect 370. The heterogeneous catalyst of Aspect 366, wherein the catalyst metal comprises two metals selected from Ru, Pd, Cr, Fe, Co, Ni, and Zn.

Aspect 371. The heterogeneous catalyst of Aspect 370, wherein the catalyst metal comprises Ru and Fe.

Aspect 372. The heterogeneous catalyst of Aspect 370, wherein the catalyst metal comprises Ru and Pd.

Aspect 373. The heterogeneous catalyst of Aspect 366, wherein the catalyst metal is present in an amount from about 2 wt % to about 8 wt %.

Aspect 374. The heterogeneous catalyst of Aspect 366, further comprising a catalyst promoter comprising at least one metal selected from K, Cs, or a combination thereof; wherein the catalyst promoter is present in an amount from about 0.1 wt % to about 15 wt %; and wherein the wt % is based on the total weight of the catalyst support, the catalyst metal, and the catalyst promoter.

Aspect 375. The heterogeneous catalyst of Aspect 375, wherein the total wt % of both the catalyst metal and the catalyst promoter is from about 1 wt % to about 15 wt %.

Aspect 376. The heterogeneous catalyst of Aspect 375, wherein the catalyst metal has an active catalyst metal cluster size of from about 0.5 nm to about 20 nm.

Aspect 377. The heterogeneous catalyst of Aspect 366, wherein catalyst support comprises CeO₂ and La₂O₃.

Aspect 378. The heterogeneous catalyst of Aspect 377, wherein the CeO₂ and La₂O₃ are present in a 1:1 ratio based on weight.

Aspect 379. A heterogeneous catalyst as disclosed in or utilized in the process of Aspect 174-Aspect 365.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### L. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Catalytic Performance Microwave-Assisted NH₃ Synthesis.

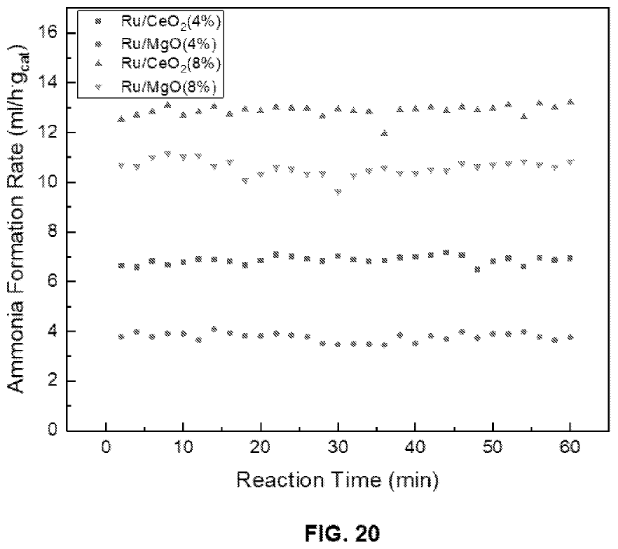

Effect of Support and Promoter on Microwave-assisted NH₃ Synthesis. To investigate the effect of support, MgO and CeO₂ were selected as supports and compared. FIG. 20 shows NH₃ formation rate over MgO and CeO₂ supported catalysts. Compared to MgO, CeO₂ supported catalysts showed much higher NH₃ synthesis activity under the same Ru loading. The NH₃ formation rates were increased with Ru loading increase over both CeO₂ and MgO supported catalysts. With increase in Ru loading to 8%, the NH₃ formation rate was increased to 13.1 ml/h·g_{cat} and 11.0 ml/h·g_{cat} over Ru/CeO₂(8%) and Ru/MgO(8%), respectively.

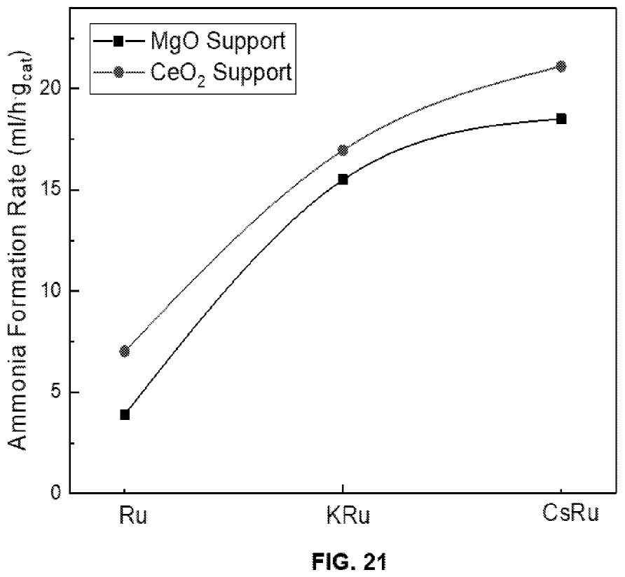

To investigate the effect of promoter, Cs and K were selected as promoters and compared. As shown in FIG. 21, by adding either 4 wt % Cs or 4 wt % K promoters, NH₃ synthesis activities over both MgO and CeO₂ supported catalysts were significantly increased, and Cs appeared to be a better promoter than K. Moreover, CeO₂ supported catalysts exhibited higher NH₃ synthesis activity than MgO supported catalysts. With the addition of 4 wt % K, the NH₃ formation rate was more than doubled over Ru/CeO₂(4%). The effect of K was more dramatic over MgO supported Ru catalyst where NH₃ activity was tripled. Specifically, as shown in FIG. 21, the NH₃ formation rates were increased to 17.0 ml/h·g_{cat} and 15.5 ml/h·g_{cat} over KRu/CeO₂(4-4%) and KRu/MgO(4-4%), respectively. Promoting with 4 wt % Cs, the NH₃ formation rate reached to 21.1 ml/h·g_{cat} and 18.5 ml/h·g_{cat} over CsRu/CeO₂(4-4%) and CsRu/MgO(4-4%), respectively.

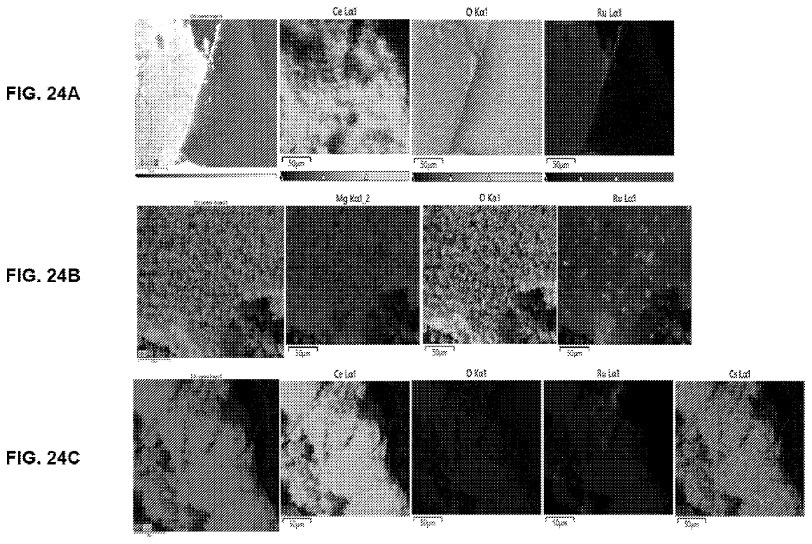

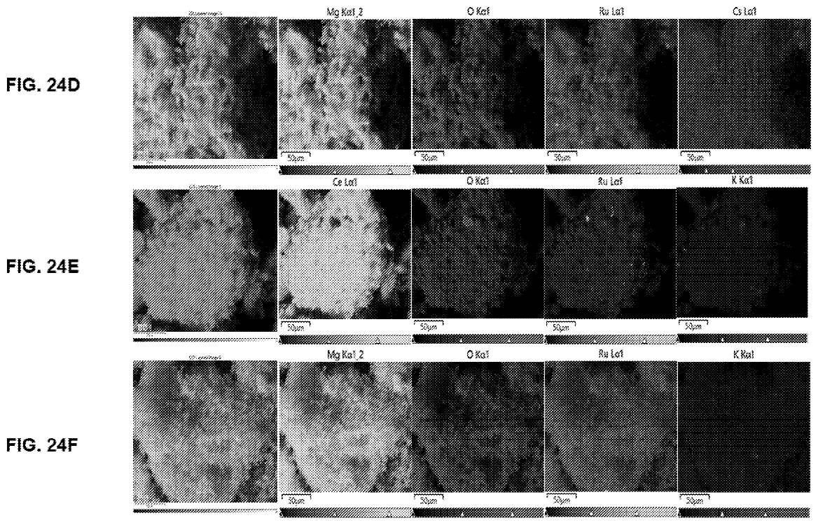

Catalyst Optimization. In the studies described above, Cs exhibited better improvement than K in NH₃ synthesis. The effect of promoter was further studied by varying Cs loading. FIG. 24 illustrates the effect of Cs to Ru mass ratio on NH₃ formation rate over both CeO₂ and MgO supported catalysts. When the Cs loading is increased from 1 wt % to 2 wt %, the NH₃ synthesis activity reaches a maximum for both CeO₂ and MgO supported catalysts. The NH₃ formation rate reached to 26.4 ml/h·g_{cat} and 21.5 ml/h·g_{cat} for CsRu/CeO₂(2-4%) and CsRu/MgO(2-4%), respectively. With further increase in Cs/Ru mass ratio, NH₃ synthesis activity decreases for both CeO₂ and MgO supported catalysts. Under the same Cs/Ru mass ratio, the CeO₂ supported catalysts always show the higher activity than the one supported on MgO, further confirming CeO₂ has better promoting effect than MgO.

In the disclosed microwave-assisted NH₃ synthesis processes, both support and promoter can affect Ru catalyst activity. As shown in FIG. 9, CeO₂ supported Ru catalysts showed higher NH₃ synthesis activity over MgO supported Ru catalysts under the same active metals loading. The NH₃ synthesis activity was significantly increased in the presence of K and Cs promoter over both MgO and CeO₂ supported Ru catalysts, especially with the Cs promoter. Meanwhile, the NH₃ synthesis activity was affected by the promoter loading amount, with 2 wt % Cs loading, both CeO₂ and MgO supported Ru catalysts reached their highest NH₃ synthesis activity. The differences in NH₃ synthesis performance indicated that Ru physicochemical properties were modified by the supports and promoters. Therefore, a number of analytical methods were used to characterize the Ru catalysts, in order to correlate the changes in structural and electronic properties with NH₃ synthesis activity.

2. Characterization and Correlation with Catalytic Activity.

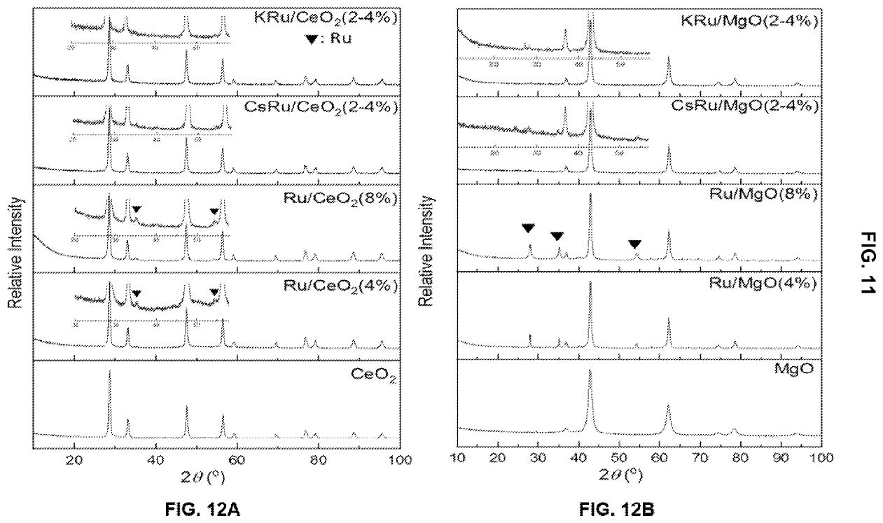

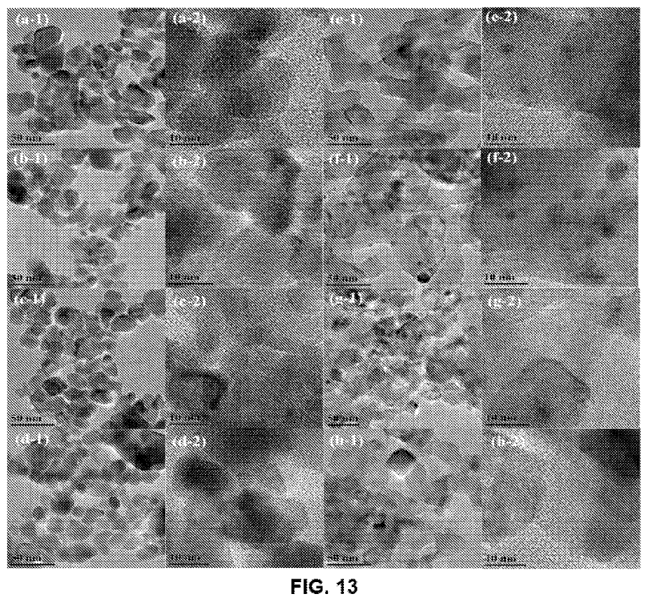

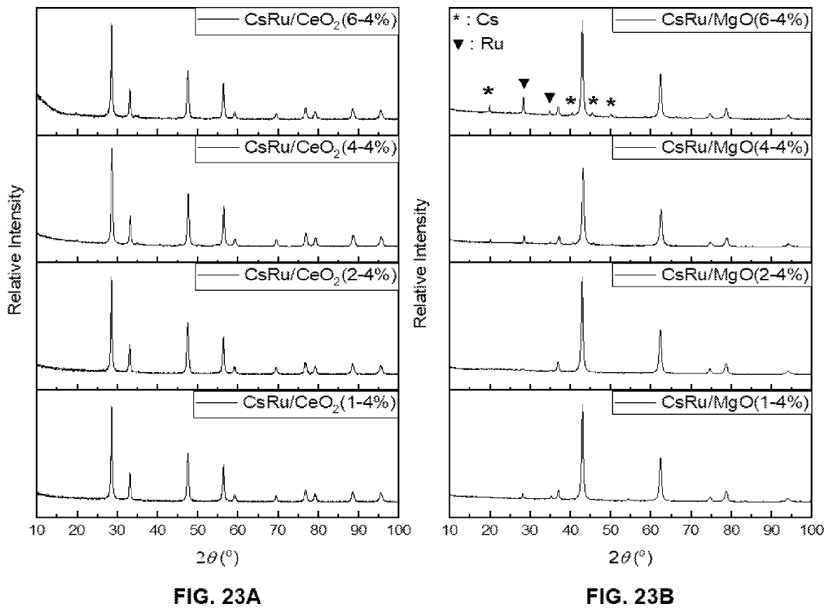

XRD Measurement. XRD was utilized to identify crystalline phases and determine structural property of the catalysts. As shown in FIG. 12A, the Ru diffraction intensity was much weaker over CeO₂ support catalysts. There was only a small Ru characteristic diffraction peak can be observed over Ru/CeO₂(4%) and Ru/CeO₂(8%) when zoomed in the XRD spectra, and the relative diffraction intensity was slightly enhanced when the Ru loading was increased from 4 wt % to 8 wt %. With the addition of Cs and K promoters, it was difficult to ascertain any characteristic diffraction peaks that are attributed to Ru. These results indicated the formation of small particle size of Ru over CeO₂ supported catalysts. The diffraction peaks of Cs and K were not observed over CeO₂ supported catalysts, even at CsRu/CeO₂(6-4%) with 6 wt % Cs concentration, as shown in FIG. 23B. Compared to the CeO₂ supported catalysts, the Ru diffraction intensity is much stronger over MgO supported catalysts, especially for Ru/MgO(4%) and Ru/MgO(8%), as shown in FIG. 12B. With the addition of Cs and K promoters, the Ru diffraction intensity was significantly reduced, but the peaks were still visible. The Ru diffraction intensity presents a valley-shaped distribution with increased in Cs loading, which is shown in FIG. 23B. For MgO supported catalsyts, the Ru diffraction intensity was weakest over CsRu/MgO(2-4%), which was difficult to observe.

The Ru diffraction intensity was weaker over CeO₂ support than MgO and was reduced with the addition of promoters. Moreover, the Ru diffraction intensity was also affected by the loading of promoter, especially over MgO supported catalysts. The strength of Ru diffraction intensity appeared to be associated, at least in part, with its particle size over the support, while the XRD results indicate that Ru particle size can be smaller over CeO₂ than MgO.

CO Chemisorption Measurement. The Ru particle size was further analyzed using CO chemisorption measurement. As shown in Table 3, the Ru particle size and dispersion were affected by the support and promoter, and the results corresponded well with the XRD diffraction peak intensity. Compared with the MgO supported catalysts, the Ru particle size was much smaller with well dispersion over CeO₂ supported catalysts in the absence of promoters. Over Ru/CeO₂ (4%), the Ru particle size was around 7.2 nm with 15.2% dispersion, whereas Ru particle size was much larger (16.8 nm) with lower dispersion (6.6%) over Ru/MgO(4%). When the Ru loading was increase to 8 wt %, the Ru particle size increased and the dispersion decreased on both supports. The Ru particle size was reduced by adding Cs and K promoters over both CeO₂ and MgO supported catalysts with the reduction effect by Cs being more significant, especially over MgO supported catalysts. The Ru particle sizes are slightly reduced to 6.1 and 6.4 nm over CsRu/CeO₂(2-4%) and KRu/CeO₂(2-4%), respectively, and the Ru particle dispersions are increased to 18.0% and 17.4%, correspondingly. The Ru particle size reduction by adding promoter over MgO support was evident. Compared with Ru/MgO(4%), the Ru particle size was reduced by around 74% and 70% for CsRu/MgO(2-4%) and KRu/MgO(2-4%), respectively. Moreover, the Ru particle size was affected by the amount of promoter loading, and it showed different trend over CeO₂ and MgO supported catalysts. As shown in Table 4, Ru particle size was decreased with the increase in Cs loading over CeO₂ supported catalysts. The valley-shaped distribution was observed with increase in Cs loading over MgO supported catalysts. Ru particle size reaches the smallest with 2 wt % Cs loading. The particle size distribution was strongly corresponded with the XRD diffraction peak intensity.

TABLE 3
Physical and chemical properties of MgO and CeO₂ supported
catalysts measured by CO chemisorption and XPS.

| | | | Ru 3d_{5/2} | |
|---|---|---|---|---|
| | | Ru | core | Ce³⁺/ |
| | Ru | Particle | level | (Ce³⁺ + |
| | Dispersion | Size | spectra | Ce⁴⁺) |
| Catalyst | (%) | (nm) | (eV) | (%) |
| Ru/MgO (4%) | 6.6 | 16.8 | 281.6 | N.A. |
| Ru/MgO (8%) | 5.8 | 19.0 | 281.5 | N.A. |
| CsRu/MgO (2-4%) | 24.9 | 4.4 | 282.0 | N.A. |
| KRu/MgO (2-4%) | 21.0 | 5.2 | 281.7 | N.A. |
| Ru/CeO₂ (4%) | 15.2 | 7.2 | 279.8 | 32.1 |
| Ru/CeO₂ (8%) | 8.4 | 13.2 | 279.5 | 29.3 |
| CsRu/CeO₂(2-4%) | 18.0 | 6.1 | 278.9 | 36.7 |
| KRu/CeO²(2-4%) | 17.4 | 6.4 | 279.2 | 35.1 |

TABLE 4
Physical and Chemical Properties of
CsRu/CeO₂ and CsRu/MgO catalysts.

| | | | Ru 3d_{5/2} | |
|---|---|---|---|---|
| | | Ru | core | Ce³⁺/ |
| | Ru | Particle | level | (Ce³⁺ + |
| | Dispersion | Size | spectra | Ce⁴⁺) |
| Catalyst | (%) | (nm) | (eV) | (%) |
| CsRu/MgO | 7.5 | 14.7 | 281.6 | N.A. |
| (1-4%) | | | | |
| CsRu/MgO | 25.0 | 4.4 | 281.5 | N.A. |
| (2-4%) | | | | |
| CsRu/MgO | 20 | 5.5 | 281.6 | N.A. |
| (4-4%) | | | | |
| CsRu/MgO | 14.2 | 7.8 | 281.6 | N.A. |
| (6-4%) | | | | |
| CsRu/CeO₂ | 17.5 | 6.3 | 278.7 | 35.3 |
| (1-4%) | | | | |
| CsRu/CeO₂ | 18.0 | 6.1 | 278.9 | 36.7 |
| (2-4%) | | | | |
| CsRu/ | 23.6 | 4.7 | 278.9 | 38.7 |
| CeO₂(4-4%) | | | | |
| CsRu/ | 27.6 | 4.0 | 278.8 | 39.2 |
| CeO₂(6-4%) | | | | |

The Ru particle size was smaller over CeO₂ supported catalysts than the corresponding MgO supported, and was reduced with the addition of promoters, especially over MgO supported catalysts. The Cs showed stronger reduction effect than K, and the reduction was also affected by the loading amount. Interestingly, although the Ru particle size was much smaller over promoted MgO based catalysts according to the CO chemisorption measurement, the Ru XRD intensity was stronger than that over promoted CeO₂ catalysts. Without wishing to be bound by a particular theory, this may be due to a special interaction between Ru and CeO₂ support. Due to oxygen vacancies of CeO₂ support, the Ru may tend to be absorbed into the CeO₂ crystal structure and form a Ru—O—Ce phase which can reduce the Ru XRD intensity (FIGS. 12A-12B and 23A-23B). The formation Ru—O—Ce phase also likely is associated with a stronger interaction between Ru and CeO₂ support, limiting mobility of Ru and thereby promoting formation of smaller particles with higher dispersion [Ref. 24]. The NH₃ synthesis activity was largely improved by Ru particle size reduction, especially over MgO supported catalysts. However, Ru particle size was not the only determination factor for the enhanced NH₃ activity. Although Ru particle size over CsRu/CeO₂(2-4%) was larger than CsRu/MgO(2-4%), the NH₃ synthesis activity was higher. Without wishing to be bound by a particular theory, this may be because beside the structural effect, Ru electronic state also plays role in NH₃ synthesis.

TEM Measurement. TEM was utilized to assess the size and shape of the active metal particles as well as their dispersion. As seen in FIG. 13 (see (a-1) to (d-2) therein), the Ru particles were not visible on CeO₂ support surface, even with high-resolution TEM (HRTEM). For MgO supported catalysts, Ru particles were observed over Ru/MgO(4%) and Ru/MgO(8%) through TEM and HRTEM, see FIG. 13 (see (e-1) to (f-2) therein). The Ru particle size on Ru/MgO(8%) appeared larger than that on Ru/MgO(4%), which was also observed by CO chemisorption. However, the absolute Ru particles size measured by TEM was smaller than that measured by CO chemisorption. The Ru particles size was mostly smaller than 5 nm for Ru/MgO(4%) and smaller than 10 nm for Ru/MgO(8%). The smaller Ru particle size measured by TEM as compared with CO chemisorption has also reported by others [Ref. 25]. In the presence of promoters Cs and K, it was difficult to define Ru particles on CsRu/MgO(2-4%) and KRu/MgO(2-4%), due to the particle size reduction, which was also confirmed by the CO chemisorption. Elemental EDS mapping measurement by SEM was carried out to confirm the presence of Ru, and/or Cs, and/or K in the corresponding catalysts with fine dispersion, results are shown in FIGS. 24A-24F. Without wishing to be bound by a particular theory, the difficulty of observing Ru particles on some of these catalysts may be due to the small Ru particle size, particularly on MgO supported catalysts. Further, without wishing to be bound by a particular theory, for the CeO₂ supported catalysts, the formation of Ru—O—Ce phase may also be a reason for not being able to observe Ru particles through TEM. Without wishing to be bound by a particular theory, it is possible that Ru was immersed into Ru—O—Ce phase with a structure similar to lattice CeO₂.

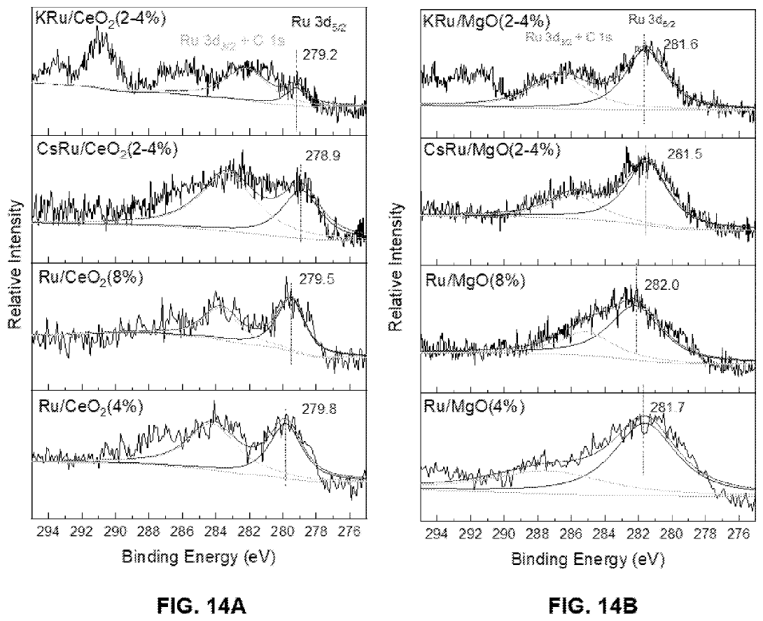

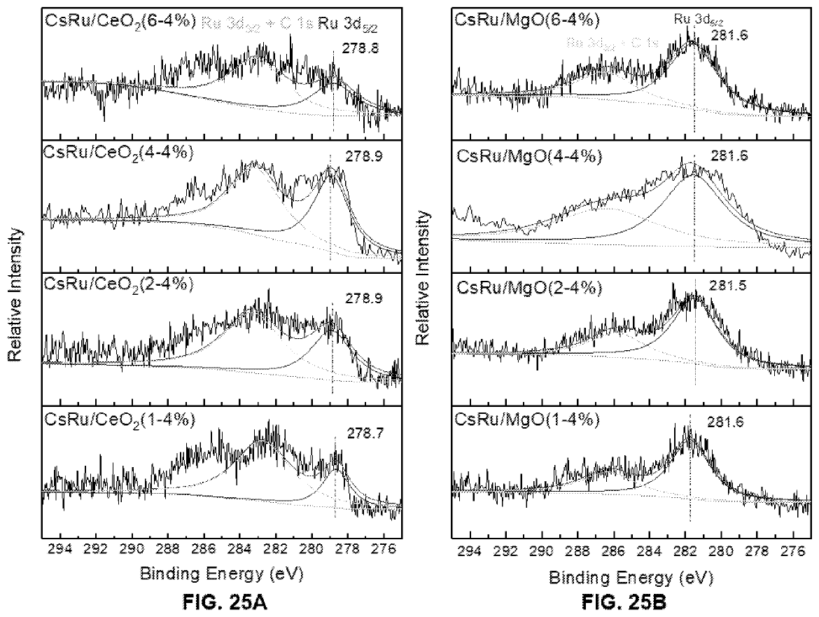

Characterization by XPS. XPS was utilized to characterize the electronic state of Ru in order to identify the effect of support and promoter in NH₃ synthesis. FIGS. 14A-14B show Ru 3d core level spectra of catalysts without reduction with dihydrogen before the XPS measurements. The Ru 3d core level spectra consisted of Ru 3d5/2 and Ru 3d3/2 core level spectra, due to the spin-orbital splitting. The Ru 3d3/2 core level spectra were overlapped with C is core level spectra, which was derived from the carbon tape or slowly accumulated in the spectrometer. For this reason, only Ru 3d5/2 core level spectra were used for discussion herein. The Ru 3d5/2 core level spectra over CeO₂ supported catalysts were much lower than over MgO supported catalysts. As shown in FIGS. 14A-14B and Table 3, the Ru 3d5/2 core level spectra ranged from 278.9 to 279.4 eV over CeO₂ supported catalysts, while the range from 281.5 to 282 eV over MgO supported catalysts was observed. Ru 3d5/2 core level spectra were also affected by the presence of promoters over both CeO₂ and MgO supported catalysts. Specifically, in the presence of Cs promoter, the Ru 3d5/2 core level spectra were decreased from 279.8 eV for Ru/CeO₂(4%) to 278.9 eV for CsRu/CeO₂(2-4%), and decreased from 281.7 eV for Ru/MgO(4%) to 281.5 eV for CsRu/MgO(2-4%). In the presence of K promoter, the Ru 3d5/2 core level spectra were decreased to 279.2 and 281.6 eV for KRu/CeO₂(2-4%) and KRu/MgO(2-4%), respectively. However, the amount of promoter loading appears to have less effect on the Ru 3d5/2 core level spectra. As shown in FIGS. 25A-25B and Table 2, all the CsRu/CeO₂ catalysts have the similar Ru 3d5/2 core level spectra, same with the CsRu/MgO catalysts. The Ru 3d5/2 core level spectra indicate the electron density of Ru, the low Ru 3d5/2 core level spectra mean the higher electron density [Ref. 26]. Without wishing to be bound by a particular theory, the excess electron density can be transferred from d orbitals of Ru atoms to the antibonding orbitals of adsorbed N₂ molecules, which can weaken the N═N bonds and therefore facilitate N₂ dissociation. Further, without wishing to be bound by a particular theory, because activation of N═N bonds is the rate determination step, the Ru with high electron density can accelerate NH₃ synthesis rate. While the electron density of Ru is affected by its interaction with the support and promoter, CeO₂ shows higher negative charge ability for Ru compare with MgO, leading to higher NH₃ synthesis activity over CeO₂ supported catalysts. The Ru electron density was further improved by adding promoters. Due to the lower electronegativity of Cs, it showed the higher promoting effect than K.

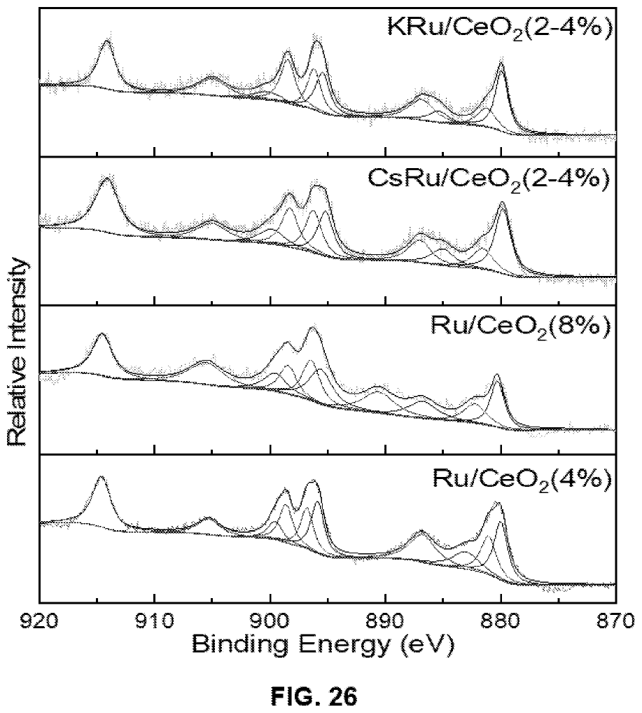

Moreover, the partial reduction of CeO₂ facilitates NH₃ synthesis. The changes of oxidation state from Ce⁴⁺ to Ce³⁺ creates abundant of oxygen vacancies, which enhance the adsorption of hydrogen and nitrogen facilitating the NH₃ synthesis [Ref. 19, 27]. Meanwhile, the oxygen vacancies lead to the formation of Ru—O—Ce bonds and increase the interaction between Ru and CeO₂ [Ref. 28.] The strong interaction between Ru and CeO₂ reduces the Ru particle size and improves Ru dispersion, thus creating more active sites for NH₃ synthesis. In addition to the increase in metal active sites, the oxygen vacancy also acts as an important coordination site in Ru/CeO₂ catalysts. Therefore, the concentration of oxygen vacancy in Ru/CeO₂ catalysts was analyzed by XPS in the present study. The amount of oxygen vacancy is correlated with the Ce³⁺ concentration. The oxygen vacancy concentration is calculated by the ratio of the Ce³⁺ XPS peak area to the area of all Ce peaks. FIG. 26 shows the Ce 3d XPS spectra of CeO₂ supported catalysts. As show in Table 3, the CsRu/CeO₂ (2-4%) has the highest Ce³⁺/(Ce³⁺+Ce⁴⁺) percentage of 36.7%, followed by 35.1% for KRu/CeO₂ (2-4%), 32.1% for Ru/CeO₂ (4%), and 29.3% for Ru/CeO₂ (8%). This order was consistent with Ru particle size over CeO₂ support. Meanwhile, the Ce³⁺/(Ce³⁺+Ce⁴⁺) ratio was affected by Cs loading amount, which are shown in Table S2 and Figure S9. The Ce³⁺/(Ce³⁺+Ce⁴⁺) ratio was increased from 35.3% to 39.2% when the Cs loading is increased from 1% to 6%. This result suggests that the interaction between Ru and CeO₂ support is enhanced with increase in Cs loading, leading to decrease in Ru particle size.

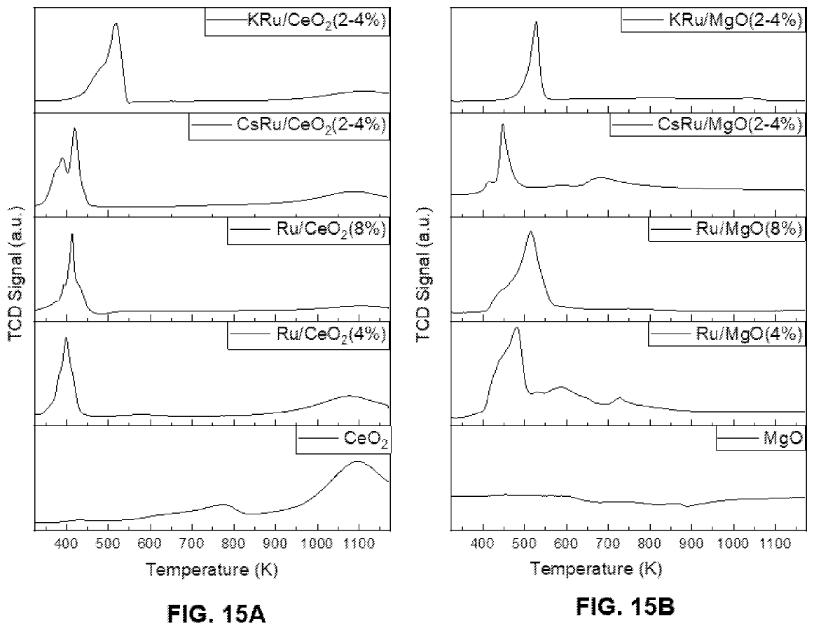

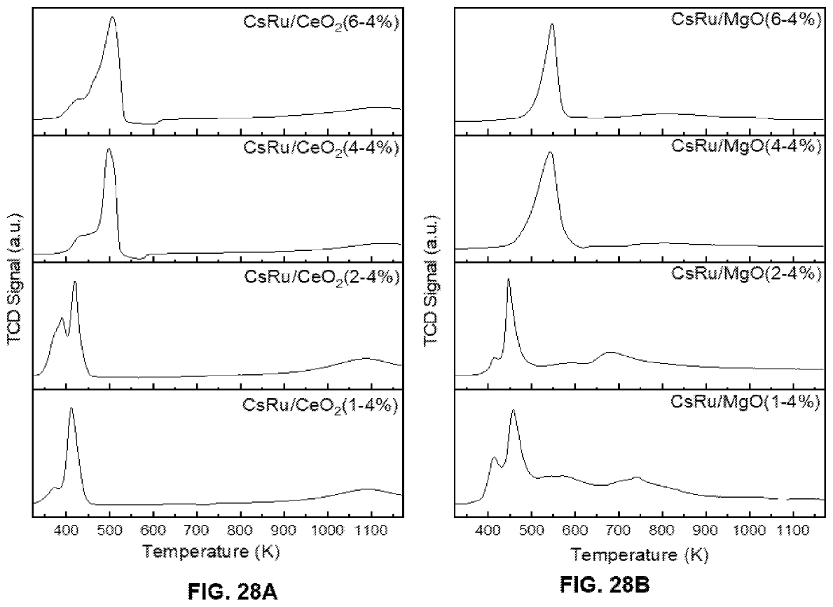

H₂-TPR Measurement. H₂-TPR was utilized to investigate the effects of support and promoter on the Ru catalysts reducibility. As shown in FIG. 15A, two reduction peaks were detected over CeO₂ support. The one centered around 773K represents the reduction of the surface oxygen on CeO₂, the other centered around 1093K is likely due to the reduction of lattice oxygen of CeO₂. While MgO is more stable, no reduction peak was detected over MgO. These results further confirmed that the reduction of CeO₂ facilitates NH₃ synthesis. The reducibility of Ru was affected by the particle size and metal-support interaction. Ru showed much lower reduction temperature over CeO₂ support than MgO support. A hydrogen reduction peak in the temperature range of 338-438K was observed over Ru/CeO₂(4%), where a main peak centered around 398K and a shoulder peak centered around 383K are observed. The main peak can be attributed to the complete reduction of Ru⁴⁺ to Ru⁰, whereas the shoulder peak is associated with Ru species interacting with CeO₂ support through sharing of common oxygen atoms. A wider reduction peak in the temperature range of 398-513K was observed over Ru/MgO(4%), with a main peak centered around 483K and a shoulder peak centered around 438K. The higher Ru reduction temperature over MgO was likely due to the larger size of particles. When Ru loading was increased to 8%, the main Ru reduction peak shifted to 413 and 513 K for Ru/CeO₂(8%) and Ru/MgO(8%), respectively, due to the Ru particle size increase. When Cs promoter was added to the catalysts, two reduction peaks were observed over both CsRu/CeO₂(2-4%) and CsRu/MgO(2-4%) with the lower temperature peak being attributable to the Cs reduction and the higher peak attributable to the Ru. The closeness of these two peaks may be due to the Cs dispersed over the Ru particles or close surroundings. As the Ru has high hydrogen dissociating capability, Cs can be reduced by hydrogen spillover directly and simultaneously with Ru [Ref. 29]. Without wishing to be bound by a particular theory, it may be possible that the reduced Cs nearby Ru can act as a strong electron donor and increase the NH₃ synthesis. For the CsRu/MgO(2-4%) catalyst, the main reduction peak shifted to 448 K with decrease in Ru particles size. In contrast, the CsRu/CeO₂(2-4%) catalyst only showed a small reduction in particle size and the main reduction peak is increased to 423K in comparison with Ru/CeO₂(4%). But the Ru reduction peak at lower temperature, which is corresponding to the interaction with CeO₂ support, is more apparent. These results indicate that Cs shows both electronic and structural promotion over CsRu/MgO(2-4%), while more electronic promotion than structural promotion over CsRu/CeO₂(2-4%) was observed. The promoter K doesn't show any reduction peak over KRu/CeO₂(2-4%) and KRu/MgO(2-4%), which may be due to the close contact with Ru particles and hydrogen spillover reduction. Distinct from the decrease in reduction peak temperature over CsRu/MgO(2-4%) or a slight increase over CsRu/CeO₂(2-4%) for Cs promoter, the reduction peak is shifted to 523K for both KRu/CeO₂(2-4%) and KRu/MgO(2-4%). This suggests that the electronic property may be simultaneously modified when two elements interact each other, meanwhile the support's electronic property can also affect these changes. Although the reduction temperature was increased with the introduction of K, Ru particle size was still reduced over KRu/MgO(2-4%) and KRu/CeO₂(2-4%), and the increase in electron donation ability of reduced K improved NH₃ synthesis activity. Moreover, the reducibility of Ru was affected by the promoter Cs loading amount, as shown in FIGS. 28A-28B. The Ru reduction temperature shifted higher as the Cs loading is increased over both CeO₂ and MgO supported catalysts. At the low Cs loading (1 wt % and 2 wt %), two reduction peaks below 473K were observed over both CeO₂ and MgO support. When Cs loading was increased, the reduction peaks merger into one, especially over MgO support. The reduction peaks of Cs and Ru were merged into one. Without wishing to be bound by a particular theory, this may be due to simultaneous electronic modification of both elements when they interact each other.

### 3. Density Functional Theory (DFT) Calculations.

DFT Modeling for Catalysts. To understand the relatively higher dispersion and smaller particle size of Ru over CeO₂ than MgO, the binding energy of Ru, Ru₄, Ru₁₃ metal clusters over CeO₂ and MgO surface were calculated using density functional theory (DFT). The detailed DFT method is described in supporting information. As shown in Table 5, the binding of Ru to the CeO₂(110) surface was stronger (3.65 eV) compared to MgO(100) surface (5.60 eV). Similarly, the binding of Ru₄ and Ru₁₃ metal clusters to the CeO₂(110) surface were also stronger (2.35 eV and 1.92 eV per atom, respectively) in comparison to the MgO(100) surface (3.18 eV and 2.02 eV per atom, respectively).

TABLE 5
Binding energy of Ru metal cluster to
the MgO(100) and CeO₂(110) surfaces.

| | |
|---|---|
| Binding | atom (eV) |

| energy | MgO(100) | CeO₂(110) |
|---|---|---|
| Ru | 5.60 | 3.65 |
| Ru₄ | 3.18 | 2.35 |
| Ru₁₃ | 2.02 | 1.92 |

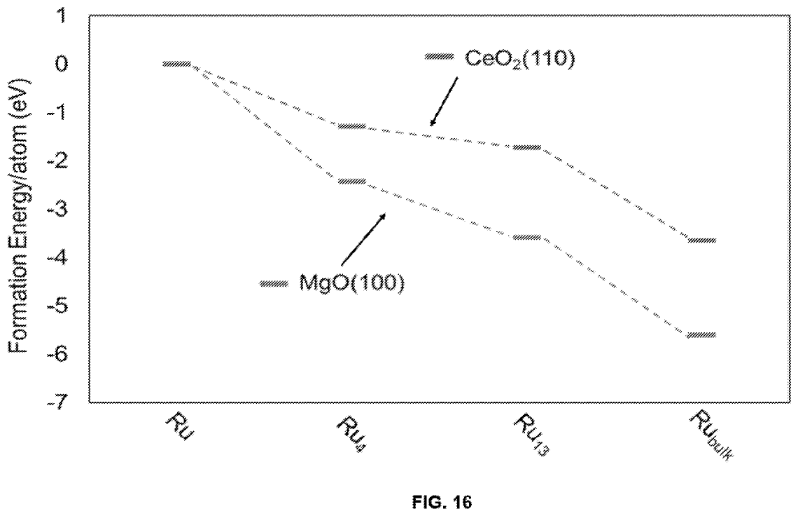

In FIG. 16, the tendency of the atomically dispersed adsorbed Ru atom to form bigger Ru cluster (Ru₄ and Ru₁₃) and eventually Ru-bulk like surface structure is shown.

E_{f}=(E_{Ru}_{ₓ}₊ₛᵤₚₚₒᵣₜ×E_{Ru+support})/x,E_{Ru}_{ₓ}₊ₛᵤₚₚₒᵣₜE_{Ru+support}

As can be seen in FIG. 16, the gain in formation energy for four Ru single atom to form Ru₄ cluster is higher on MgO(100) surface compared to the CeO₂(110) surface. A similar trend can also be seen for agglomeration of Ru single atom to Ru₁₃ cluster and Ru-bulk in FIG. 16. The agglomeration energy/per atom for forming Ru bulk like surface structure over MgO(100) surface was found to be favorable by −5.60 eV, whereas the value is comparatively lower at the CeO₂(110) surface (−3.65 eV). The higher metal dispersion and small particle size for the Ru/CeO₂ catalyst can be attributed to stronger Ru—CeO₂ metal-surface bond strength which reduces the tendency of agglomeration of Ru over the CeO₂(110) surface.

Due to high dispersion and small particle size, the number of Ru (211) step sites, known to be the active site for NH₃ formation, are anticipated to be higher in the Ru/CeO₂ catalyst compared to the Ru/MgO catalyst. The number of step site presented in the metal nanoparticle increases exponentially with the decrease in particle size which has been reported by Jacobsen et al [Ref. 30-33]. Due to the presence of higher number of active sites in the Ru/CeO₂ catalyst, the NH₃ yield is calculated to be higher compared to the Ru/MgO catalyst, that has been confirmed by the experiment data.

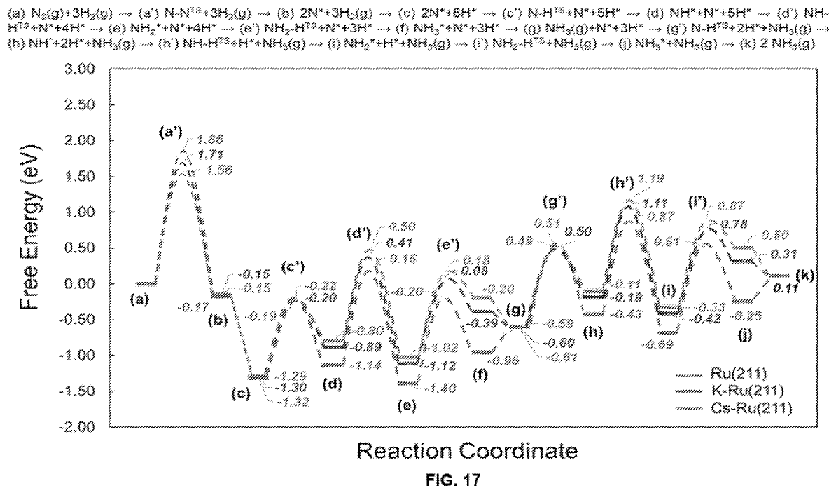

MKM Modeling for Reaction Mechanism. Microkinetic modeling (MKM) was used to understand the NH₃ formation reaction pathway over Ru and the effect of promoter under microwave irradiation. The detailed calculation method is described below. A free energy diagram constructed for the NH₃ formation from the reaction of N₂ and H₂ at reaction temperature 533 K, over the Ru(211) and K and Cs promoted Ru(211) surface has been shown in FIG. 17. As can be seen in FIG. 17 (a′) the activation barrier of N₂ dissociation were calculated to be smaller by 0.15 eV and 0.3 eV over the K—Ru(211) and Cs—Ru(211) surfaces, respectively, in comparison to pure Ru(211) surface. The reaction energy for the N₂ dissociation to surface adsorbed 2N* almost remains unchanged for the K—Ru(211) and Cs—Ru(211) surfaces as shown in FIG. 17. The subsequent step-wise hydrogenation of N* to NH, NH₂ and NH₃ are shown in FIG. 17 (c→d), (d→e) and (e→f), respectively. Due to the smaller activation barriers, the hydrogenation steps are not expected to be rate-limiting. However due to high stability of NHx species over the Ru(211) surface, the NH₃ conversion may be desorption limited at lower temperatures. The addition of K and Cs promoter destabilized the NHx species, as shown in Table 6, also help in the desorption of the NHx species hence enhance the rate of NH₃ production. Destabilization of NH, NH₂ and NH₃ surface intermediates are more pronounced over the Cs—Ru(211) surface, as can be seen in FIG. 17.

TABLE 6
DFT Calculated Energies of transition states and surface intermediates
over the Ru(211), K—Ru(211) and Cs—Ru(211) surfaces.

| | Energy (eV) | | |
|---|---|---|---|
| | Ru(211) | K—Ru(211) | Cs—Ru(211) |
| N* | 0.32 | 0.33 | 0.33 |
| NH* | −0.05 | 0.19 | 0.27 |
| NH₂* | −0.86 | −0.59 | −0.5 |
| NH₃* | −0.97 | −0.41 | −0.22 |
| H* | −0.55 | −0.55 | −0.55 |
| N—N^{TS} | 2.67 | 2.52 | 2.37 |
| N—H^{TS} | 0.87 | 0.88 | 0.88 |
| NH—H^{TS} | 0.7 | 0.94 | 1.02 |
| NH₂—H^{TS} | −0.21 | 0.06 | 0.15 |

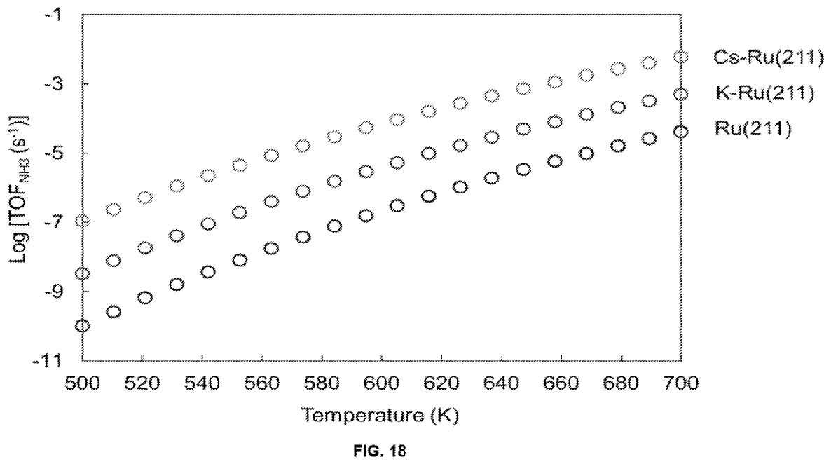

To obtain the intrinsic activity trend of the non-promoted and K and Cs promoted Ru(211) surface for the rate of ammonia production was calculated using MKM, as shown in FIG. 18. The rate (TOF) of NH₃ production over the Ru(211), K—Ru(211) and Cs—Ru(211) catalyst surfaces have been plotted against the reaction temperature which was shown in FIG. 18. Due to the high N≡N dissociation barrier, the ammonia formation rate over the Ru(211) surface is calculated to be low (˜10-9 s−1) at 533 K, which increased with an increase in temperature and reaches an appreciable value of TOF ˜10-4 s−1 at 700K (FIG. 18). Due to the promotional effect of K, discussed above, the TOF of ammonia formation was calculated to be at least one order of magnitude higher, as shown in FIG. 18. The NH₃ formation TOF over the K—Ru(211) surface is obtained to be ˜10-7 s−1 at 533K and increased to TOF ˜10-3 s−1 at 700K (FIG. 18). The promotional effect of Cs is further pronounced with ammonia production TOF calculated to be ˜10-6 s−1 at 533K and ˜10-2 s−1 at 700K, as shown in FIG. 18. The promotional role of alkali promoter K and Cs in the ammonia formation over Ru catalyst is explained using combined DFT and ab-initio microkinetic modeling approach, with Cs being the better promoter than K, in agreement with the experimental results presented above.

Results from characterization and DFT calculation, suggests that both supports and promoters play important roles in Ru catalyzed NH₃ synthesis. The Ru particle size was smaller and more dispersed over CeO₂ than over MgO, resulting in an enhancement in the number of active sites in NH₃ synthesis. As shown in DFT calculation, the strength of Ru—CeO₂ bond appears to become stronger than that of Ru—MgO, which reduces Ru particle size over CeO₂ surface. Meanwhile, compared with MgO, the CeO₂ has higher electron donating ability to Ru, resulting in a higher electron density over Ru. The excess electron density appears to reduce the N═N dissociation barrier and therefore facilitates NH₃ synthesis. Furthermore, the reversible transition between Ce³⁺ and Ce⁴⁺ valence states over CeO₂ creates abundant of oxygen vacancies, enhancing H₂ and N₂ adsorption. These oxygen vacancies can also lead to the formation of Ru—O—Ce bonds, thereby increasing the interaction between Ru and CeO₂.

The Ru particle structure and electronic state can be modified by promoters, and these modifications are associated with support property. The electron density of Ru is improved as the promoter was introduced, resulting in higher NH₃ synthesis activity.

Due to lower electronegativity, the Cs appears to show a higher electronic promotion effect than K. The electronic modification by promoter is more apparent over CeO₂ than MgO support. However, the electronic state of Ru appears less sensitive to the loading amount of promoters. The structural sensitivity over MgO support was more apparent than CeO₂ support and it was impacted by loading amount of the promoters. Over MgO supported catalysts, Ru particle size was reduced with the addition of Cs, reaching the minimum size at 2 wt % Cs at which NH₃ synthesis activity reaches the highest. Over CeO₂ supported catalysts, Ru particle size continued to decrease with increased Cs loading. Without wishing to be bound by a particular theory, this may be due to the stronger interaction between Ru and CeO₂ interaction. However, NH₃ synthesis activity reached a high level at 2 wt % Cs loading over CeO₂ supported catalysts. Without wishing to be bound by a particular theory, this may be associated with a balanced effect of structural sensitivity and electronic modification.

Both structural and electronic modifications by promoters play roles on supported Ru catalysts, however, their proportions of contribution in NH₃ synthesis are different over MgO and CeO₂ supports. Over MgO supported catalysts, the structural sensitivity becomes predominant through reduction of Ru particle size to increase the number of active sites. In contrast, over CeO₂ supported catalysts, the electronic modification is dominant, mainly through improving the electron density over Ru that favors activation of N₂ molecule.

### 4. Further Data.

Chemicals and materials. Magnesium oxide (MgO, Timilon Technology), Cerium (IV) oxide (99.95%, CeO₂, Sigma-Aldrich), Ruthenium (III) nitrosylnitrate (≥31.3% Ru, Ru(NO)(NO3)3, Alfa Aesar), Cesium nitrate (99.8%, CsNO3, Alfa Aesar), and Potassium nitrate (≥99.0%, KNO3, Fisher Chemical) were used to synthesize the catalysts. All chemicals used in this work were purchased from the commercial suppliers and used as received without any further purification.

Catalyst Preparation. All catalysts were prepared by incipient wetness method. For example, the CeO₂ support was wet impregnated with a solution of Ru(NO)(NO3)3 and CsNO3. After drying in air (373K, 12 h), the sample was calcined at 823K for 4 h. The catalyst thus obtained had a nominal 4 wt % content of Ru and 2 wt % Cs and was designated as CsRu/CeO₂(2-4%). Moreover, Ru/CeO₂(4%), Ru/CeO₂(8%), CsRu/CeO₂(1-4%), CsRu/CeO₂(4-4%), CsRu/CeO₂(6-4%), KRu/CeO₂(2-4%), Ru/MgO(4%), Ru/MgO(8%), CsRu/MgO(1-4%), CsRu/MgO(2-4%), CsRu/MgO(4-4%), CsRu/MgO(6-4%), and KRu/MgO(2-4%) were also prepared following the same procedure.

Catalytic Activity Evaluation. The catalyst activity for ammonia synthesis was measured in a quartz tube reactor (8 mm-ID, 12 mm-OD) under atmospheric pressure. A variable frequency microwave reactor (Lambda MC1330-200) was used to apply microwave irradiation to the catalyst at 5.850 GHz frequency. The microwave reactor system is equipped with two IR sensors, one is used to measure reactor temperature, the other is used to measure bulk catalyst temperature. The CeO₂ supported catalysts (1.2 g) was sieved to 60-100 mesh and tested in a flowing gas mixture of 75 vol. % H₂ and 25% vol. N₂ at 533 K under 6000 mL/g_{cat}·h weight hourly space velocity (WHSV). For the MgO supported catalysts, 0.4 g catalyst (60-100 meshes) was mixed with 0.1 g of 200 mesh sized silicon carbide (SiC) to improve the microwave adsorption ability. The activity was tested under the same temperature, gas composition, and WHSV. The ammonia concentration in the effluent was analyzed by a 4-channel Inficon Fusion micro gas chromatography (Micro-GC).

Characterization Methods. X-Ray diffraction (XRD) measurement was carried out on a PANalytical XRD using CuKα radiation at 40 kV and 40 mA in the 26 range from 10 to 1000 at a scan rate of 5 o/min. Transmission electron microscopy (TEM) measurement were carried out on a FEI Tecnai F20 Super-Twin, operated at 200 kV. The samples were prepared by suspending catalyst in ethanol and dispersing on a copper grid coated with lacey carbon film before TEM analysis. The chemical elements of the samples were measured by the energy-dispersive X-ray spectroscopy (EDS) equipped with scanning electron microscopy (SEM) on a Hitachi S-4700.

H₂ temperature-programmed reduction (H₂-TPR) was carried out in a Micromeritics Autochem 2910 instrument. In the TPR measurement, 0.2 g sample was first pretreated at 573K for 120 min in a flow of N₂ (30 mL/min) followed by cooling down to 323K. Then, the sample was heated up to 1123K at a heating rate of 10 K/min in a flow of 10% H₂ in argon (30 mL/min). Hydrogen consumption was measured using calibration of the signal obtained using a TCD.

X-ray photoelectron spectroscopy (XPS) analysis was carried out using a PHI 5000 Versaprobe Scanning ESCA Microprobe spectrometer equipped with a monochromatic Al X-ray beam (100 μm, 12.5 W, 15 kV). The samples were sputtered with an Ar ion gun (2 kV, 2 μA, 1×1 raster) at a sputter rate of 17 nm/min. The binding energies are referenced to the C(1s) binding energy of adventitious carbon contamination taken to be 284.8 eV.

The average Ru particles size was estimated through chemisorption technique with carbon monoxide (CO) as the adsorbate. The measurements were performed in an ASAP 2020 instrument (Micromeritics) at 308 K. The samples were reduced with H₂ at 703K for 10 h prior to measurements. The chemisorption data were used for calculating the Ru particles size and dispersions, The CO: Ru=0.6:1 stoichiometry was applied for calculating Ru particles size.

Dielectric properties were measured with a HP 7-mm-diameter coaxial airline (model no. 85051-60010) connected to a Keysight N5231A PNA-L microwave network analyzer. To minimize the contribution of air to the measurement, samples were compressed within the coaxial airline to a length of 1.5 cm. The samples were measured from 0.5 to 13.4 GHz.

Computational methods. The steady state catalytic rates were calculated using microkinetic modeling (MKM), the reaction condition (e.g. temperature and pressure), gas-phase reactant and products energetics, adsorption energies of the reaction intermediates, and transition state energies of the elementary reaction steps used as the inputs. Intermediates and transition states energies are obtained from CatApp database [Ref. 1]. These energies are calculated using plane wave DFT calculations with Revised Perdew-Burke-Ernzerhof (RPBE) Generalized Gradient Approximation (GGA) exchange correlation functional [Ref. 2]. The intermediates and transition states energies are calculated with the formula (1):

$$\\ \begin{matrix}{E}_{{N}_{x} {H}_{y} = {E}_{slab + {N}_{x} {H}_{y}}} - {E}_{slab} - [ x ( {E}_{{NH}_{3} ( g )} - \frac{3}{2} {E}_{{H}_{2} ( g )} ) + \frac{y}{2} {E}_{{H}_{2} ( g )} ] , & ( 1 )\end{matrix}$$

where E_{slab+N}_{ₓ}_{H}_{_{y}}, E_{slab}, E_{NH}_{₃}_{(g)} and E_{H}_{₂}_{(g)} are the energies of adsorbed intermediate N_x H_y, clean surface, gas-phase ammonia and hydrogen, respectively. The assumption rate-determining step is not required, because the MKM solution is performed numerically.

The steady-state solutions for the elementary reaction steps were obtained with CatMAP utilizing a multi-dimensional Newton's root finding method. The fixed entropy assumption was applied for the gas-phase species, the frozen adsorbate approximation was used for the adsorbates, with negligible entropy change in the reactions taking place on the surface assuming [Ref. 36-37]. The normal mode vibrational frequency analysis with harmonic approximation was used to calculating the Gas phase species zero point energy (ZPE) [Ref. 36, 38]. Table 7 shows the formation energy, entropy and ZPE data of the gas-phase species.

TABLE 7
Formation energy, entropy and ZPE of the
reactant and product gas-phase species.

| | Formation | | |
|---|---|---|---|
| Gas-phase | Energy | Entropy | ZPE |
| species | (eV) | (eV/K) | (cm⁻¹) |
| N₂ | 1.87 | 0.00198 | 1227 |
| H₂ | 0 | 0.00135 | 2233 |
| NH₃ | 0 | 0.001997 | 7630 |

MKM was simulated at a 500 K-700 K range temperature, 1 bar total pressure, 1:3 in N₂:H₂ molar ratio, and 0.001% conversion of reactant gases.

To understand the effect of promoter for Ru activity for ammonia synthesis, the dissociative chemisorption process of N₂ molecule was studied over the atomically dispersed Ru/CeO₂ catalyst surface using density functional theory (DFT). Geometry optimizations were performed using plane wave DFT code as implemented in Vienna ab initio simulation package (VASP-5.4.4 version) [Ref. 39]. The core-electrons of the system were represented using Projected Augmented Wave (PAW) potential, whereas valence state electrons were expanded using plane wave basis function [Ref. 35, 40]. The plane-wave basis functions were truncated at a cut-off energy of 396 eV. Revised Perdew-Burke-Ernzerhof (RPBE) exchange correlation functional developed by Hammer et al. was used [Ref. 35].

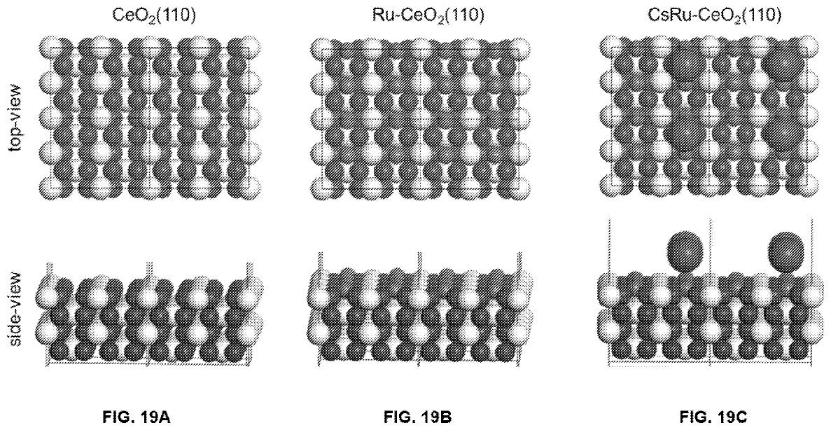

The CeO₂(110) surface was modeled using a four-layer surface slab of size 4×4, shown in FIG. 19A. The atomically dispersed Ru—CeO₂(110) model was obtained by adding one Ru atom at the CeO₂(110) surface. The most stable configuration of Ru—CeO₂(110) and Cs-promoted Ru—CeO₂(110) surface model obtained using DFT geometry optimization has been shown above in FIGS. 19B and 19C, respectively. The surface slabs were periodically repeated with 20 Å vacuum along the z-axis. During the geometry optimization the bottom two layers of the CeO₂(110) surface slab were fixed while the upper half along the adsorbate were allowed to relax. Convergence criteria for force and energy were set to 0.05 eV/A and 10-6 eV, respectively. Monkhorst-Pack k-point sampling of 2×2×1 along with Gaussian smearing parameter of value 0.02 were used for all the calculations [Ref. 41].

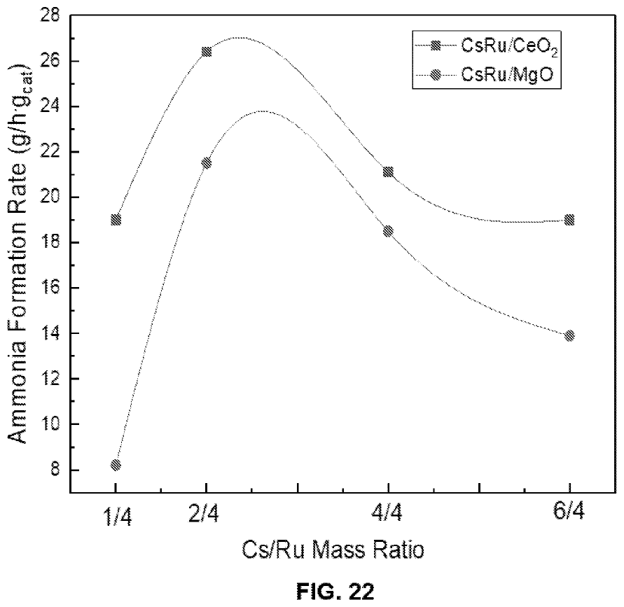

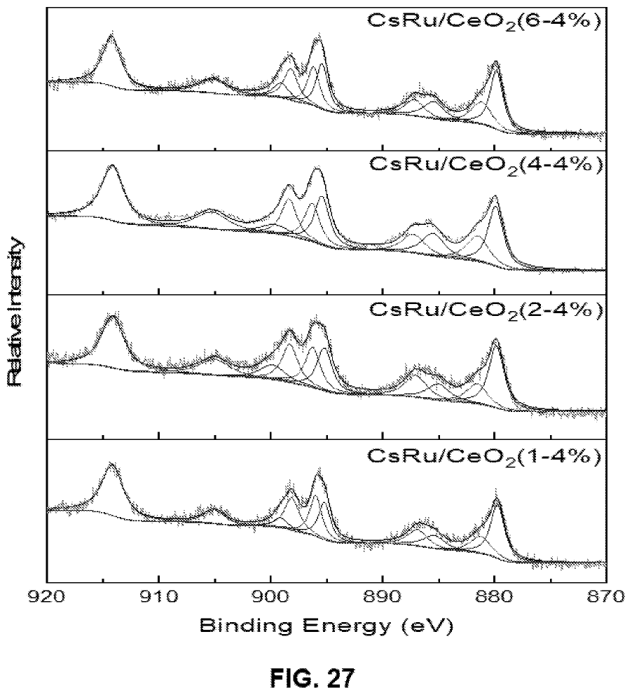

Results. The results are discussed, in part, herein above and data are shown in Table 4 and FIGS. 20-28B.

DFT Modeling set up for Ru/MqO and Ru/CeO₂. To understand the relatively high dispersion and small particle size of Ru nanoclusters, the binding energy of Ru, Ru₄, Ru₁₃ metal clusters were calculated over CeO₂ and MgO surface using density functional theory (DFT). Geometry optimizations were performed using plane wave DFT code as implemented in Vienna ab initio simulation package (VASP-5.4.4 version) [Ref. 39]. The core-electrons of the system were represented using Projected Augmented Wave (PAW) potential, whereas valence state electrons were expanded using plane wave basis function [Ref. 35, 40]. The plane-wave basis functions were truncated at a cut-off energy of 396 eV. Revised Perdew-Burke-Ernzerhof (RPBE) exchange correlation functional developed by Hammer et al. was used [Ref. 35].

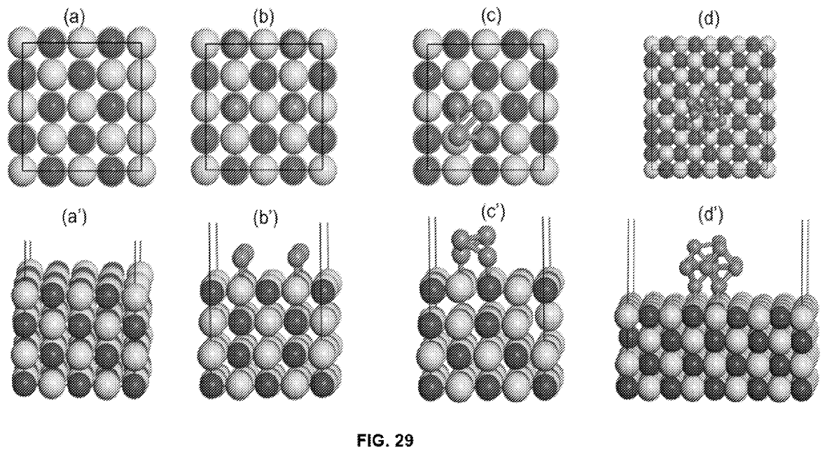

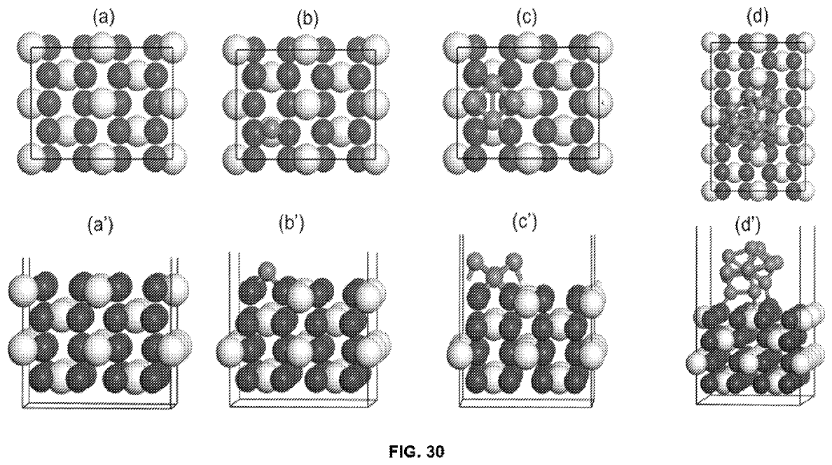

MgO(100) and CeO₂(110) surface was modeled using a four-layer surface slab of size 4×4, shown in FIGS. 29-30. The DFT optimized geometry binding configuration of Ru, Ru₄ and Ru₁₃ metal cluster bonded to the MgO(100) and CeO₂(110) surfaces were shown in FIG. 29 (b-d) and FIG. 30 (b-d), respectively. The surface slabs were periodically repeated with 20 Å vacuum along the z-axis. During the geometry optimization the bottom two layers of the MgO(100) and CeO₂(110) surface slabs were fixed while the upper half along the Ru cluster atoms were allowed to relax. Convergence criteria for force and energy were set to 0.05 eV/A and 10-6 eV, respectively. Monkhorst-Pack k-point sampling of 2×2×1 along with Gaussian smearing parameter of value 0.02 were used for all the calculations [Ref. 41]. The cluster formation energy/atom (Ef) was defined as:

E_{f}=(E_{Ru}_{ₓ}₊ₛᵤₚₚₒᵣₜ−xE_{Ru+support})/x,

where x is the number of Ru atom in the cluster and,

E_{Ru}_{ₓ}₊ₛᵤₚₚₒᵣₜ,E_{Ru+support}

are the energies of Rux metal cluster and single Ru atom adsorbed at the catalyst support surface, respectively.

Microkinetic modeling set up for Reaction Mechanism. NH₃ production over the Ru catalyst is known to be predominant over the B5 site of Ru(0001) step sites. The activation barrier for the N₂ dissociation over the Ru(0001) step sites was calculated to be 0.59 eV lower compared to the closed packed terrace sites. Alkali promoters like K and Cs are commonly used along with Ru catalyst to boost the NH₃ production rate in Haber Bosch process. To understand the higher activity of Cs promoted Ru catalyst over the K promoted Ru catalyst, a free energy diagram was constructed for NH₃ formation at reaction temperature (T=533 K) for the Ru(0001) step surface and K and Cs promoted Ru(0001) step surfaces, using the adsorption and transition state energies given in Table 5. The effect of the K and Cs promoter on the adsorption and transition energies of species involved in NH₃ formation reaction have been studied by Nørskov et al [Ref. 42-43]. The interaction of the alkali promoter and the surface adsorbates and transition states were known to be electrostatic in nature as studied by Mortensen et al [Ref. 44]. The electrostatic interaction (ΔE_{dipole}) was proposed to be dependent of the electric field (ε) induced by the alkali promoted (K and Cs) and the dipole moment (μ) of the adsorbed intermediates and transition states and follow the equation: ΔE_{dipole}=−ε×μ. The electropositive alkali metals known to decrease the work-function of the metal surface and hence creating an enhanced electric field, as described by Mortensen et al [Ref. ¹¹]. As suggested by the authors over the K-promoted Ru(211) surface, the N—N^{TS} was lowered by 0.15 eV, whereas the N, NH, NH₂ and NH₃ species were destabilized by 0.01 eV, 0.23 eV, 0.27 eV and 0.56 eV, respectively, as given in Table S4 [Ref. ^{34, 35}] In general, the electropositive nature of the alkali metals increases with increasing atomic number and the promotion effects of Cs is higher compared to K. Mortensen et al. showed the decrease in the Ru(0001) work-function as well as the ΔE_{dipole} for the N-N^{TS} for the Cs-promoted Ru(211) surface were higher compared to the Na-promoted Ru(211) step surface [Ref. ¹¹] Using the ΔE_{dipole} value for the Cs-promoted Ru(211) surface, the N—N^{TS} was lowered by 0.3 eV, whereas the N, NH, NH₂ and NH₃ species were destabilized by 0.01 eV, 0.32 eV, 0.36 eV and 0.75 eV, respectively, as given in Table 6. The activation barriers for the NHₓ—H (x=0, 1, 2) coupling reactions were kept unchanged for both the K and Cs promoted Ru(211) surfaces.

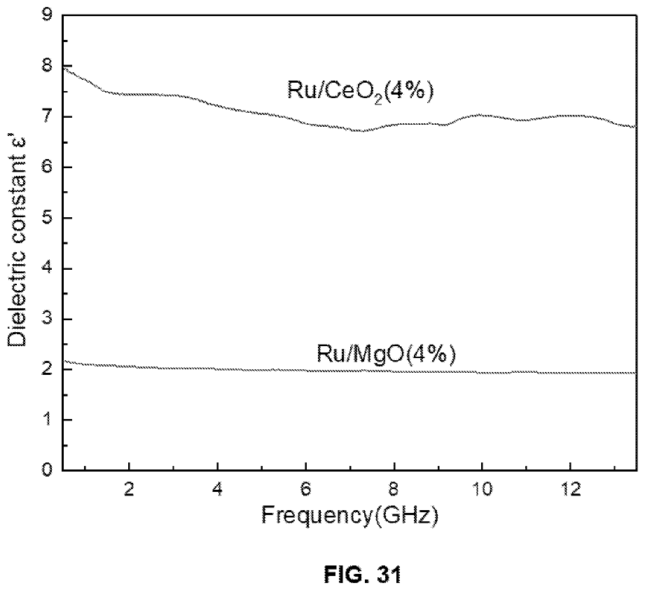

Dielectric Property Measurement. During microwave irradiation, the catalyst functions as microwave energy absorber, and microwave energy utilization depends on dielectric property of the catalyst. In this study, the CeO₂ supported catalysts show high microwave energy adsorption ability, while the MgO supported catalysts exhibits much lower microwave energy adsorption ability. To achieve 533 K reaction temperature, the CeO₂ supported catalysts only need 10-15 W of microwave power, while MgO supported catalysts usually require 70-85 W of microwave power. The dielectric constant ε′ indicates the electrical energy storing capable of material and is effected by frequency and temperature. The dielectric constant ε′ for the typically Ru/CeO₂(4%) and Ru/MgO(4%) were measured in the frequency range of 0.5-13.4 GHz at room temperature to help understand microwave-assisted NH₃ synthesis. As shown in FIG. 31, the Ru/CeO₂(4%) had a much higher dielectric constant than that of Ru/MgO(4%), indicating the higher microwave energy storage ability of the CeO₂ supported catalysts. The result helps to explain why the MgO supported catalysts needs more power to achieve the same temperature compared to CeO₂ supported catalysts.

In the Examples herein, the effects of Ru electronic and geometric structures in microwave-assisted NH₃ synthesis at ambient pressure have been comprehensively investigated. Compared with MgO support, CeO₂ exhibits significant advantages in NH₃ synthesis. Owing to stronger interaction between Ru and CeO₂ support, Ru particle size becomes smaller with high dispersion, creating more active sites for NH₃ synthesis. Meanwhile, higher electronic density and electron donating ability of CeO₂ facilitate higher electron density over Ru which is a critical step in activating N₂ under microwave irradiation. Promoters have strong influence on Ru catalyst in NH₃ synthesis, with Cs being more effective than K due to lower electronegativity. Beside the electronic modification, the structural modification is also observed by adding promoter. The combined theoretical and experimental approaches provided herein the Examples provide a basis for the role of supports and promoters in microwave-enhanced NH₃ synthesis.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A process for ammonia synthesis, the process comprising:
providing a reaction chamber within a reactor with a heterogeneous catalyst;
activating the heterogeneous catalyst using electromagnetic energy having a frequency of 13.5 MHz to 50 GHz;
wherein the activating the heterogeneous catalyst initiates a chemical reaction;
conveying a flow of a reactant gas mixtures into the reaction chamber via an entry port;
wherein the reaction chamber pressurizes the reaction chamber to a pressure from about 0.5 atm to about 1000 atm;
contacting the reactant gas mixture with the heterogeneous catalyst; and
reacting the reactant gas mixture in contact with the heterogeneous catalyst, thereby providing a product gas mixture;
wherein the heterogeneous catalyst comprises a catalyst support comprising a cerium oxide, a lanthanum oxide, or a combination thereof;
wherein the cerium oxide, if present, comprises Ce(III), Ce(IV), or combinations thereof; and
wherein the lanthanum oxide, if present, comprises La(III);
wherein the heterogeneous catalyst comprises a catalyst metal comprising at least one metal selected from Groups 6-12; and
wherein the catalyst metal is selected from Rh, Ir, Os, Ru, Pt, Pd, Cr, Mn, Fe, Co, Ni, Zn, and combinations thereof;
wherein the catalyst metal is present in an amount from about 0.1 wt % to about 15 wt %;
wherein the reactant gas mixture is pre-heated to a reactant gas mixture pre-heat temperature prior to conveying the flow of a reactant gas mixture into the reaction chamber via an entry port;
wherein the reactant gas mixture pre-heat temperature is from about 20° C. to about 500° C.;
wherein the heterogeneous catalyst has a heterogeneous catalyst temperature of from about 40° C. to about 800° C.;
wherein the reactant gas mixture comprises nitrogen and hydrogen; and
wherein the product gas mixture comprises ammonia.

2. The process of claim 1, wherein the reaction chamber has a pressure of from about 1 atm to about 2.5 atm.

3. The process of claim 1, wherein the reaction chamber has a pressure of from about 5 atm to about 100 atm.

4. The process of claim 1, wherein the reactant gas mixture comprises about 15 vol % to about 75 vol % of nitrogen; and about 90 vol % to about 15 vol % of hydrogen; provided that the vol % ratio of hydrogen to nitrogen is about 1 to about 5.

5. The process of claim 4, wherein the reactant gas mixture comprises about 25 vol % to about 50 vol % of nitrogen; and about 75 vol % to about 35 vol % of hydrogen; provided that the vol % ratio of hydrogen to nitrogen is about 1.5 to about 4.

6. (canceled)

7. The process of claim 1, wherein the reactant gas mixture pre-heat temperature is from about 100° C. to about 450° C.

8. The process of claim 1, wherein the heterogeneous catalyst has a heterogeneous catalyst temperature of from about 150° C. to about 600° C.

9. The process of claim 1, wherein the product gas mixture has an ammonia concentration of about 0.5 vol % to about 25 vol %.

10. The process of claim 9, wherein the product gas mixture has an ammonia concentration of about 5 vol % to about 20 vol %.

11. The process of claim 1, wherein the electromagnetic energy has a frequency of from 300 MHz to 50 GHz.

12. The process of claim 11, wherein the electromagnetic energy has a frequency of from 900 MHz to 2.5 GHz.

13. The process of claim 1, further comprising microwave-thermal hybrid heating.

14. The process of claim 1, further comprising providing an electromagnetic energy susceptor with the heterogeneous catalyst in the reaction chamber within the reactor; wherein the electromagnetic energy susceptor is capable of interacting with electromagnetic energy in the frequency range of 13.5 MHz to 50 GHz.

15. The process of claim 14, wherein the electromagnetic energy susceptor comprises a material selected from a SiC, graphene, carbon nanotube, carbon nanofiber, graphite, carbon nanofoam, and combinations thereof.

16. A heterogeneous catalyst comprising:
a catalyst support comprising a cerium oxide, a lanthanum oxide, or a combination thereof; and
wherein the cerium oxide, if present, comprises Ce(III), Ce(IV), or combinations thereof; and
wherein the lanthanum oxide, if present, comprises La(III);
a catalyst metal comprising at least one metal selected from Groups 6-12;
wherein the catalyst metal is selected from Rh, Ir, Os, Ru, Pt, Pd, Cr, Mn, Fe, Co, Ni, Zn, and combinations thereof;
wherein the catalyst metal is present in an amount from about 0.1 wt % to about 15 wt %;
wherein the catalyst is capable of interacting with electromagnetic energy having a frequency of 13.5 MHz to 50 GHz;
wherein the wt % is based on the total weight of the catalyst support and the catalyst metal.

17. The heterogeneous catalyst of claim 16, wherein the catalyst metal is selected from Ru, Pd, Fe, and combinations thereof.

18. The heterogeneous catalyst of claim 17, wherein the catalyst metal is Ru.

19. The heterogeneous catalyst of claim 16, wherein the catalyst metal comprises a single metal selected from Ru, Pt, Pd, Cr, Mn, Fe, Co, Ni, and Zn.

20. The heterogeneous catalyst of claim 16, wherein the catalyst metal comprises two metals selected from Ru, Pd, Cr, Fe, Co, Ni, and Zn.

21-28. (canceled)
